(19) United States
(12) Patent Application Publication
(10) Pub. No.: US 2011/0166868 A1
(43) Pub. Date: Jul. 7, 2011

(54) METHOD FOR PROVIDING GENOMIC CLONES

(75) Inventors: Lincoln Muir, Wellesley, MA (US); August Sick, Eugene, OR (US); Nancy Groot, Waltham, MA (US); Dwayne W. Dexter, Wilmington, DE (US); Charles Robinson, Niagra Falls, NY (US); John Carrino, San Diego, CA (US); Robert Bennett, Encinitas, CA (US)

(73) Assignee: LIFE TECHNOLOGIES CORPORATION, Carlsbad, CA (US)

(21) Appl. No.: 12/715,147

(22) Filed: Mar. 1, 2010

Related U.S. Application Data
(63) Continuation of application No. 10/618,852, filed on Jul. 15, 2003, now abandoned.
(60) Provisional application No. 60/396,241, filed on Jul. 17, 2002.

(51) Int. Cl. G06Q 99/00; C40B 50/00; C40B 40/08

(52) U.S. Cl. 705/1.1; 506/23; 506/17

(57) ABSTRACT

Subscription-based systems and methods where a provider provides one or more customers, identified as subscribers or non-subscribers, with research products and services (e.g., for industries involved in genomic and proteomic research). Initially, the provider prepares collections of clones and provides customers with access to clone collections. Individual clones in a clone collection may comprise an ORF that may be flanked by recombination sites. Further, an ORF may contain a suppressible stop codon that may be suppressed to produce a fusion protein comprising the ORF and a tag sequence. Provider may provide additional related services and/or products. The products and services offered to the customers will vary depending on their designation as either subscribers or non-subscribers.

### BACKGROUND OF THE INVENTION

1. Field of the Invention

The present invention is directed to systems and methods for providing research products and services (e.g., for industries involved in genomic and proteomic research), as well as research products supplied as part of the systems and methods.

2. Background Art

Genomics relates to the study of genes and how they relate to the health, development, structure, and disease of an organism. The sequencing of the human genome has been a large focus of scientists over the past decade. Now that the task has been completed, life science research is shifting beyond sequencing to functional studies. This has given rise to the science of proteomics. Proteomics examines the role, that proteins play with respect to both normal and abnormal biological (e.g., cellular) processes. Together, genomic and proteomic research are driving, for example, the race to mine the human genome to identify and exploit druggable targets.

A druggable target is a gene whose function can be modulated by a drug, such as an organic molecule with one or more pharmacological activities. The number of gene targets within the human genome that are of pharmaceutical relevance is limited. Presently, the pharmaceutical industry is focusing primarily on certain areas of high interest, such as CNS (central nervous systems) disorders, metabolic diseases, cardiovascular diseases, oncology, inflammation and infectious diseases. Within these areas, each pharmaceutical company has identified their own prioritized list of “druggable targets”.

Many currently available drugs were designed without the benefit of using clones encoding the intended druggable targets, and show undesirable, or sometimes unacceptable, side effects. It is generally believed that the poor side effect profiles of currently available drugs often stem from the interaction of these drugs with (sometimes multiple) family members of the target molecule. Each family member may be involved in a physiological function distinct from the other family members. More than one family member, however, may respond to a non-specific drug. As a consequence, a non-specific drug intended to exert its effects on one physiological function may in fact influence other physiological functions, thereby causing undesirable side effects. Therefore, the pharmaceutical industry is expressing an urgent need for access to complete sets of gene families.

Further, a major theme of pharmaceutical and biotechnology companies is to improve their lead compound selection process at the earliest stages of drug development. If these attempts are successful, those drug candidates that enter the clinic to treat human disease should possess much improved side effect and safety profiles. For example, drugs with undesirable or unacceptable side effects can be eliminated at the research stage, rather than at the clinical stage. Accordingly, there is a need to improve the lead compound selection process in order to reduce the costs associated with new drug development. Conducting research on open reading frame clones is one way of improving the identification of lead compounds. Thus, there is also a need to generate a representative open reading frame (ORF) clone collection for every human gene and/or gene family.

Pharmaceutical and biotechnology companies have invested significant resources in various genomics technologies developing, for example databases, gene expression platforms, etc. Further, a number of companies provide products and services related to these technologies. However, the offerings of these companies are generic, as opposed to customized, to the individual needs of the pharmaceutical and biotechnology companies. Heretofore, there has not been a single source upon which a pharmaceutical or biotechnology company could rely to meet most, if not all, of its needs for genomic and proteomic products and services. Thus, there is a need for an integrated system for providing customized genomic and proteomic products and services.

These needs and others are met by the present invention.

### BRIEF SUMMARY OF THE INVENTION

The present invention provides subscription-based systems, methods, and components for providing research products and services (e.g., for use in industries involved in genomic and proteomic research and development). In addition, the present invention encompasses the products provided as well as methods of performing the services provided. The system includes a provider of research products and services and one or more customers desirous of obtaining one or more research products and/or services. Customers are identified as either subscribers or non-subscribers.

In some aspects, the system may comprise one or more databases. A database may comprise various types of information of interest to customers (e.g., individuals or organizations conducting research). For example, a database may contain information regarding products and/or services available (e.g., cloning services, expression services, expressed polypeptides, antibodies that bind expressed polypeptides, etc.), clones, sequences of clones, sequences of open reading frames (ORFs) contained in clones, physical characteristics of polypeptides expressed from open reading frames (e.g, molecular weight, amino acid composition, isoelectric point, etc.), activities (e.g., enzymatic, immunogenic, regulatory, etc.) of polypeptides expressed from ORFs, protein-protein interactions (e.g., identities of proteins that bind to/interact with polypeptides expressed from ORFs contained in clones), expression information (e.g., amount and/or activity of one or more polypeptides produced by one or more host cells containing one or more clones), functional regions (e.g., domains and/or sequences of polypeptides and/or nucleic acids having an activity and/or characteristic such as enzyme active sites, protein binding sites, promoter sequences, enhancer/repressor sequences, nucleic acid sequences bound by polypeptides, centromeres, telomers, etc.), and the like. A database may contain more than one type of information (e.g., two, three, four, five, six, seven, eight, nine, ten, etc. types of information) and a given type of information may be in more than one database. A database may contain private and/or public information. For example, a database may contain private information (e.g., trade secret and/or patentable information) regarding, for example, one or more clones (e.g., sequence of an ORF encoded by the clone, expression information, etc.) as well as public information (e.g., GenBank, EMBL, etc. sequences of related ORFs).

In one embodiment, one or more directories of available research products and services (e.g., genomic and proteomic research products and services) is maintained in a research products and services database. This database may be accessed by subscribers and non-subscribers (e.g., via an interface, such as a graphical user interface).

In one embodiment, the system may comprise one or more clone collection databases. Clone collection databases may be associated with the research products and services database or may be independent of the research products and services database. A clone collection database may comprise a private area that is only accessible by one or more subscribers and/or a public area that is accessible by both subscribers and non-subscribers. In one embodiment, the private area may be further sub-divided into private areas (e.g., for maintaining sub-categories of data and/or data accessible to specific subscribers). Such sub-divided portions of a private database may be accessible to one or more subscribers and inaccessible to others. A clone collection database may contain information identifying the characteristics of private and public clone collections available from the provider.

The system may further comprise one or more expression databases. An expression database may contain information identifying optimized expression systems for one or more clones in private and/or public clone collections. Such information may comprise one or more suitable host cells or cell types (e.g., mammalian cells, insect cells, etc.), as well as promoter information, enhancer information, repressor information, and the like. An expression database may comprise information regarding culture conditions suitable for a specific host cell type, isolation conditions for purifying a polypeptide encoded by a clone, and any other information related to expression of a polypeptide. An expression database may comprise information regarding an RNA expressed from a clone. The RNA may be translated or un-translated. The information may comprise information regarded 5′ and/or 3′ un-translated regions, RNA stability, etc. In some embodiments, an expression database may comprise information regarding suitable host cells for expression of a polypeptide having desired characteristics. For example, a database may contain information regarding post-translational modifications (e.g., glcosylation, acylation, etc.) that occur in a given host and information regarding the effects of such post-translational modification on one or more characteristics of the polypeptide (e.g., activity, immunogenicity, etc.).

In some embodiments, systems of the invention may be provided with one or more subscriber records. Such records may be use to, for example, manage subscriptions to the products and services of the provider. A subscriber record may include a subscription identification field, a subscription fee payment field, a clone purchase credit field, a clone purchase field, a subscriber site identification field, and/or combinations of any two or more of the above.

In one aspect, the present invention provides one or more compositions identified in one or more databases. The invention also encompasses reaction mixtures comprising such compositions and methods of making and using such reaction mixtures.

In one embodiment, the present invention provides the subscriber with access to the research products and services of the provider using a computer system and a graphical user interface. In addition to providing the subscriber with access to multiple databases, the present invention enables the subscriber to identify products and/or services, which may not have been previously available from the provider, that the subscriber desires to obtain. In one embodiment, clones to be built and added to the private or public clone collections of the provider may be identified by a subscriber. In some embodiments, the subscriber may be able to prioritize the order in which the identified clones are built and added to a clone collection. The present invention encompasses methods for preparing clone collections as well as clone collections prepared using the methods of the invention. Still further, the present invention provides research and development consulting services to one or more sites designated by the subscriber.

In some embodiments, the present invention provides clone collections. Clones making up a clone collection may contain any nucleic acids (e.g., two, three, five, ten, twenty, etc.) of interest, for example, nucleic acids that contain one or more open reading frames (ORFs), nucleic acids containing un-translated sequences, (e.g., 5′ and/or 3′ un-translated sequences, introns, etc.), which may be from cDNA and/or genomic DNA, nucleic acids containing promoter elements, and any other nucleic acid of interest to a customer. A clone collection may contain ORFs, which may be in vectors, representing all, substantially all, a majority, or a representative number of members of a class of polypeptides (e.g., all known polypeptides having a particular activity and/or characteristic of interest). A collection may comprise clones comprising ORFs encoding all, substantially all, a majority, or a representative number of polypeptides related to and/or affected by a particular activity. A collection may comprise clones comprising ORFs encoding all, substantially all, a majority, or a representative number of polypeptides involved in the metabolism (e.g., synthesis and degradation) of a metabolite of interest (e.g., a lipid, carbohydrate, peptide, etc.) as well as clones comprising one or more ORFs encoding polypeptides affected by the metabolite. One or more individual members of a clone collection may comprise ORFs flanked by recognition sites (e.g., recombination sites, topoisomerase sites, restriction enzyme sites, etc.). When a clone contains multiple recombination sites, such sites may or may not recombine with each other.

Clones of a collection may also contain one or more functional sequences (e.g., transcriptional regulatory sequences, sequences comprising stop codons, etc.). Such functional sequences may be operably linked to a sequence of interest (e.g., an ORF). Clones of a collection may also comprise one or more stop codons that may be repressible as well as one or more sequences encoding one or more tags (e.g., one or more C-terminal and/or N-terminal tags). One or members of a clone collection may comprise sequences other than ORFs. For example, one or more members of a clone might contain 5′-un-translated regions, regions of genomic nucleic acids, intron regions, promoter regions, enhancer regions, and the like.

The present invention also contemplates methods of making clones to be included in clone collections, methods of making clone collections, clones, and collections made by the methods of the invention, as well as reaction mixtures and compositions comprising one or more clones or collections.

Further features and advantages of the present invention, as well as the structure and operation of various embodiments of the invention, are described in detail below with reference to the accompanying drawings. In the drawings, like reference numbers generally indicate identical, functionally similar and/or structurally similar elements. The drawing in which an element first appears is generally indicated by the leftmost digit(s) in the corresponding reference number.

### BRIEF DESCRIPTION OF THE FIGURES

The present invention will be described with reference to the accompanying drawings, wherein:

FIG. 1 is a block diagram of a system for providing genomic and proteomic products and services according to an embodiment of the present invention;

FIG. 2A is a table describing exemplary genomic and proteomic products offered by a provider according to an embodiment of the present invention;

FIG. 2B is a table describing exemplary genomic and proteomic services offered by a provider according to an embodiment of the present invention;

FIG. 3 is a block diagram illustration of a subscriber record according to an embodiment of the present invention;

FIG. 4 is a block diagram illustration depicting a client/server implementation according to an embodiment of the present invention;

FIG. 5 is a block diagram illustration of an exemplary computer system embodiment of the client/server implementation of FIG. 4;

FIG. 6 is a flow chart diagram of a method for providing genomic and proteomic products and services according to an embodiment of the present invention;

FIG. 7 is a flow chart diagram of a method, for providing genomic and proteomic products and services according to an embodiment of the present invention;

FIG. 8 is a flow chart diagram of a method for providing clone construction and related genomic and proteomic products and services according to an embodiment of the present invention; and

FIG. 9 is a flow chart diagram of a method for constructing a clone according to an embodiment of the present invention;

FIG. 10 is a flow chart diagram of an exemplary implementation of an embodiment of the present invention;

FIG. 11 is a schematic representation of some of the services that may be provided in conjunction with the present invention; and

FIG. 12A-12F are schematic representations of configurations of vectors and sequences of interest that may be used in various embodiments of the invention.

Table of Contents

```
1. Definitions
2. Overview of the Invention
3. Exemplary system embodiments
  3.1 Genomic and Proteomic Research Products and Services System
    3.1.1 Exemplary Products
    3.1.2 Exemplary Services
    3.1.3 Customers
  3.2 Exemplary computer system embodiment
    3.2.1Genomic and Proteomic Products and Services databases
      3.2.1.1 Subscriber database
      3.2.1.2 Clone collection database
      3.2.1.3 Expression Database
    3.2.2 Client/Server Architecture
4. Exemplary operational embodiments
  4.1 Accessing Genomic and Proteomic Research Products and Services
  4.2 Providing Genomic and Proteomic Research Products and Services
5. Detailed Description of Exemplary Products
6. Detailed Description of Exemplary Services
7. Conclusion
```

### 1. DEFINITIONS

In the description that follows, a number of terms used in recombinant nucleic acid technology are utilized extensively. In order to provide a clear and more consistent understanding of the specification and claims, including the scope to be given such terms, the following definitions are provided.

Genomic Products and Services: As used herein, the term genomic products and services refers to products and services that may be used to conduct research involving nucleic acids.

Proteomic Products and Services: As used herein, the term proteomic products and services refers to products and services that may be used to conduct research involving polypeptides.

Clone Collection: As used herein, “clone collection” refers to two or more nucleic acid molecules, each of which comprises one or more nucleic acid sequences of interest.

Customer: As used herein, the term customer refers to any individual, institution, corporation, university, or organization seeking to obtain genomic and proteomic products and services.

Provider: As used herein, the term provider refers to any individual, institution, corporation, university, or organization seeking to provide genomic and proteomic products and services.

Subscriber: As used herein, the term subscriber refers to any customer having an agreement with a provider to obtain public and private genomic and proteomic products and services at subscriber rates.

Non-subscriber: As used herein, the term non-subscriber refers to any customer who does not have an agreement with a provider to obtain public and private genomic and proteomic products and services at subscriber rates.

Host: As used herein, the term “host” refers to any prokaryotic or eukaryotic (e.g., mammalian, insect, yeast, plant, avian, animal, etc.) cell and/or organism that is a recipient of a replicable expression vector, cloning vector or any nucleic acid molecule. The nucleic acid molecule may contain, but is not limited to, a sequence of interest, a transcriptional regulatory sequence (such as a promoter, enhancer, repressor, and the like) and/or an origin of replication. As used herein, the terms “host,” “host cell,” “recombinant host” and “recombinant host cell” may be used interchangeably. For examples of such hosts, see Sambrook, et al., Molecular Cloning: A Laboratory Manual, Cold Spring Harbor Laboratory, Cold Spring Harbor, N.Y.

Transcriptional Regulatory Sequence: As used herein, the phrase “transcriptional regulatory sequence” refers to a functional stretch of nucleotides contained on a nucleic acid molecule, in any configuration or geometry, that act to regulate the transcription of (1) one or more nucleic acid sequences that may comprise ORFs, (e.g., two, three, four, five, seven, ten, etc.) into messenger RNA or (2) one or more nucleic acid sequences into untranslated. RNA. Examples of transcriptional regulatory sequences include, but are not limited to, promoters, enhancers, repressors, operators (e.g., the tet operator), and the like.

Promoter: As used herein, a promoter is an example of a transcriptional regulatory sequence, and is specifically a nucleic acid generally described as the 5′-region of a gene located proximal to the start codon or nucleic acid that encodes untranslated RNA. The transcription of an adjacent nucleic acid segment is initiated at or near the promoter. A repressible promoter's rate of transcription decreases in response to a repressing agent. An inducible promoter's rate of transcription increases in response to an inducing agent. A constitutive promoter's rate of transcription is not specifically regulated, though it can vary under the influence of general metabolic conditions.

Insert: As used herein, the term “insert” refers to a desired nucleic acid segment that is a part of a larger nucleic acid molecule. In many instances, the insert will be introduced into the larger nucleic acid molecule using techniques known to those of skill in the art; e.g., recombinational cloning, topoisomerase cloning or joining, ligation, etc.

Target Nucleic Acid Molecule: As used herein, the phrase “target nucleic acid molecule” refers to a nucleic acid molecule comprising at least one nucleic acid sequence of interest, preferably a nucleic acid molecule that is to be acted upon using the compounds and methods of the present invention. Such target nucleic acid molecules may contain one or more (e.g., two, three, four, five, seven, ten, twelve, fifteen, twenty, thirty, fifty, etc.) sequences of interest.

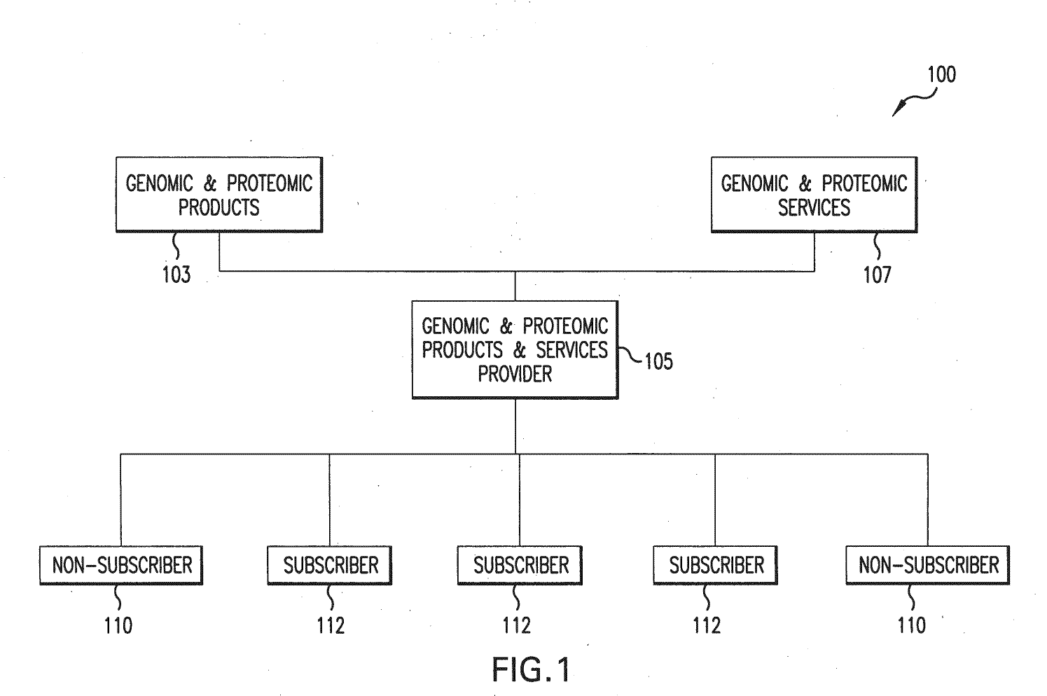

Recognition Sequence: As used herein, the phrase “recognition sequence” or “recognition site” refers to a particular sequence to which a protein, chemical compound, DNA, or RNA molecule (e.g., restriction endonuclease, a topoisomerase, a modification methylase, a recombinase, etc.) recognizes and binds. In the present invention, a recognition sequence may refer to a recombination site. For example, the recognition sequence for Cre recombinase is loxP which is a 34 base pair sequence comprising two 13 base pair inverted repeats (serving as the recombinase binding sites) flanking an 8 base pair core sequence (see FIG. 1 of Sauer, B., Current Opinion in Biotechnology 5:521-527 (1994)). Other examples of recognition sequences are the attB, attP, attL, and attR sequences, which are recognized by the recombinase enzyme λ Integrase. attB is an approximately 25 base pair sequence containing two 9 base pair core-type Int binding sites and a 7 base pair overlap region. attP is an approximately 240 base pair sequence containing core-type Int binding sites and arm-type Int binding sites as well as sites for auxiliary proteins integration host factor (IHF), FIS and excisionase (Xis) (see Landy, Current Opinion in Biotechnology 3:699-707 (1993)). Such sites may also be engineered according to the present invention to enhance production of products in the methods of the invention. For example, when such engineered sites lack the P1 or H1 domains to make the recombination reactions irreversible (e.g., attR or attP), such sites may be designated attR′ or attP' to show that the domains of these sites have been modified in some way.

Recombination Proteins: As used herein, the phrase “recombination proteins” includes excisive or integrative proteins, enzymes, co-factors or associated proteins that are involved in recombination reactions involving one or more recombination sites (e.g., two, three, four, five, seven, ten, twelve, fifteen, twenty, thirty, fifty, etc.), which may be wild-type proteins (see Landy, Current Opinion in Biotechnology 3:699-707 (1993)), or mutants, derivatives (e.g., fusion proteins containing the recombination protein sequences or fragments thereof), fragments, and variants thereof. Examples of recombination proteins include Cre, Int, IHF, X is, Flp, F is, Hin, Gin, ΦC31, Cin, Tn3 resolvase, TndX, XerC, XerD, TnpX, Hjc, Gin, SpCCE1, and ParA.

Recombinases: As used herein, the term “recombinases” is used to refer to the protein that catalyzes strand cleavage and re-ligation in a recombination reaction. Site-specific recombinases are proteins that are present in many organisms (e.g., viruses and bacteria) and have been characterized as having both endonuclease and ligase properties. These recombinases (along with associated proteins in some cases) recognize specific sequences of bases in a nucleic acid molecule and exchange the nucleic acid segments flanking those sequences. The recombinases and associated proteins are collectively referred to as “recombination proteins” (see, e.g., Landy, A., Current Opinion in Biotechnology 3:699-707 (1993)).

Numerous recombination systems from various organisms have been described. See, e.g., Hoess, et al., Nucleic Acids Research 14(6):2287 (1986); Abremski, et al., J. Biol. Chem. 261(1):391 (1986); Campbell, J. Bacteriol. 174(23):7495 (1992); Qian, et al., J. Biol. Chem. 267(11):7794 (1992); Araki, et al., J. Mol. Biol. 225(1):25 (1992); Maeser and Kahnmann, Mol. Gen. Genet. 230:170-176 (1991); Esposito, et al., Nucl. Acids Res. 25(18):3605 (1997). Many of these belong to the integrase family of recombinases (Argos, et al., EMBO J. 5:433-440 (1986); Voziyanov, et al., Nucl. Acids Res. 27:930 (1999)). Perhaps the best studied of these are the Integrase/att system from bacteriophage λ (Landy, A. Current Opinions in Genetics and Devel. 3:699-707 (1993)), the Cre/loxP system from bacteriophage P1 (Hoess and Abremski (1990) In Nucleic Acids and Molecular Biology, vol. 4. Eds.: Eckstein and Lilley, Berlin-Heidelberg: Springer-Verlag; pp. 90-109), and the FLP/FRT system from the Saccharomyces cerevisiae 2 μ circle plasmid (Broach, et al., Cell 29:227-234 (1982)).

Recombination Site: A used herein, the phrase “recombination site” refers to a recognition sequence on a nucleic acid molecule that participates in an integration/recombination reaction by recombination proteins. Recombination sites are discrete sections or segments of nucleic acid on the participating nucleic acid molecules that are recognized and bound by a site-specific recombination protein during the initial stages of integration or recombination. For example, the recombination site for Cre recombinase is loxP, which is a 34 base pair sequence comprised of two 13 base pair inverted repeats (serving as the recombinase binding sites) flanking an 8 base pair core sequence (see FIG. 1 of Sauer, B., Curr. Opin. Biotech. 5:521-527 (1994)). Other examples of recombination sites include the attB, attP, attL, and attR sequences described in U.S. provisional patent applications 60/136,744, filed May 28, 1999, and 60/188,000, filed Mar. 9, 2000, and in co-pending U.S. patent application Ser. Nos. 09/517,466 and 09/732,91—all of which are specifically incorporated herein by reference—and mutants, fragments, variants and derivatives thereof, which are recognized by the recombination protein Int and by the auxiliary proteins integration host factor (IHF), FIS and excisionase (Xis) (see Landy, Curr. Opin. Biotech. 3:699-707. (1993)).

Mutating specific residues in the core region of the att site can generate a large number of different att sites. As with the att1 and att2 sites utilized in GATEWAY™, each additional mutation potentially creates a novel att site with unique specificity that will recombine only with its cognate partner att site bearing the same mutation and will not cross-react with any other mutant or wild-type att site. Novel mutated att sites (e.g., attB 1-10, attP 1-10, attR 1-10 and attL 1-10) are described in previous patent application Ser. No. 09/517,466, filed Mar. 2, 2000, which is specifically incorporated herein by reference. Other recombination sites having unique specificity (i.e., a first site will recombine with its corresponding site and will not recombine or not substantially recombine with a second site having a different specificity) may be used to practice the present invention. Examples of suitable recombination sites include, but are not limited to, loxP sites; loxP site mutants, variants or derivatives such as loxP511 (see U.S. Pat. No. 5,851,808); frt sites; frt site mutants, variants or derivatives; dif sites; dif site mutants, variants or derivatives; psi sites; psi site mutants, variants or derivatives; cer sites; and cer site mutants, variants or derivatives.

Recombination sites may be added to molecules by any number of known methods. For example, recombination sites can be added to nucleic acid molecules by blunt end ligation, PCR performed with fully or partially random primers, or inserting the nucleic acid molecules into a vector using a restriction site flanked by recombination sites.

Recombinational Cloning: As used herein, the phrase “recombinational cloning” refers to a method whereby segments of nucleic acid molecules or populations of such molecules are exchanged, inserted, replaced, substituted or modified, in vitro or in vivo. Preferably, such cloning method is an in vitro method.

Suitable recombinational cloning systems that utilize recombination at defined recombination sites have been previously described in U.S. Pat. No. 5,888,732, U.S. Pat. No. 6,143,557, U.S. Pat. No. 6,171,861, U.S. Pat. No. 6,270,969, and U.S. Pat. No. 6,277,608, and in pending U.S. application Ser. No. 09/517,466, and in published United States application no. 20020007051, (each of which is fully incorporated herein by reference), all assigned to the Invitrogen Corporation, Carlsbad, Calif. In brief, the GATEWAY™ Cloning System described in these patents utilizes vectors that contain at least one recombination site to clone desired nucleic acid molecules in vivo or in vitro. In some embodiments, the system utilizes vectors that contain at least two different site-specific recombination sites that may be based on the bacteriophage lambda system (e.g., att1 and att2) that are mutated from the wild-type (att0) sites. Each mutated site has a unique specificity for its cognate partner att site (i.e., its binding partner recombination site) of the same type (for example attB1 with attP1, or attL1 with attR1) and will not cross-react with recombination sites of the other mutant type or with the wild-type att0 site. Different site specificities allow directional cloning or linkage of desired molecules thus providing desired orientation of the cloned molecules. Nucleic acid fragments, flanked by recombination sites are cloned and subcloned using the GATEWAY™ system by replacing a selectable marker (for example, ccdB) flanked by att sites on the recipient plasmid molecule, sometimes termed the Destination Vector. Desired clones are then selected by transformation of a ccdB sensitive host strain and positive selection for a marker on the recipient molecule. Similar strategies for negative selection (e.g., use of toxic genes) can be used in other organisms such as thymidine kinase (TK) in mammals and insects.

Topoisomerase recognition site. As used herein, the term “topoisomerase recognition site” means a defined nucleotide sequence that is recognized and bound by a site specific topoisomerase. For example, the nucleotide sequence 5′-(C/T)CCTT-3′ is a topoisomerase recognition site that is bound specifically by most poxvirus topoisomerases, including vaccinia virus DNA topoisomerase I, which then can cleave the strand after the 3′- most thymidine of the recognition site to produce a nucleotide sequence comprising 5′-(C/T)CCTT-PO₄-TOPO, i.e., a complex of the topoisomerase covalently bound to the 3′ phosphate through a tyrosine residue in the topoisomerase (see, Shuman, J. Biol. Chem. 266:11372-1137, 1991; Sekiguchi and Shuman, Nucl. Acids Res. 22:5360-5365, 1994; each of which is incorporated herein by reference; see, also, U.S. Pat. No. 5,766,891; PCT/US95/16099; and PCT/US98/12372). In comparison, the nucleotide sequence 5′-GCAACTT-3′ is the topoisomerase recognition site for type IA E. coli topoisomerase III.

Repression Cassette: As used herein, the phrase “repression cassette” refers to a nucleic acid segment that contains a repressor or a selectable marker present in the subcloning vector.

Selectable Marker: As used herein, the phrase “selectable marker” refers to a nucleic acid segment that allows one to select for or against a molecule (e.g., a replicon) or a cell that contains it, often under particular conditions. These markers can encode an activity, such as, but not limited to, production of RNA, peptide, or protein, or can provide a binding site for RNA, peptides, proteins, inorganic and organic compounds or compositions and the like. Examples of selectable markers include but are not limited to: (1) nucleic acid segments that encode products that provide resistance against otherwise toxic compounds (e.g., antibiotics); (2) nucleic acid segments that encode products that are otherwise lacking in the recipient cell (e.g., tRNA genes, auxotrophic markers); (3) nucleic acid segments that encode products that suppress the activity of a gene product; (4) nucleic acid segments that encode products that can be readily identified (e.g., phenotypic markers such as (β-galactosidase, green fluorescent protein (GFP), yellow fluorescent protein (YFP), red fluorescent protein (RFP), cyan fluorescent protein (CFP), and cell surface proteins); (5) nucleic acid segments that bind products that are otherwise detrimental to cell survival and/or function; (6) nucleic acid segments that otherwise inhibit the activity of any of the nucleic acid segments described in Nos. 1-5 above (e.g., antisense oligonucleotides); (7) nucleic acid segments that bind products that modify a substrate (e.g., restriction endonucleases); (8) nucleic acid segments that can be used to isolate or identify a desired molecule (e.g., specific protein binding sites); (9) nucleic acid segments that encode a specific nucleotide sequence that can be otherwise non-functional (e.g., for PCR amplification of subpopulations of molecules); (10) nucleic acid segments that, when absent, directly or indirectly confer resistance or sensitivity to particular compounds; and/or (11) nucleic acid segments that encode products that either are toxic (e.g., Diphtheria toxin) or convert a relatively non-toxic compound to a toxic compound (e.g., Herpes simplex thymidine kinase, cytosine deaminase) in recipient cells; (12) nucleic acid segments that inhibit replication, partition or heritability of nucleic acid molecules that contain them; and/or (13) nucleic acid segments that encode conditional replication functions, e.g., replication in certain hosts or host cell strains or under certain environmental conditions (e.g., temperature, nutritional conditions, etc.).

Site-Specific Recombinase: As used herein, the phrase “site-specific recombinase” refers to a type of recombinase that typically has at least the following four activities (or combinations thereof): (1) recognition of specific nucleic acid sequences; (2) cleavage of said sequence or sequences; (3) topoisomerase activity involved in strand exchange; and (4) ligase activity to reseal the cleaved strands of nucleic acid (see Sauer, B., Current Opinions in Biotechnology 5:521-527 (1994)). Conservative site-specific recombination is distinguished from homologous recombination and transposition by a high degree of sequence specificity for both partners. The strand exchange mechanism involves the cleavage and rejoining of specific nucleic acid sequences in the absence of DNA synthesis (Landy, A. (1989) Ann. Rev. Biochem. 58:913-949).

Suppressor tRNAs. As used herein, the phrase “suppressor tRNA” refers to a molecule that mediates the incorporation of an amino acid in a polypeptide in a position corresponding to a stop codon in the mRNA being translated.

Homologous Recombination: As used herein, the phrase “homologous recombination” refers to the process in which nucleic acid molecules with similar nucleotide sequences associate and exchange nucleotide strands. A nucleotide sequence of a first nucleic acid molecule that is effective for engaging in homologous recombination at a predefined position of a second nucleic acid molecule will therefore have a nucleotide sequence that facilitates the exchange of nucleotide strands between the first nucleic acid molecule and a defined position of the second nucleic acid molecule. Thus, the first nucleic acid will generally have a nucleotide sequence that is sufficiently complementary to a portion of the second nucleic acid molecule to promote nucleotide base pairing.

Homologous recombination requires homologous sequences in the two recombining partner nucleic acids but does not require any specific sequences. As indicated above, site-specific recombination that occurs, for example, at recombination sites such as att sites, is not considered to be “homologous recombination,” as the phrase is used herein.

Vector: As used herein, the term “vector” refers to a nucleic acid molecule (preferably DNA) that provides a useful biological or biochemical property to an insert. Examples include plasmids, phages, viruses, autonomously replicating sequences (ARS), centromeres, and other sequences that are able to replicate or be replicated in vitro or in a host cell, or to convey a desired nucleic acid segment to a desired location within a host cell. A vector can have one or more restriction endonuclease recognition sites (e.g., two, three, four, five, seven, ten, etc.) at which the sequences can be cut in a determinable fashion without loss of an essential biological function of the vector, and into which a nucleic acid fragment can be spliced in order to bring about its replication and cloning. Vectors can further provide primer sites (e.g., for PCR), transcriptional and/or translational initiation and/or regulation sites, recombinational signals, replicons, selectable markers, etc. Clearly, methods of inserting a desired nucleic acid fragment that do not require the use of recombination, transpositions or restriction enzymes (such as, but not limited to, uracil N-glycosylase (UDG) cloning of PCR fragments (U.S. Pat. Nos. 5,334,575 and 5,888,795, both of which are entirely incorporated herein by reference), T:A cloning, and the like) can also be applied to clone a fragment into a cloning vector to be used according to the present invention. The cloning vector can further contain one or more selectable markers (e.g., two, three, four, five, seven, ten, etc.) suitable for use in the identification of cells transformed with the cloning vector.

Subcloning Vector: As used herein, the phrase “subcloning vector” refers to a cloning vector comprising a circular or linear nucleic acid molecule that includes, preferably, an appropriate replicon. In the present invention, the subcloning vector can also contain functional and/or regulatory elements that are desired to be incorporated into the final product to act upon or with the cloned nucleic acid insert. The subcloning vector can also contain a selectable marker (preferably DNA).

Primer: As used herein, the term “primer” refers to a single stranded or double stranded oligonucleotide that is extended by covalent bonding of nucleotide monomers during amplification or polymerization of a nucleic acid molecule (e.g., a DNA molecule). In one aspect, the primer may be a sequencing primer (for example, a universal sequencing primer). In another aspect, the primer may comprise a recombination site or portion thereof.

Adapter: As used herein, the term “adapter” refers to an oligonucleotide or nucleic acid fragment or segment (preferably DNA) that comprises one or more recombination sites (or portions of such recombination sites) that can be added to a circular or linear nucleic acid molecule as well as to other nucleic acid molecules described herein. When using portions of recombination sites, the missing portion may be provided by the nucleic acid molecule. Such adapters may be added at any location within a circular or linear molecule, although the adapters are preferably added at or near one or both termini of a linear molecule. Preferably, adapters are positioned to be located on both sides (flanking) a particular nucleic acid molecule of interest. In accordance with the invention, adapters may be added to nucleic acid molecules of interest by standard recombinant techniques (e.g., restriction digest and ligation). For example, adapters may be added to a circular molecule by first digesting the molecule with an appropriate restriction enzyme, adding the adapter at the cleavage site and reforming the circular molecule that contains the adapter(s) at the site of cleavage. In other aspects, adapters may be added by homologous recombination, by integration of RNA molecules, and the like. Alternatively, adapters may be ligated directly to one or more and preferably both termini of a linear molecule thereby resulting in linear molecule(s) having adapters at one or both termini. In one aspect of the invention, adapters may be added to a population of linear molecules, (e.g., a cDNA library or genomic DNA that has been cleaved or digested) to form a population of linear molecules containing adapters at one and preferably both termini of all or substantial portion of said population.

Adapter-Primer: As used herein, the phrase “adapter-primer” refers to a primer molecule that comprises one or more recombination sites (or portions of such recombination sites) that can be added to a circular or to a linear nucleic acid molecule described herein. When using portions of recombination sites, the missing portion may be provided by a nucleic acid molecule (e.g., an adapter) of the invention. Such adapter-primers may be added at any location within a circular or linear molecule, although the adapter-primers are preferably added at or near one or both termini of a linear molecule. Such adapter-primers may be used to add one or more recombination sites or portions thereof to circular or linear nucleic acid molecules in a variety of contexts and by a variety of techniques, including but not limited to amplification (e.g., PCR), ligation (e.g., enzymatic or chemical/synthetic ligation), recombination (e.g., homologous or non-homologous (illegitimate) recombination) and the like.

Template: As used herein, the term “template” refers to a double stranded or single stranded nucleic acid molecule, all or a portion of which is to be amplified, synthesized, reverse transcribed, or sequenced. In the case of a double-stranded DNA molecule, denaturation of its strands to form a first and a second strand is preferably performed before these molecules may be amplified, synthesized or sequenced, or the double stranded molecule may be used directly as a template. For single stranded templates, a primer complementary to at least a portion of the template hybridizes under appropriate conditions and one or more polypeptides having polymerase activity (e.g., two, three, four, five, or seven DNA polymerases and/or reverse transcriptases) may then synthesize a molecule complementary to all or a portion of the template. Alternatively, for double stranded templates, one or more transcriptional regulatory sequences (e.g., two, three, four, five, seven or more promoters) may be used in combination with one or more polymerases to make nucleic acid molecules complementary to all or a portion of the template. The newly synthesized molecule, according to the invention, may be of equal or shorter length compared to the original template. Mismatch incorporation or strand slippage during the synthesis or extension of the newly synthesized molecule may result in one or a number of mismatched base pairs. Thus, the synthesized molecule need not be exactly complementary to the template. Additionally, a population of nucleic acid templates may be used during synthesis or amplification to produce a population of nucleic acid molecules typically representative of the original template population.

Incorporating: As used herein, the term “incorporating” means becoming a part of a nucleic acid (e.g., DNA) molecule or primer.

Library: As used herein, the term “library” refers to a collection of nucleic acid molecules (circular or linear). In one embodiment, a library may comprise a plurality of nucleic acid molecules (e.g., two, three, four, five, seven, ten, twelve, fifteen, twenty, thirty, fifty, one hundred, two hundred, five hundred one thousand, five thousand, or more), that may or may not be from a common source organism, organ, tissue, or cell. In another embodiment, a library is representative of all or a portion or a significant portion of the nucleic acid content of an organism (a “genomic” library), or a set of nucleic acid molecules representative of all or a portion or a significant portion of the expressed nucleic acid molecules (a cDNA library or segments derived therefrom) in a cell, tissue, organ or organism. A library may also comprise nucleic acid molecules having random sequences made by de novo synthesis, mutagenesis of one or more nucleic acid molecules, and the like. Such libraries may or may not be contained in one or more vectors (e.g., two, three, four, five, seven, ten, twelve, fifteen, twenty, thirty, fifty, etc.). In some embodiments, a library may be “normalized” library (i.e., a library of cloned nucleic acid molecules from which each member nucleic acid molecule can be isolated with approximately equivalent probability).

Normalized. As used herein, the term “normalized” or “normalized library” means a nucleic acid library that has been manipulated, preferably using the methods of the invention, to reduce the relative variation in abundance among member nucleic acid molecules in the library to a range of no greater than about 25-fold, no greater than about 20-fold, no greater than about 15-fold, no greater than about 10-fold, no greater than about 7-fold, no greater than about 6-fold, no greater than about 5-fold, no greater than about 4-fold, no greater than about 3-fold or no greater than about 2-fold.

Amplification: As used herein, the term “amplification” refers to any in vitro method for increasing the number of copies of a nucleic acid molecule with the use of one or more polypeptides having polymerase activity (e.g., one, two, three, four or more nucleic acid polymerases or reverse transcriptases). Nucleic acid amplification results in the incorporation of nucleotides into a DNA and/or RNA molecule or primer thereby forming a new nucleic acid molecule complementary to a template. The formed nucleic acid molecule and its template can be used as templates to synthesize additional nucleic acid molecules. As used herein, one amplification reaction may consist of many rounds of nucleic acid replication. DNA amplification reactions include, for example, polymerase chain reaction (PCR). One PCR reaction may consist of 5 to 100 cycles of denaturation and synthesis of a DNA molecule.

Nucleotide: As used herein, the term “nucleotide” refers to a base-sugar-phosphate combination. Nucleotides are monomeric units of a nucleic acid molecule (DNA and RNA). The term nucleotide includes ribonucleoside triphosphates ATP, UTP, CTG, GTP and deoxyribonucleoside triphosphates such as dATP, dCTP, dITP, dUTP, dGTP, dTTP, or derivatives thereof. Such derivatives include, for example, [α-S]dATP, 7-deaza-dGTP and 7-deaza-dATP. The term nucleotide as used herein also refers to dideoxyribonucleoside triphosphates (ddNTPs) and their derivatives. Illustrated examples of dideoxyribonucleoside triphosphates include, but are not limited to, ddATP, ddCTP, ddGTP, ddITP, and ddTTP. According to the present invention, a “nucleotide” may be unlabeled or detectably labeled by well known techniques. Detectable labels include, for example, radioactive isotopes, fluorescent labels, chemiluminescent labels, bioluminescent labels and enzyme labels.

Nucleic Acid Molecule: As used herein, the phrase “nucleic acid molecule” refers to a sequence of contiguous nucleotides (riboNTPs, dNTPs, ddNTPs, or combinations thereof) of any length. A nucleic acid molecule may encode a full-length polypeptide or a fragment of any length thereof, or may be non-coding. As used herein, the terms “nucleic acid molecule” and “polynucleotide” may be used interchangeably and include both RNA and DNA.

Oligonucleotide: As used herein, the term “oligonucleotide” refers to a synthetic or natural molecule comprising a covalently linked sequence of nucleotides that are joined by a phosphodiester bond between the 3′ position of the pentose of one nucleotide and the 5′ position of the pentose of the adjacent nucleotide.

Open Reading Frame (ORF): As used herein, an open reading frame or ORF refers to a sequence of nucleotides that codes for a contiguous sequence of amino acids. ORFs of the invention may be constructed to code for the amino acids of a polypeptide of interest from the N-terminus of the polypeptide (typically a methionine encoded by a sequence that is transcribed as AUG) to the C-terminus of the polypeptide. ORFs of the invention include sequences that encode a contiguous sequence of amino acids with no intervening sequences (e.g., an ORF from a cDNA) as well as ORFs that comprise one or more intervening sequences (e.g., introns) that may be processed from an mRNA containing them (e.g., by splicing) when an mRNA containing the ORF is transcribed in a suitable host cell. ORFs of the invention also comprise splice variants of ORFs containing intervening sequences.

ORFs may optionally be provided with one or more sequences that function as stop codons (e.g., contain nucleotides that are transcribed as UAG, an amber stop codon, UGA, an opal stop codon, and/or UAA, an ochre stop codon). When present, a stop codon may be provided after the codon encoding the C-terminus of a polypeptide of interest (e.g., after the last amino acid of the polypeptide) and/or may be located within the coding sequence of the polypeptide of interest. When located after the C-terminus of the polypeptide of interest, a stop codon may be immediately adjacent to the codon encoding the last amino acid of the polypeptide or there may be one or more codons (e.g., one, two, three, four, five, ten, twenty, etc) between the codon encoding the last amino acid of the polypeptide of interest and the stop codon. A nucleic acid molecule containing an ORF may be provided with a stop codon upstream of the initiation codon (e.g., an AUG codon) of the ORF. When located upstream of the initiation codon of the polypeptide of interest, a stop codon may be immediately adjacent to the initiation codon or there may be one or more codons (e.g., one, two, three, four, five, ten, twenty, etc) between the initiation codon and the stop codon.

Polypeptide: As used herein, the term “polypeptide” refers to a sequence of contiguous amino acids of any length. The terms “peptide,” “oligopeptide,” or “protein” may be used interchangeably herein with the term “polypeptide.”

Hybridization: As used herein, the terms “hybridization” and “hybridizing” refer to base pairing of two complementary single-stranded nucleic acid molecules (RNA and/or DNA) to give a double stranded molecule. As used herein, two nucleic acid molecules may hybridize, although the base pairing is not completely complementary. Accordingly, mismatched bases do not prevent hybridization of two nucleic acid molecules provided that appropriate conditions, well known in the art, are used. In some aspects, hybridization is said to be under “stringent conditions.” By “stringent conditions,” as the phrase is used herein, is meant overnight incubation at 42° C. in a solution comprising: 50% formamide, 5×SSC (750 mM NaCl, 75 mM trisodium citrate), 50 mM sodium phosphate (pH 7.6), 5×Denhardt's solution, 10% dextran sulfate, and 20 μg/ml denatured, sheared salmon sperm DNA, followed by washing the filters in 0.1×SSC at about 65° C.

Other terms used in the fields of recombinant nucleic acid technology and molecular and cell biology as used herein will be generally understood by one of ordinary skill in the applicable arts.

### 2. OVERVIEW

The present invention provides subscription-based and non-subscription based systems and methods for providing research products and services (e.g., for industries involved in genomic and proteomic research). A provider of genomic and proteomic research products and services provides such products and services to customers for a fee. In exchange for payment of a subscription fee, a customer may be designated a subscriber. Subscribers are charged subscriber fees for the genomic and proteomic research products and services they request. In one embodiment, the subscriber fees are less than the fees charged to non-subscribers.

Users of the system are provided access to one or more clone collections of the provider. The users may also be given access to databases that contain data describing the attributes of the clones represented in the clone collections. In addition to providing the subscriber with access to multiple databases, the present invention enables the subscriber to identify clones to be built and added to the clone collections of the provider. Access to these clones may or may not be provided to non-subscribers and/or to other subscribers. Further, the subscriber is able to prioritize the order in which the identified clones are to be built and added to the clone collection. In this way, the clone collection can be customized and prioritized according to the research needs of the subscriber. Still further, the present invention provides research and development consulting services to one or more sites designated by the subscriber.

### 3. EXEMPLARY SYSTEM EMBODIMENTS

3.1 Genomics and Proteomics research products and services system

FIG. 1 is a block diagram illustration of a system 100 for providing genomic and proteomic products and services according to an embodiment of the present invention. In FIG. 1, a provider 105 provides genomic and proteomic products 103 and services 107 to customers.

3.1.1 Exemplary Products

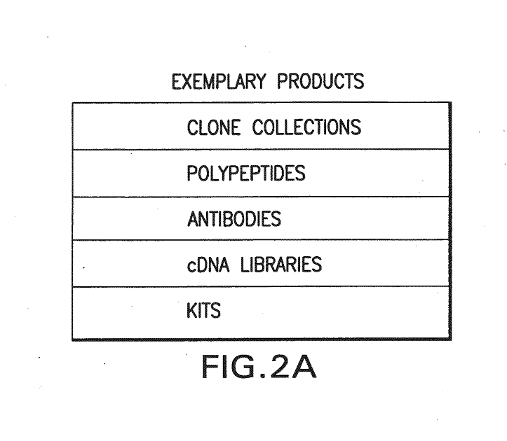

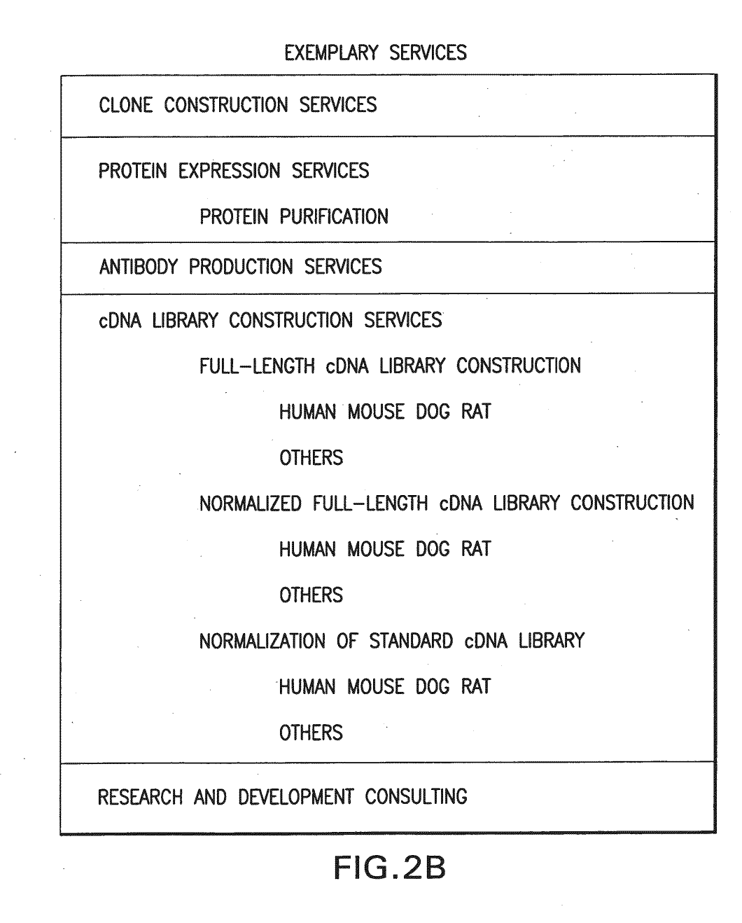

FIG. 2A provides an exemplary list of the types of products offered by the provider 105. Such products may comprise clone collections, individual clones, compositions comprising one or more clones and/or collections of clones, reaction mixtures comprising one or more clones and/or collections of clones, polypeptides, antibodies, libraries (e.g., cDNA libraries, genomic libraries, etc.), and kits, as well as individual clones. Additional details of these exemplary products are provided below. Further, these exemplary products are provided for example only and are not intended to limit the present invention.

3.1.2 Exemplary Services

FIG. 2B provides an exemplary list of the types of services offered by the provider 105. Such services include clone construction services, protein expression services, antibody production services, library (e.g., cDNA library, genomic library, etc.) construction services, and research and development consulting services. In some embodiments, library construction services may comprise construction of a library having specified characteristics (e.g., full-length, normalized, etc.). Library construction services may be performed using tissues and/or organisms of any source. In some embodiments, libraries may be constructed from human, mouse, dog, rat, and/or other mammalian tissues. Libraries may be constructed from more than one tissue source within an organism, for example, from brain, liver, kidney, pancreas, lung, heart, etc. Libraries may be normalized, full-length and/or both normalized and full-length libraries. Thus, the present invention contemplates cDNA library construction (e.g., full-length and/or normalized) for human, mouse, dog, rat, and other organisms. The invention also contemplates normalization of standard cDNA libraries (e.g., for organisms other than human, mouse, dog, or rat). Additional details of these exemplary products and services, as well as Other products and services, are provided below. Further, these exemplary services are provided for example only and are not intended to limit the present invention.

3.1.3 Customers

Referring again to FIG. 1, in an embodiment of the present invention, the exemplary products and services set out in FIGS. 2A and 2B are provided to the customers in exchange for the payment of fees associated with the products or services requested. In one embodiment of the present invention, the customers can elect to pay a subscription fee in order to be designated as a subscriber. Accordingly, the customers in FIG. 1 are shown as subscribers 112 and non-subscribers 110. In another embodiment of the present invention, subscribers 112 are able to obtain subscriber benefits offered by the provider 105.

One example subscriber benefit is the ability to purchase the products and services of the provider 115 at subscriber rates. In one embodiment of the present invention, subscriber rates are less than non-subscriber rates. An additional subscriber benefit includes the ability to access private clone collections (i.e., clone collections only made available to all or some subscribers). Another subscriber benefit includes the ability to identify clones to be built and added to the clone collections maintained by the provider 105. The ability to prioritize the order in which clones are built and added to the clone collections maintained by the provider 105 is an additional subscriber benefit. In some embodiments, a subscriber may have the ability to specify the size of a clone collection (e.g., one, ten, fifty, one hundred, five hundred, one thousand, etc.) and may also have the ability to specify when one or more specific clones are made and supplied (e.g., the clones will be made and supplied within 2 to 8, 3 to 20, 2 to 20, 4 to 20, 6 to 20, 6 to 15, etc. weeks). Yet another subscriber benefit is the ability to designate one or more sites to receive research and development consulting services from the provider 105. In one embodiment, research and development consulting services include providing the subscriber designated sites with information relating to new products and services being developed by the provider. In another embodiment, the research and development consulting services also include provider evaluation of new products and services being developed by the subscriber. In other embodiments, the number of sites that the subscriber can designate is one, two, three, four, five or six. However, the subscriber may designate more sites (e.g., eight, ten, twenty, etc.) by paying an additional fee for each additional site designated.

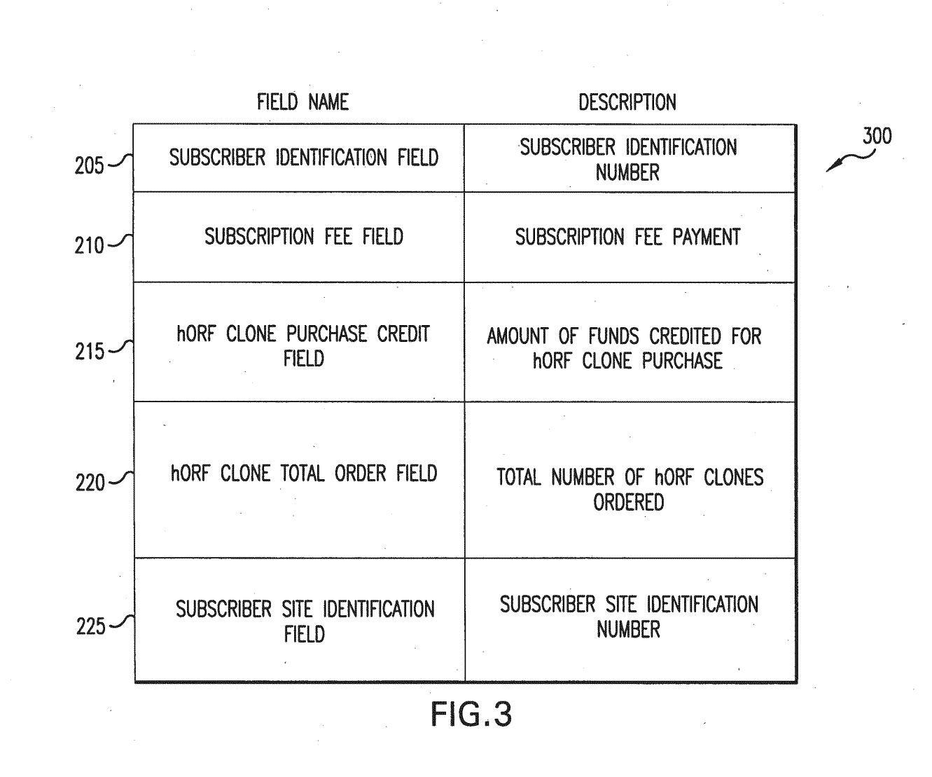

Referring to FIG. 3, for each customer who chooses to become a subscriber, a subscriber record 300 may be maintained. The subscriber record may be used to maintain information identifying each subscriber 112 and for tracking the products and services provided to each of the subscribers. In one embodiment, the subscriber record comprises a subscriber identification field 305, a subscription fee field 310, a clone purchase credit field 315, a clone total order field 320, and a subscriber site identification field 325. In this embodiment, the subscriber identification field may be used to record a unique subscriber identification number for each subscriber 112. The subscription fee field is used to record the subscription fee paid by the subscriber 112. The clone purchase credit field 315 may be used to record the amount of funds the subscriber 112 has credited toward the purchase of clones. The clone total order field may be used to record the number of clones the subscriber 112 has ordered during a designated accounting period. For example, the provider 112 could track the number of clones ordered during a month, quarter or year. The subscriber site identification field 325 may be used to record unique identifiers for one or more sites designated by the subscriber 112. In an embodiment of the present invention, the designated sites receive research and development consulting services from the provider 105. Additional subscriber record fields will be apparent to a person skilled in the relevant arts based at least on the teachings contained herein.

3.2 Exemplary Computer System Embodiment

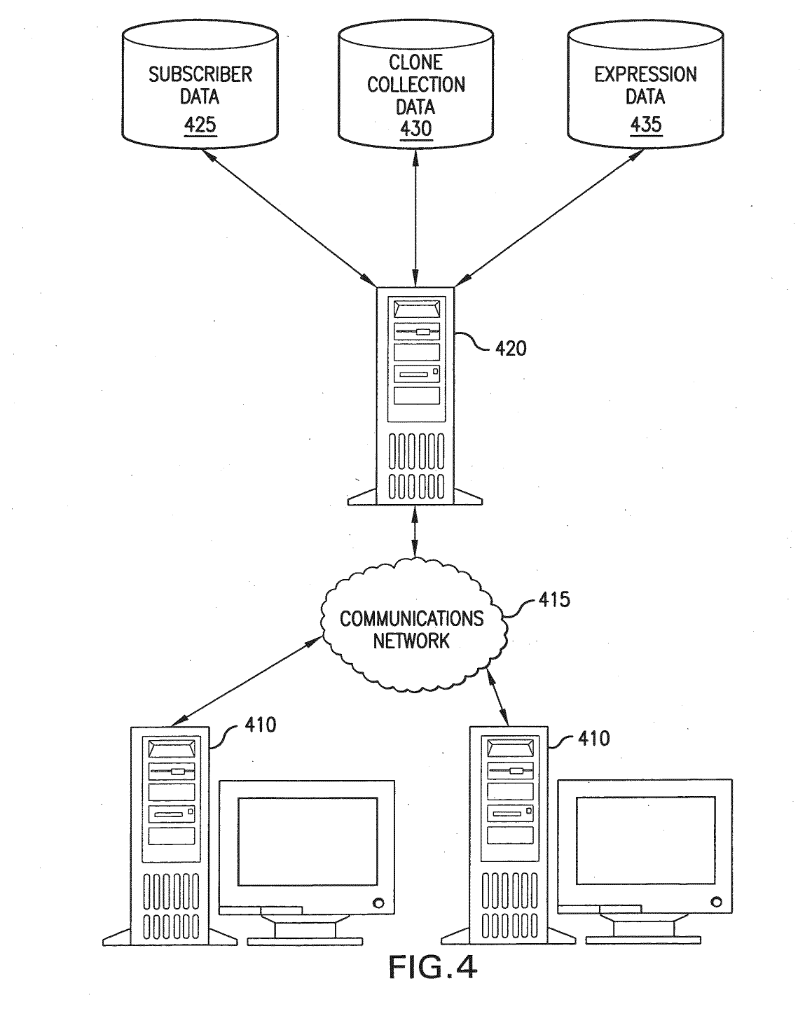

In one embodiment of the present invention, system 100 is implemented in part using one or more computer systems. FIG. 4 is a block diagram of a client/server system 400 for providing genomic and proteomic products and services according to an embodiment of the present invention.

3.2.1 Databases

In one embodiment, one or more databases are used to store data related to the genomic and proteomic products and services. In one embodiment, the databases may be organized by fields, records, and files. A field may represent a single piece of information. A record may represent one complete set of fields. Finally, a collection of records may be organized into a file. In FIG. 4, system 400 includes a subscriber database 425, a clone collection database 430, and an expression database 435.

3.2.1.1 Subscriber Database

Subscriber database 425 contains a subscriber record, such as subscriber record 300 of FIG. 3, for each subscriber of genomic and proteomic products and services.

3.2.1.2 Clone Collection Database

The clone collection database 430 is configured to store data describing the attributes of the clones available in one or more clone collections (e.g., public and/or private clone collections). Examples of attributes that may be stored in a clone collection database include, but are not limited to, the nucleotide sequence of an ORF in a clone, the source of the template used to construct the ORF, the sequences of known allelic variants of the ORF, sequences of splice variants, sites of known polymorphisms and/or mutations in the ORF (e.g., single nucleotide polymorphisms, etc.), post-translational modifications (e.g., glycosylation, protein splicing, etc.) that are known to occur to the polypeptide expressed from the ORF, sites at which such post-translational modifications occur, and other similar information. Clone collection databases may comprise attributes of the polypeptides expressed from one or more clones. Attributes of a polypeptide that a clone collection database may comprise include, but are not limited to, the amino acid sequence, amino acid residues known to be involved in one or more activity (e.g., active site residues, epitopes, etc.), locations of structural and/or functional domains, molecular weight, isoelectric point, catalytic activities, number and kind of post-translational modifications, amino acids that are post-translationally modified, the amino acid sequence of structurally related polypeptides, and the like.

Clone collection databases may be searchable (e.g., with a nucleotide and/or polypeptide sequence). In some embodiments, it may be possible to search a clone collection database with all or a portion of the amino acid sequence of a polypeptide in order to identify clones encoding all or a portion of the polypeptide or encoding all or a portion of one or more related polypeptides. In some embodiments, the amino acid sequence of a portion of a polypeptide (e.g., a structural and/or functional domain, an amino acid motif, etc.) may be used to search a clone collection database to identify one or more clones encoding polypeptides that have an amino acid sequence similar to the search sequence (e.g., have a similar domain and/or motif).

In some embodiments, a clone collection database may contain sequence information. Such sequence information may or may not be of any particular clone present in the collection. For example, a clone collection database may have sequence information concerning one or more nucleic acids, which may encode one or more polypeptides, that are not present in a clone collection. In some embodiments, a subscriber may request that a clone be prepared from all or a part of such a sequence.

In one embodiment of the present invention, the clone collection database 430 includes a private area and a public area. The private area of clone collection database 430 maintains information describing clones that are only available to one or more subscribers. The public area of the clone collection database 430 maintains information describing the clones from the provider's clone collections that are available to everyone (i.e., all customers).

3.2.1.3 Expression Database

The expression database 435 is configured to store data describing the results of protein expression analyses performed for the clones in the clone collections. In this way, optimized protein expression systems identifying the best vector and host for a particular clone are readily accessible.

In addition to vector and host systems, a protein expression database may comprise information related to codon usage in one or more hosts. The optimum codon usage based on any particular host may be identified. Clones employing the optimum codon usage may be constructed and added to a clone collection in order to optimize the expression of one or more polypeptides in one or more hosts. In some embodiments, clones in a clone collection may encode polypeptides using optimized codons for a particular organism (e.g., E. coli, yeast, insect cells, mammalian cells, etc.). A clone collection may comprise multiple sequences encoding the same polypeptide but employing different codons in order to optimize the expression of the polypeptide in a variety of host cells.

In addition, protein expression databases may comprise other information including, but not limited to, information regarding the characteristics of a polypeptide expressed from an ORF in the clone collection. Characteristics that might be included include the molecular weight of the expressed polypeptide, the site, extent and nature of post-translational modification undergone by the polypeptide in its native organism, the specific activity of the polypeptide, known stimulators and/or inhibitors of an activity of the polypeptide, physiological role of the polypeptide in its native organism, and similar information.

3.2.1.4 Client/Server Architecture

A provider server 420 provides access to subscriber database 425, clone collection database 430, and expression database 435. Customer computer systems 410 are connected to provider server 420 via a communications network 415 (such as a local area network, a wide area network, point-to-point links, the Internet, etc., or combinations thereof). Users may access and traverse the functions provided by the provider server 420 in any number of ways via interaction with menus or icons provided by a user interface. Other ways of accessing system 400 will be apparent to persons skilled in the relevant arts based at least on the teachings contained herein.

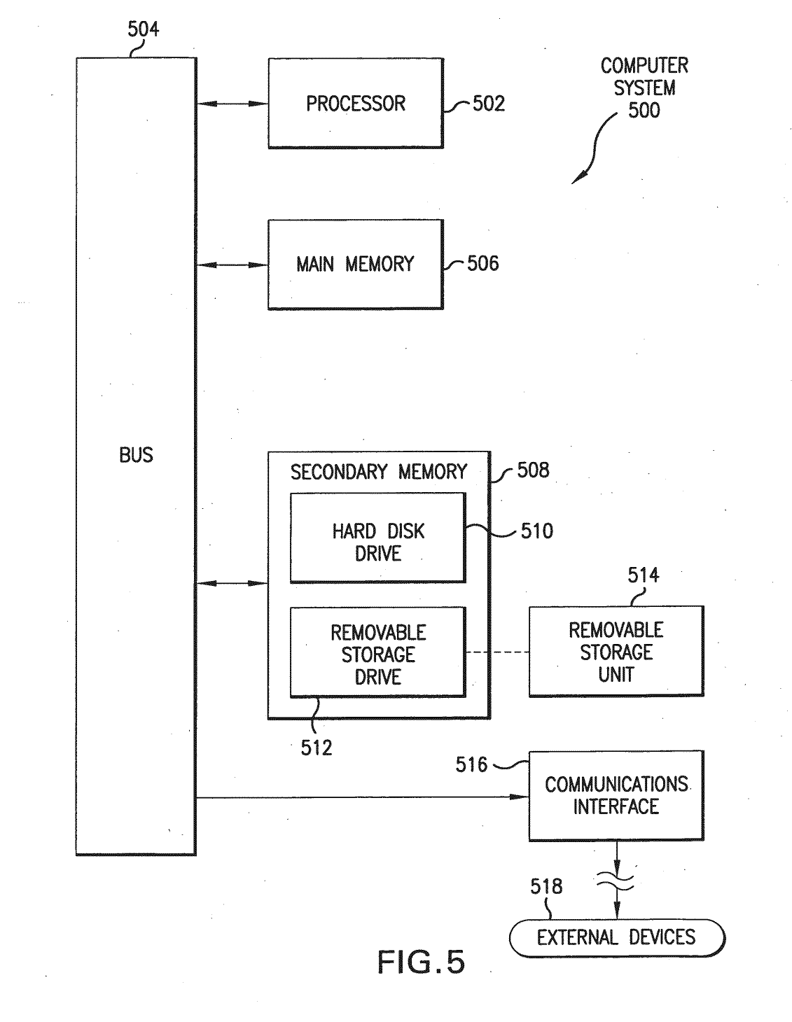

In an embodiment, the provider server 420 and the customer systems 410 are implemented using a computer system 500 such as that shown in FIG. 5.

Referring to FIG. 5, the computer system 500 includes one or more processors 502. Processor 502 is connected to a communication bus 504. The computer system 500 also includes a main memory 506. Main memory 506 is preferably random access memory (RAM). Computer system 500 further includes secondary memory 508. Secondary memory 508 includes, for example, hard disk drive 510 and/or removable storage drive 512. Removable storage drive 512 could be, for example, a floppy disk drive, a magnetic tape drive, a compact disk drive, a program cartridge and cartridge interface, or a removable memory chip. Removable storage drive 512 reads from and writes to a removable storage unit 514. Removable storage unit 514, also called a program storage device or computer program product, represents a floppy disk, magnetic tape, compact disk, or other data storage device. Computer programs or computer control logic are stored in main memory 506 and/or secondary memory 508 and/or removable storage unit 514. When executed, these computer programs enable the provider server 420 and customer systems 410 to perform various functions of the present invention as discussed herein. In particular, the computer programs enable the processor 502 to perform some of the functions of the present invention. Accordingly, such computer programs represent controllers of the system 400. Computer system 500 further includes a communications interface 516. Communications interface 516 facilitates communications between computer system 500 and local or remote external devices 518. External devices 518 could be, for example, personal computers, displays, databases, and additional computer systems 500. In particular, communications interface 516 enables computer system 500 to send and receive software and data to/from external devices 518 via signals, which are also herein referred to as computer program products. Examples of communications interface 516 include a modem, a network interface, and a communications port.

### 4. EXEMPLARY OPERATIONAL EMBODIMENTS

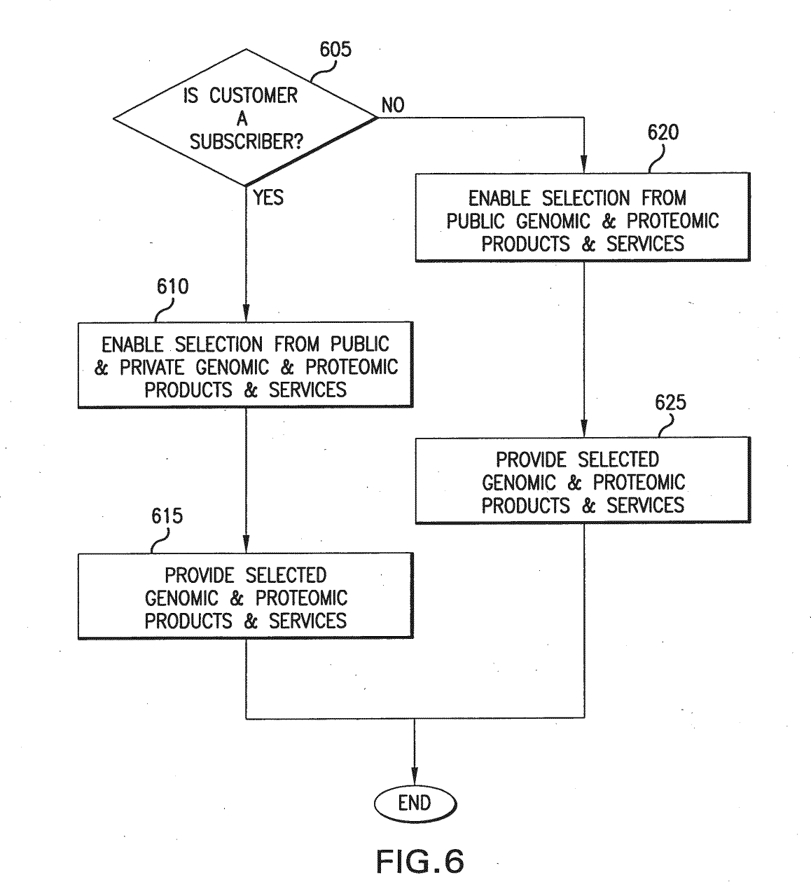

Exemplary methods for providing genomic and proteomic products and services in accordance with embodiments of the present invention will now be described with reference to FIG. 1, FIG. 4, and the steps described in FIGS. 6-8 and 10.

4.1 Accessing Genomic and Proteomic Research Products and Services

Referring to FIG. 6, in a step 605, a determination may be made as to whether a customer is a subscriber or not. The results of this determination will often dictate the nature, extent, configuration, and other details of products and services to which the customer is provided access.

Next, if the customer is a subscriber, then the customer may be presented with means for enabling the selection of public and private genomic and proteomic products and services from the provider 105 (step 610). In one embodiment, a listing of available products and services is provided to the customer on a display associated with a customer computer system such as customer system 410 illustrated in FIG. 4. The user is then able to select products and services from the list using an input device such as a keyboard or mouse.

Once a product or service has been selected, in a step 615, the provider 105 responds by providing the selected product or service at an established subscriber rate.

Alternatively, where the customer is not a subscriber, in a step 620, the customer may be, for example, presented with means for enabling the selection of public genomic and proteomic products and services from the provider 105. The products and services available to a non-subscriber may be the same or different from those available to a subscriber. In some embodiments, more products and services may be available to a subscriber than are available to a non-subscriber.

Once a product or service has been selected, in a step 625, the provider 105 responds by providing the selected product or service at an established non-subscriber rate.

Steps 610 or 620 provide the subscribers and non-subscribers with multiple products and services from which to choose. Accordingly, in steps 615 or 625, a variety of operational flows could be executed; such operational flows are within the scope and spirit of the invention. Further, as a consequence, of providing a particular product or service, the need for additional products or services may arise. Accordingly, in an embodiment of the present invention, the need for additional products and services is anticipated.

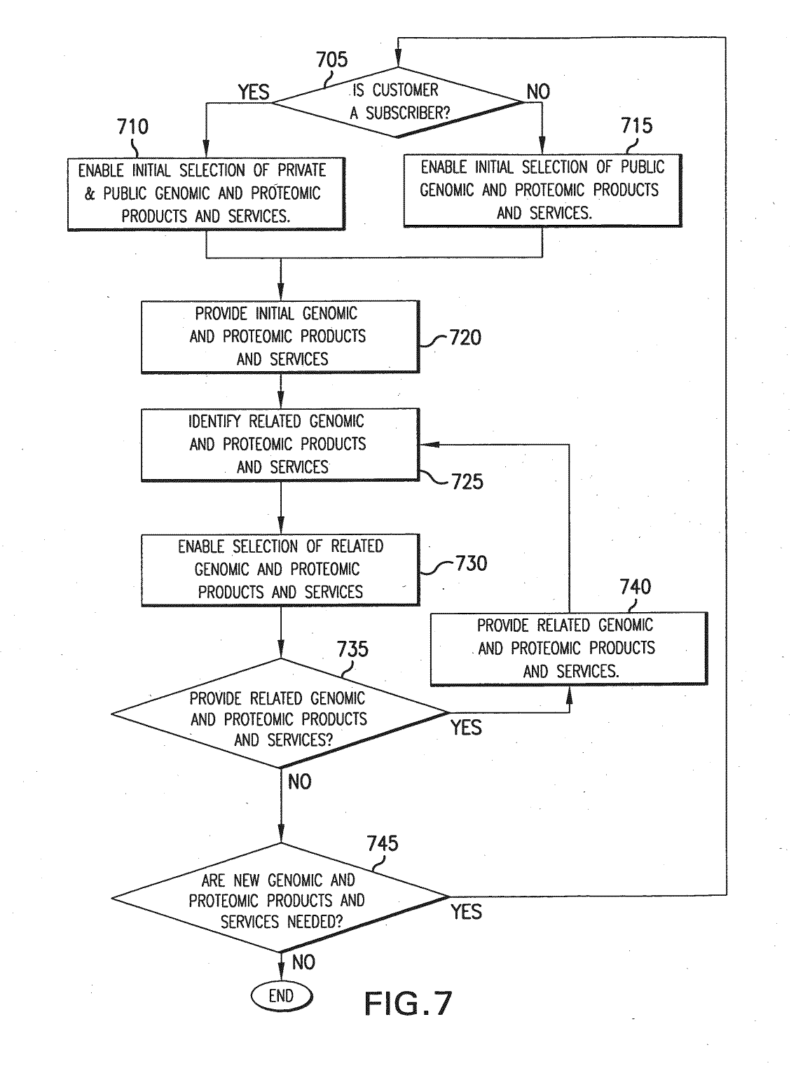

An exemplary method for providing additional products and services related to an initial product or service provided to the subscribers and non-subscribers in now provided with reference to FIG. 7.

In step 705, a determination is made as to whether a customer is a subscriber or not. The results of this determination will dictate the nature, extent, configuration, and other details of products and services to which the customer is provided access.

Next, if the customer is a subscriber, then the customer is presented with means for enabling the selection of public and private genomic and proteomic products and services from the provider 105 (step 710).

Alternatively, where the customer is not a subscriber, in a step 715, the customer is presented with means for enabling the selection of public genomic and proteomic products and services from the provider 105.

In one embodiment, a listing of available products and services is provided to the customer on a display associated with a customer computer system such as customer system 410 illustrated in FIG. 4. The user is then able to select products and services from the list using an input device such as a keyboard or mouse.

Once an initial selection of products or services has been made, in a step 720, the provider 105 responds by providing the selected initial product or service. In one embodiment, the customer will be charged a subscriber rate or a non-subscriber rate for the selected product or service.

In a step 725, products or services that are related to the initial products or services provided are identified. For example, an initial product may be a clone from a clone collection, related products would include, but not be limited to, a polypeptide encoded by the clone, an expression system (e.g., a vector comprising the ORF for the polypeptide and a suitable host cell) for expressing the polypeptide, antibodies that specifically bind to the polypeptide, reagents for assaying an activity of the polypeptide and the like. Related services may include the production of any related product, for example, expression and purification of the polypeptide, production of antibodies specific to the polypeptide, and the like.

Next, the customer is presented with means for enabling the selection of the identified products or services that are related to the initially provided product or service (step 730).

If the customer elects to obtain a related product or service (step 735), the provider 105 responds by providing the related product or service (step 740).

If the customer does not wish to obtain the related product or service, in a step 745, he or she can elect to request new products or services. In this case, the customer is again presented with the option of selecting initial genomic and proteomic products and services (steps 710 or 715).

4.2 Providing Genomic and Proteomic Research Products and Services

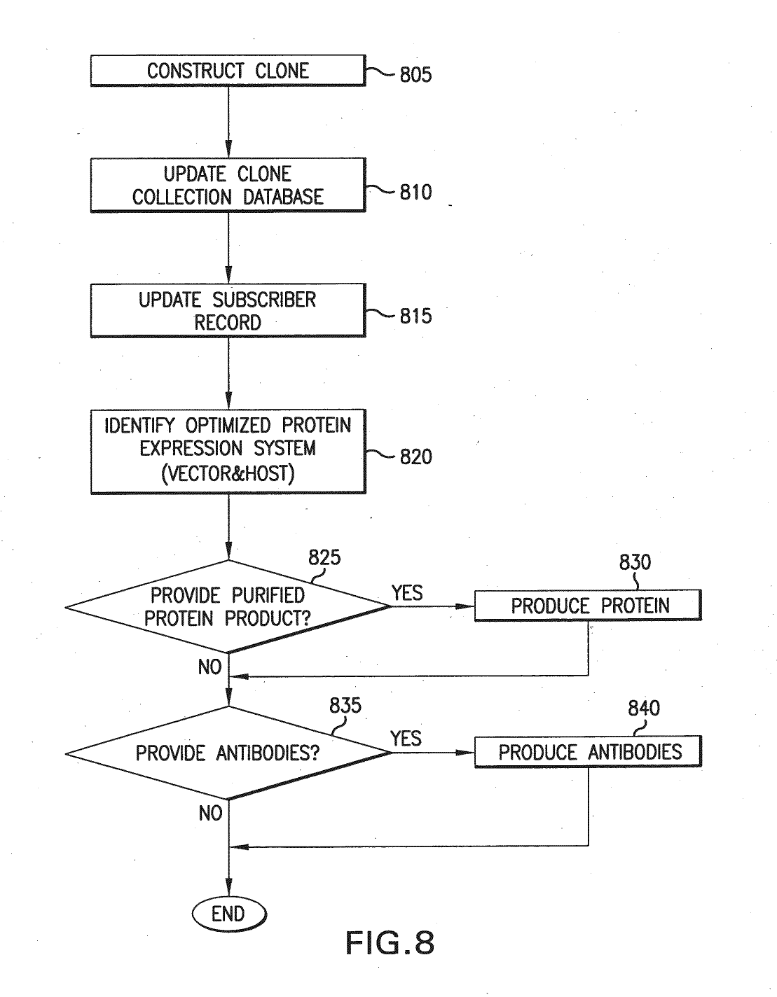

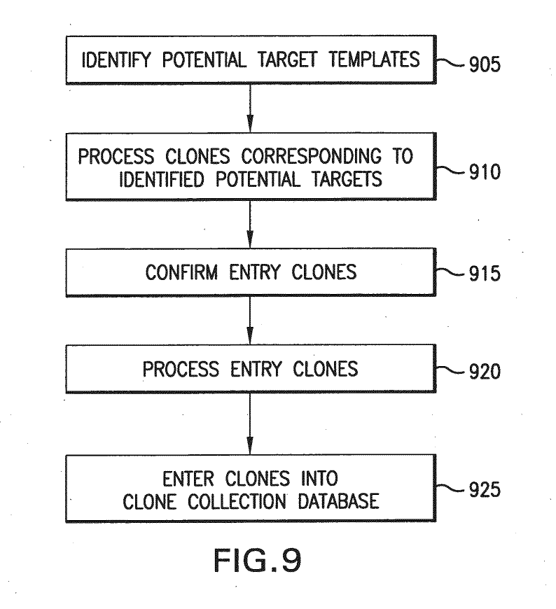

Requesting clone construction is one service that can be requested by both subscribers and non-subscribers and is likely to lead to the need for additional products or services. FIGS. 8 and 9 will now be used to describe an exemplary method for providing clone construction and activities related thereto in accordance with one embodiment of the present invention.

In a step 805, the provider constructs one or more clones in response to a customer's selection of this service. An exemplary method for constructing clones is described with reference to the steps shown in FIG. 9.

In a step 905, target templates are identified. A target template may be a nucleic acid molecule that contains a nucleic acid sequence of interest that a customer desires to be included in a clone. In an embodiment of the present invention, all or a portion of a nucleic acid sequence of interest may be compared (e.g., BLASTed) against a number of available public and/or private clone databases in order to identify potential templates from which to amplify corresponding sequence of interest (e.g., ORF).

Next, in a step 910, clones corresponding to the identified potential templates are processed. The desired template is isolated and a clone comprising the desired nucleic acid sequence is prepared from the template using standard techniques (e.g., PCR cloning, recombinational cloning, restriction digest and ligation cloning, topoisomerase-mediated cloning, etc.). For example, the desired nucleic acid sequence of interest may be amplified form a template using PCR primers that flank the desired sequence. PCR primers may contain sequences corresponding to one or more recognition sites. For example, a PCR primer may contain the sequence of all or a portion of a recombination site, all or a portion of a topoisomerase site, all or a portion of a restriction enzyme site, or combinations of the above. After amplification, the amplification product may be inserted into one or more vectors making use of one or more of the recognition sites. For example, after PCR, an amplification product comprising recombination sites may be contacted with one or more vectors comprising compatible recombination sites and one or more recombination proteins under conditions causing the amplification product to be inserted in the vector.

A clone comprises a nucleic acid sequence of interest. A nucleic acid sequence of interest may be any nucleic acid sequence. For example, a nucleic acid sequence of interest may comprise an ORF. The ORF may correspond to all or a portion of a polypeptide (e.g., may be a full-length ORF or a partial ORF). A sequence comprising an ORF may further comprise one or more stop codons, one or more promoters, one or more enhancers, one or more polyadenylation sites, one or more splice sites or other sequences known to those skilled in the art. A nucleic acid sequence of interest may comprise a sequence of an un-translated RNA molecule. For example, a sequence of interest may comprise the sequence of a tRNA, a ribozyme, an RNAi, an anti-sense molecule and the like.

In one embodiment, full-length clones that correspond to the targets are inoculated into 96-well Bio-Blocks for subsequent mini-preps. In parallel, PCR primers, which flank each ORF including the stop codon, are designed. In an embodiment, primers include the full attB 1 and attB2 sites. In this way, subsequent cloning of the amplicons into a Gateway-compatible donor vector (e.g. pDoNR221) can be performed. Primers may be synthesized at a 50 nmol scale, desalted purity, in the same format as the arrayed clones (96-well) in order to facilitate set-up of the amplification reactions. For those targets which are deemed vital to the collection but are not present within the clone collections, the provider utilizes its collection of >50 full-length and normalized full-length human cDNA libraries as potential templates from which to amplify the ORF. Primer design and synthesis proceeds as described earlier. Amplification of the ORF proceeds using a DNA polymerase, preferably one with proofreading activity (e.g. Platinum Pfx), under conditions which will minimize the potential for PCR-induced nucleotide mutations (e.g. base changes, insertions, deletions). Immediately following amplification, products are run out on a 1% agarose gel containing ethidium bromide (0.25 μg/ml) and visualized on a gel documentation system in order to confirm amplification of the correct product. Products are then purified in a 96-well format using a commercially available filter plate to remove excess primer and unincorporated nucleotides. Purified PCR products are then reacted with pDoNR221 in a BxP Gateway™ cloning reaction in a 96-well format to produce entry clones. Upon termination of the BxP reaction with proteinase K, DNA is transformed, for example, into MultiShot™ TOP10 chemically competent E. coli and selected on solid medium containing kanamycin (50 μg/ml). One or two individual antibiotic-resistant colonies are then selected per clone and subjected to diagnostic PCR using vector-specific primers in order to confirm presence of the ORF insert within the entry vector.

Next, in a step 915, the entry clones produced in step 910 are confirmed. In one embodiment, confirmation is achieved via agarose gel electrophoresis and subsequent visualization on a gel documentation system.

Processing of the entry clones continues in step 920. In one embodiment, confirmed entry clones from step 915 are inoculated into liquid media containing kanamycin (50 μg/ml) and cultured overnight for the purpose of producing glycerol stocks of each of the entry clones. Full-length nucleotide sequence verification of the glycerol stocks is then completed. The confirmed entry clones are then prepped and initially subjected to 5′ and 3′ end sequencing using the universal sequencing sites within the vector. Full-length sequencing proceeds via primer walking and results in 2× coverage of the ORFs.

Finally, in step 925, once the sequence data is annotated and confirmed, the entry clones are entered into the clone collection. In one embodiment, the clone is added to either the public clone collection or the private clone collection.

In accordance with an embodiment of the present invention, the customer is able to identify the clones that are built and added to the clone collection. Further, the subscriber may stipulate the order in which clones are built and added to the clone collection. In this way, the populating of the clone collection is prioritized to meet the research needs of the subscriber.

Returning to FIG. 8, once the clones have been constructed and added to the clone collection, in a step 810, the clone collection database may be updated with information describing the attributes of the newly added entry clones.

In a step 815, where the customer is a subscriber, the subscriber record for the customer may be updated. Accordingly, the amount of funds credited for clone purchases may be reduced by an amount equal to the subscriber fee for this service. Additionally, the total number of clones ordered is incremented by an amount equal to the number of clones ordered.

In a step 820, the provider identifies optimized protein expression systems for one or more of the clones in the clone collection. In one embodiment, data describing the characteristics of the optimized protein expression systems is maintained in the expression database 435. Optimized protein expression systems may identify the vector and host shown to yield protein of a particular type or quantity. An optimized protein expression system may identify codons to be used for one or more amino acids that result in improved expression in one or more host cells. One or more clones may be constructed that use one or more of the optimized codons to encode the polypeptide to be expressed. By taking advantage of this service, the customer can avoid the time and expense involved with identifying optimized protein expression systems on their own.

In a step 825, the provider determines if the customer would like to obtain protein produced by any of the clones in the clone collection. If protein is desired, then in step 830, the purified protein products are produced and/or provided to the customer.

In a step 835, the provider determines if the customer would like to obtain antibodies produced by any of the clones in the clone collection. If antibodies are desired, then in step 840, antibody products are provided to the customer.

In accordance with the above described system and methods, a customer is able to obtain customized genomic and proteomic products and services. In this way, a single resource for assisting with the efficient identification of pharmacologically accessible targets is realized.

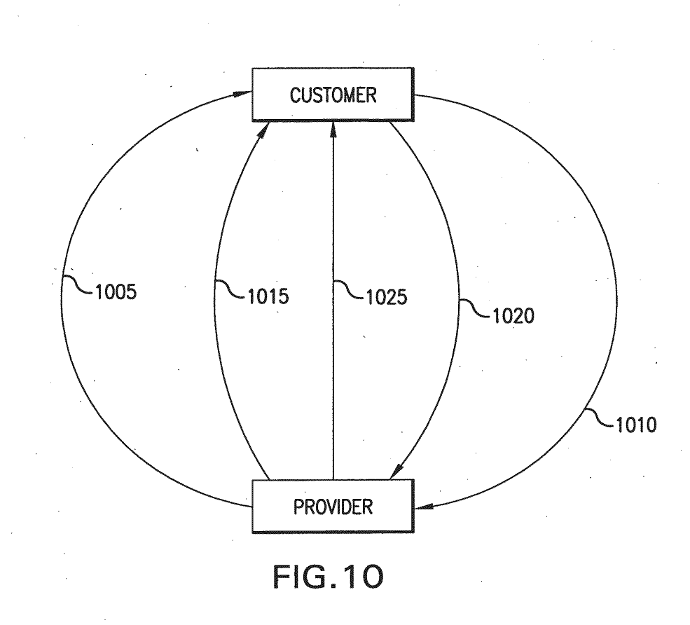

FIG. 10 illustrates yet another exemplary method for iteratively providing genomic and proteomic products and services in accordance with one embodiment of the present invention.

In a step 1005, customers are given access to one or more databases by the provider.

In a step 1010, customers may request a product or service, such as requesting reagents, for example.

In response, in a step 1015, the provider supplies the requested reagents.

Next, in a step 1020, customers may request additional reagents related to the originally requested product or service. For example, customers may request protein antibodies, etc.

In response, in a step 1025, the provider supplies the related reagents requested by the customers.

The steps described herein are presented for explanation only and are not intended to limit the present invention. Based at least on the teachings described herein, a person skilled in the relevant arts will recognize that one or more steps could be added or removed without departing from the spirit and scope of the present invention. Further details of the products and services available in accordance with embodiments of the present invention will now be described.

### 5. DETAILED EXEMPLARY PRODUCTS DESCRIPTION

### Clone Collections.

In some embodiments of the invention, a collection of clones (e.g., clones comprising an ORF or other sequence of interest) may be constructed. A collection of clones may be constructed in response to a request from a subscriber and may comprise one or more sequences identified by a subscriber. A clone collection may comprise clones comprising any sequences that are of interest to a subscriber. A clone collection may contain sequences representing all, substantially all, a majority, or a representative number of all known members of a class of polypeptides. For example, a collection may contain clones comprising ORFs of all known polypeptides having a particular activity and/or characteristic of interest (e.g., all human polypeptides having a particular enzymatic activity of interest).

Collections may comprise clones comprising ORFs encoding all, substantially all, a majority, or a representative number of polypeptides related to and/or affected by a particular activity. For example, a collection may comprise clones comprising ORFs relating to or affected by a particular ligand. Clones in a collection of this type might comprise ORFs encoding signal transduction polypeptides (e.g., receptors), related signaling polypeptides (e.g., polypeptides involved in signaling pathways), and polypeptides affected by the ligand (e.g., polypeptides induced, repressed, activated, in-activated, etc.).

Collections may comprise clones comprising ORFs encoding all, substantially all, a majority, or a representative number of polypeptides involved in the metabolism (e.g., synthesis and degradation) of a metabolite of interest (e.g., a lipid, carbohydrate, peptide, etc.) as well as clones comprising ORFs encoding the polypeptides affected by the metabolite. For example, a collection may contain clones comprising ORFs encoding the enzymes of the biosynthetic pathway that results in the production of a metabolite of interest, those involved in the degradative pathway of the metabolite as well as those affected by the presence or absence of the metabolite. Representative metabolites include, but are not limited to, lipids (e.g., eicosanoids, prostaglandins, prostacyclins, thromboxanes, leukotrienes, steroid hormones, etc.) carbohydrates (e.g., inositol phosphate), peptides (e.g., cytokines, chemokines, interleukins, growth factors) and the like.

Examples of collections that may be prepared include, but are not limited to, those in Tables 1-15 or subsets thereof. Tables 1-15 contain the GenBank accession numbers of sequences relating to various molecules of interest (e.g., polypeptides, hormones, small molecules, etc.). Sequences relating to a molecule of interest may comprise sequences of the molecules of interest (e.g., when the molecule of interest is a polypeptide or nucleic acid), sequences of polypeptides involved in the metabolism (e.g., synthesis and/or degradation) of the molecule of interest, sequences of polypeptides that are affected by the molecule of interest (directly or indirectly), and/or polypeptides involved in signaling or other processes mediated by the molecule of interest. The accession numbers of the sequences listed in the tables, as well as the underlying full GenBank record of each accession number (e.g., sequences and references cited) are specifically incorporated herein by reference.

Nucleic acid sequences of interest to be included in a clone collection of the invention (e.g., ORFs, tRNAs, ribozymes, RNA is, 5′-un-translated regions, promoters, enhancers, etc.) may be provided in any suitable vector for inclusion in a collection. In some instances, it may be desirable to position a nucleic acid sequence of interest (e.g., an ORF or other nucleic acid of interest) in the vector such that the orientation of the nucleic acid sequence of interest with respect to the vector is controlled. This may be accomplished by equipping nucleic acid sequence of interest with one or more adapter sequences prior to inserting the nucleic acid into the vector. Adapter sequences may comprise one or more functional sites such as one or more recognition sites (e.g., restriction enzyme recognition sites, one or more recombination sites and/or one or more topoisomerase recognition sites). Suitable adapter sequences may be attached to a nucleic acid sequence of interest using techniques well known in the art, for example, by ligating an adapter to the nucleic acid or by amplifying the nucleic acid with a primer containing the adapter sequences.

Clone collections of the invention may contain two or more clones (e.g., a plurality of individual clones each comprising a vector and a nucleic acid sequence of interest or insert). In many instances, the nucleic acid inserts will reside in a vector such that the insert is not normally transcribed. In such instances, the vectors of the clone collection may be used to propagate and/or transfer the inserts to other nucleic acid molecules (e.g., vectors, chromosomes, etc.). In other instances, clone collections of the invention will be designed so that nucleic acid insert is operably linked to an expression control element (e.g., a promoter). Regardless of whether the nucleic acid insert resides in a vector in an expressible format, the insert may be linked to nucleic acid which is co-transcribed with the insert under appropriate conditions. As an example, when the nucleic acid insert is an ORF, the ORF may be linked to nucleic acid which encodes an amino acid sequence which is not normally associated with the expression product of the ORF. Thus, upon transcription and translation, a fusion protein is produced.

As explained elsewhere herein, fusion proteins may be produced when stop codon suppression is employed. In other words, a stop codon may be located between the ORF and the nucleic acid which encodes the other amino acid sequence and stop codon suppression can be used to generate a fusion product. Of course, expression of the ORF in the absence of stop codon suppression will yield the product of the ORF without the other amino acid sequence.

As noted above, clone collections of the invention may contain essentially any number of clones. Further, these clones may encode RNA and/or polypeptide fusion products. Clone collections of the invention may contain from about 2 to about 100,000 clones, from about 2 to about 50,000 clones, from about 2 to about 40,000 clones, from about 2 to about 30,000 clones, from about 2 to about 20,000 clones, from about 2 to about 10,000 clones, from about 2 to about 5,000 clones, from about 2 to about 2,000 clones, from about 20 to about 100,000 clones, from about 20 to about 50,000 clones, from about 20 to about 30,000 clones, from about 20 to about 20,000 clones, from about 20 to about 10,000 clones, from about 20 to about 5,000 clones, from about 50 to about 100,000 clones, from about 50 to about 50,000 clones, from about 50 to about 40,000 clones, from about 50 to about 30,000 clones, from about 50 to about 20,000 clones, from about 50 to about 10,000 clones, from about 50 to about 5,000 clones, from about 50 to about 3,000 clones, from about 50 to about 1,000 clones, from about 100 to about 100,000 clones, from about 100 to about 50,000 clones, from about 100 to about 40,000 clones, from about 100 to about 30,000 clones, from about 100 to about 20,000 clones, from about 100 to about 10,000 clones, from about 100 to about 5,000 clones, from about 100 to about 3,000 clones, from about 200 to about 100,000 clones, from about 200 to about 50,000 clones, from about 200 to about 40,000 clones, from about 200 to about 30,000 clones, from about 200 to about 20,000 clones, from about 200 to about 10,000 clones, from about 200 to about 5,000 clones, from about 200 to about 4,000 clones, from about 200 to about 3,000 clones, from about 200 to about 2,000 clones, from about 200 to about 1,000 clones, from about 300 to about 100,000 clones, from about 300 to about 50,000 clones, from about 30 to about 30,000 clones, from about 300 to about 20,000 clones, from about 300 to about 10,000 clones, from about 300 to about 5,000 clones, from about 300 to about 3,000 clones, from about 300 to about 2,000 clones, from about 300 to about 1,000 clones, from about 400 to about 100,000 clones, from about 400 to about 50,000 clones, from about 400 to about 30,000 clones, from about 400 to about 10,000 clones, from about 400 to about 5,000 clones, from about 400 to about 3,000 clones, from about 400 to about 2,000 clones, from about 400 to about 1,000 clones, from about 500 to about 100,000 clones, from about 500 to about 50,000 clones, from about 500 to about 25,000 clones, from about 500 to about 10,000 clones, from about 500 to about 5,000 clones, from about 500 to about 3,000 clones, from about 500 to about 2,000 clones, from about 500 to about 1,000 clones, from about 750 to about 100,000 clones, from about 750 to about 50,000 clones, from about 750 to about 30,000 clones, from about 750 to about 10,000 clones, from about 750 to about 5,000 clones, from about 750 to about 3,000 clones, from about 750 to about 2,000 clones, from about 750 to about 1,000 clones, from about 1,000 to about 100,000 clones, from about 1,000 to about 50,000 clones, from about 1,000 to about 30,000 clones, from about 1,000 to about 10,000 clones, from about 1,000 to about 5,000 clones, from about 1,000 to about 3,000 clones, from about 2,000 to about 100,000 clones, from about 2,000 to about 50,000 clones, from about 2,000 to about 30,000 clones, from about 2,000 to about 10,000 clones, from about 2,000 to about 5,000 clones, from about 2,000 to about 150,000 clones, from about 2,000 to about 200,000 clones, from about 2,000 to about 300,000 clones, from about 2,000 to about 400,000 clones, from about 2,000 to about 500,000 clones, from about 2,000 to about 600,000 clones, from about 2,000 to about 800,000 clones, from about 2,000 to about 1,000,000 clones, from about 5,000 to about 1,000,000 clones, from about 5,000 to about 500,000 clones, from about 5,000 to about 250,000 clones, from about 5,000 to about 100,000 clones, from about 5,000 to about 50,000 clones, from about 5,000 to about 25,000 clones, from about 5,000 to about 10,000 clones, from about 10,000 to about 100,000 clones, from about 10,000 to about 250,000 clones, from about 10,000 to about 500,000 clones, from about 10,000 to about 750,000 clones, from about 10,000 to about 1,000,000 clones, from about 10,000 to about 50,000 clones, from about 10,000 to about 25,000 clones, from about 20,000 to about 100,000 clones, from about 20,000 to about 250,000 clones, from about 20,000 to about 500,000 clones, from about 20,000 to about 1,000,000 clones, from about 20,000 to about 50,000 clones, from about 20,000 to about 40,000 clones, from about 40,000 to about 100,000 clones, from about 40,000 to about 250,000 clones, from about 40,000 to about 500,000 clones, from about 40,000 to about 1,000,000 clones, from about 40,000 to about 75,000 clones, from about 60,000 to about 80,000 clones, from about 60,000 to about 100,000 clones, from about 60,000 to about 250,000 clones, from about 60,000 to about 500,000 clones, or from about 60,000 to about 1,000,000 clones.

A clone collection may comprise clones containing any nucleic acid sequences of interest. As examples, collections of clones which encode proteins involved in the same or related biological processes (see Tables 1-15); clones with inserts from a particular/individual organism (e.g., a human), clones with inserts from a particular species of organism, and clones with inserts from a particular strain of an organism (e.g., E. coli K12). In some embodiments; a clone collection may comprise nucleic acid sequences of interest that are derived from human, mouse, dog, rat, and/or other mammalian tissues. Clone collections may be constructed from more than one tissue source within an organism, for example, from brain, liver, kidney, pancreas, lung, heart, etc.

Nucleic acid segments used to prepare clones of collections of the invention may or may not contain one or more recombination sites and/or one or more topoisomerase recognition site. Further, in some collections, some clones may contain one or more recombination sites and/or one or more topoisomerase recognition site while other clones may not contain any such sites.

In some instances, a clone to be included in a clone collection may comprise a vector containing an ORF. A vector may be provided with one or more functional sequences. Functional sequences on the vector may be used to control the expression of a polypeptide of interest from an ORF and to influence the characteristics of the expressed polypeptide. Such sequences may be located anywhere in the vector that allows them to exert their function. For example, a vector may comprise a variety of sequences including, but not limited to, sequences suitable for use as primer sites (e.g., sequences to which a primer, such as a sequencing primer or amplification primer may hybridize to initiate nucleic acid synthesis, amplification or sequencing), transcription or translation signals or regulatory sequences such as promoters and/or enhancers, ribosomal binding sites, Kozak sequences, start codons, termination signals such as stop codons, origins of replication, recombination sites (or portions thereof), selectable markers, and ORFs or portions of ORFs to create protein fusions (e.g., N-terminal or C-terminal) such as GST, GUS, GFP, YFP, CFP, maltose binding protein, 6 histidines (HIS6), epitopes, haptens and the like and combinations thereof. In some embodiments, any one or more of the functional sequences discussed above may be operably linked to an ORF to form a nucleic acid sequence of interest comprising the ORF and one or more functional sequences. Thus functional sequences may be provided on a vector and/or as part of a nucleic acid sequence of interest.

An ORF may be cloned from a known sequence (e.g., all or a part of a sequence having a GenBank accession number) using standard techniques (see, Sambrook, et al., supra). For example, PCR amplification may be conducted using a template nucleic acid comprising the ORF. In some embodiments, primers for amplification may comprise all or a portion of one or more recognition sequences (e.g., restriction sites, topoisomerase recognition sites, and/or recombination sites). The amplification product may be inserted into a nucleic acid molecule (e.g., a vector) using techniques known in the art. In some preferred embodiments, primers for amplification of an ORF may comprise a recombination site and the amplification product may be inserted into a vector using GATEWAY™ recombinational cloning techniques available from Invitrogen Corporation, Carlsbad, Calif.

After cloning an ORF into a vector, the entire ORF may be sequenced to ensure that the cloned ORF has the desired sequence. Sequencing may be accomplished using standard techniques (e.g., dideoxy sequencing).

In some embodiments, ORFs of the invention and/or vectors comprising the ORFs of the invention may be provided with one or more recombination sites. Recombination sites for use in the invention may be any nucleic acid that can serve as a substrate in a recombination reaction. Such recombination sites may be wild-type or naturally occurring recombination sites, or modified, variant, derivative, or mutant recombination sites. Examples of recombination sites for use in the invention include, but are not limited to, phage-lambda recombination sites (such as attP, attB, attL, and attR and mutants or derivatives thereof) and recombination sites from other bacteriophages such as phi80, P22, P2, 186, P4 and P1 (including lox sites such as loxP and loxP511).

Recombination proteins and mutant, modified, variant, or derivative recombination sites for use in the invention include those described in U.S. Pat. Nos. 5,888,732, 6,143,557, 6,171,861, 6,270,969, and 6,277,608 and in U.S. application Ser. No. 09/438,358 (filed Nov. 12, 1999), based upon U.S. provisional application No. 60/108,324 (filed Nov. 13, 1998). Mutated att sites (e.g., attB 1-10, attP 1-10, attR 1-10 and attL 1-10) are described in U.S. provisional patent application Nos. 60/122,389, filed Mar. 2, 1999, 60/126,049, filed Mar. 23, 1999, 60/136,744, filed May 28, 1999, 60/169,983, filed Dec. 10, 1999, and 60/188,000, filed Mar. 9, 2000, and in U.S. application Ser. No. 09/517,466, filed Mar. 2, 2000, and 09/732,914, filed Dec. 11, 2000 (published as 20020007051-A1) the disclosures of which are specifically incorporated herein by reference in their entirety. Other suitable recombination sites and proteins are those associated with the GATEWAY™ Cloning Technology available from Invitrogen Corp., Carlsbad, Calif., and described in the product literature of the GATEWAY™ Cloning Technology, the entire disclosures of all of which are specifically incorporated herein by reference in their entireties.

Sites that may be used in the present invention include att sites. The 15 bp core region of the wild-type att site (GCTTTTTTAT ACTAA (SEQ ID NO:)), which is identical in all wild-type att sites, may be mutated in one or more positions. Other att sites that specifically recombine with other att sites can be constructed by altering nucleotides in and near the 7 base pair overlap region, bases 6-12 of the core region. Thus, recombination sites suitable for use in the methods, molecules, compositions, and vectors of the invention include, but are not limited to, those with insertions, deletions or substitutions of one, two, three, four, or more nucleotide bases within the 15 base pair core region (see U.S. application Ser. No. 08/663,002, filed Jun. 7, 1996 (now U.S. Pat. No. 5,888,732) and 09/177,387, filed Oct. 23, 1998, which describes the core region in further detail, and the disclosures of which are incorporated herein by reference in their entireties). Recombination sites suitable for use in the methods, compositions, and vectors of the invention also include those with insertions, deletions or substitutions of one, two, three, four, or more nucleotide bases within the 15 base pair core region that are at least 50% identical, at least 55% identical, at least 60% identical, at least 65% identical, at least 70% identical, at least 75% identical, at least 80% identical, at least 85% identical, at least 90% identical, or at least 95% identical to this 15 base pair core region.

Analogously, the core regions in attB1, attP1, attL1 and attR1 are identical to one another, as are the core regions in attB2, attP2, attL2 and attR2. Nucleic acid molecules suitable for use with the invention also include those comprising insertions, deletions or substitutions of one, two, three, four, or more nucleotides within the seven base pair overlap region (TTTATAC, bases 6-12 in the core region). The overlap region is defined by the cut sites for the integrase protein and is the region where strand exchange takes place. Examples of such mutants, fragments, variants and derivatives include, but are not limited to, nucleic acid molecules in which (1) the thymine at position 1 of the seven by overlap region has been deleted or substituted with a guanine, cytosine, or adenine; (2) the thymine at position 2 of the seven by overlap region has been deleted or substituted with a guanine, cytosine, or adenine; (3) the thymine at position 3 of the seven by overlap region has been deleted or substituted with a guanine, cytosine, or adenine; (4) the adenine at position 4 of the seven by overlap region has been deleted or substituted with a guanine, cytosine, or thymine; (5) the thymine at position 5 of the seven by overlap region has been deleted or substituted with a guanine, cytosine, or adenine; (6) the adenine at position 6 of the seven by overlap region has been deleted or substituted with a guanine, cytosine, or thymine; and (7) the cytosine at position 7 of the seven by overlap region has been deleted or substituted with a guanine, thymine, or adenine; or any combination of one or more (e.g., two, three, four, five, etc.) such deletions and/or substitutions within this seven by overlap region. The nucleotide sequences of representative seven base pair core regions are set out below.

Altered att sites have been constructed that demonstrate that (1) substitutions made within the first three positions of the seven base pair overlap (TTTATAC) strongly affect the specificity of recombination, (2) substitutions made in the last four positions (TTTATAC) only partially alter recombination specificity, and (3) nucleotide substitutions outside of the seven by overlap, but elsewhere within the 15 base pair core region, do not affect specificity of recombination but do influence the efficiency of recombination. Thus, nucleic acid molecules and methods of the invention include those comprising or employing one, two, three, four, five, six, eight, ten, or more recombination sites which affect recombination specificity, particularly one or more (e.g., one, two, three, four, five, six, eight, ten, twenty, thirty, forty, fifty, etc.) different recombination sites that may correspond substantially to the seven base pair overlap within the 15 base pair core region, having one or more mutations that affect recombination specificity. Particularly preferred such molecules may comprise a consensus sequence such as NNNATAC wherein “N” refers to any nucleotide (i.e., may be A, G, T/U or C). Preferably, if one of the first three nucleotides in the consensus sequence is a T/U, then at least one of the other two of the first three nucleotides is not a T/U.

The core sequence of each att site (attB, attP, attL and attR) can be divided into functional units consisting of integrase binding sites, integrase cleavage sites and sequences that determine specificity. Specificity determinants are defined by the first three positions following the integrase top strand cleavage site. These three positions are shown with underlining in the following reference sequence: CAACTTTTTTATAC AAAGTTG (SEQ ID NO:). Modification of these three positions (64 possible combinations, Table 16) can be used to generate att sites that recombine with high specificity with other att sites having the same sequence for the first three nucleotides of the seven base pair overlap region. The possible combinations of first three nucleotides of the overlap region are shown in Table 16.

Representative examples of seven base pair att site overlap regions suitable for in methods, compositions and vectors of the invention are shown in Table 17. The invention further includes nucleic acid molecules comprising one or more (e.g., one, two, three, four, five, six, eight, ten, twenty, thirty, forty, fifty, etc.) nucleotides sequences set out in Table 17. Thus, for example, in one aspect, the invention provides nucleic acid molecules comprising the nucleotide sequence GAAATAC, GATATAC, ACAATAC, or TGCATAC.

As noted above, alterations of nucleotides located 3′ to the three base pair region discussed above can also affect recombination specificity. For example, alterations within the last four positions of the seven base pair overlap can also affect recombination specificity.

For example, mutated att sites that may be used in the practice of the present invention include attB1 (AGCCTGCTTT TTTGTACAAA CTTGT (SEQ ID NO:)), attP1 (TACAGGTCAC TAATACCATC TAAGTAGTTG ATTCATAGTG ACTGGATATG TTGTGTTTTA CAGTATTATG TAGTCTGTTT TTTATGCAAA ATCTAATTTA ATATATTGAT ATTTATATCA TTTTACGTTT CTCGTTCAGC TTTTTTGTAC AAAGTTGGCA TTATAAAAAA GCATTGCTCA TCAATTTGTT GCAACGAACA GGTCACTATC AGTCAAAATA AAATCATTAT TTG (SEQ ID NO:)), attL1 (CAAATAATGA TTTTATTTTG ACTGATAGTG ACCTGTTCGT TGCAACAAAT TGATAAGCAA TGCTTTTTTA TAATGCCAAC TTTGTACAAA AAAGCAGGCT (SEQ ID NO:)), and attR1 (ACAAGTTTGT ACAAAAAAGC TGAACGAGAA ACGTAAAATG ATATAAATAT CAATATATTA AATTAGATTT TGCATAAAAA ACAGACTACA TAATACTGTA AAACACAACA TATCCAGTCA CTATG (SEQ ID NO:)). Table 18 provides the sequences of the regions surrounding the core region for the wild type att sites (attB0, P0, R0, and L0) as well as a variety of other suitable recombination sites. Those skilled in the art will appreciated that the remainder of the site may be the same as the corresponding site (B, P, L, or R) listed above.

Other recombination sites having unique specificity (i.e., a first site will recombine with its corresponding site and will not substantially recombine with a second site having a different specificity) are known to those skilled in the art and may be used to practice the present invention. Corresponding recombination proteins for these systems may be used in accordance with the invention with the indicated recombination sites. Other systems providing recombination sites and recombination proteins for use in the invention include the FLP/FRT system from Saccharomyces cerevisiae, the resolvase family (e.g., γδ, TndX, TnpX, Tn3 resolvase, Hin, Hjc, Gin, SpCCE1, ParA, and Cin), and IS231 and other Bacillus thuringiensis transposable elements. Other suitable recombination systems for use in the present invention include the XerC and XerD recombinases and the psi, dif and cer recombination sites in E. coli. Other suitable recombination sites may be found in U.S. Pat. No. 5,851,808 issued to Elledge and Liu which is specifically incorporated herein by reference.

The materials and methods of the invention may further encompass the use of “single use” recombination sites which undergo recombination one time and then either undergo recombination with low frequency (e.g., have at least five fold, at least ten fold, at least fifty fold, at least one hundred fold, or at least one thousand fold lower recombination activity in subsequent recombination reactions) or are essentially incapable of undergo recombination. The invention also provides methods for making and using nucleic acid molecules which contain such single use recombination sites and molecules which contain these sites. Examples of methods which can be used to generate and identify such single use recombination sites are set out in PCT/US00/21623, published as WO 01/11058, which claims priority to U.S. provisional patent application 60/147,892, filed Aug. 9, 1999, both of which are specifically incorporated herein by reference.

Single use recombination sites are especially useful for either decreasing the frequency of or preventing recombination when either large number of nucleic acid segments are attached to each other or multiple recombination reactions are performed. Thus, the invention further includes nucleic acid molecules which contain single use recombination sites, as well as methods for performing recombination using these sites.

Recombination sites used with the invention may also have embedded functions or properties. An embedded functionality is a function or property conferred by a nucleotide sequence in a recombination site that is not directly associated with recombination efficiency or specificity. For example, recombination sites may contain protein coding sequences (e.g, intein coding sequences), intron/exon splice sites, origins of replication, and/or stop codons. Further, recombination sites that have more than one (e.g., two, three, four, five, etc.) embedded functions or properties may also be prepared.

In some instances it will be advantageous to remove either RNA corresponding to recombination sites from RNA transcripts or amino acid residues encoded by recombination sites from polypeptides translated from such RNAs. Removal of such sequences can be performed in several ways and can occur at either the RNA or protein level. One instance where it may be advantageous to remove RNA transcribed from a recombination site will be when constructing a fusion polypeptide between a polypeptide of interest and a coding sequence present on the vector. The presence of an intervening recombination site between the ORF of the polypeptide of interest and the vector coding sequences may result in the recombination site (1) contributing codons to the mRNA that result in the inclusion of additional amino acid residues in the expression product, (2) contributing a stop codon to the mRNA that prevents the production of the desired fusion protein, and/or (3) shifting the reading frame of the mRNA such that the two protein are not fused “in-frame.”

In one aspect, the invention provides methods for removing nucleotide sequences encoded by recombination sites from RNA molecules. One example of such a method employs the use of intron/exon splice sites to remove RNA encoded by recombination sites from RNA transcripts. Nucleotide sequences that encode intron/exon splice sites may be fully or partially embedded in the recombination sites used in the present invention and/or may encoded by adjacent nucleic acid sequence. Sequences to be excised from RNA molecules may be flanked by splice sites that are appropriately located in the sequence of interest and/or on the vector. For example, one intron/exon splice site may be encoded by a recombination site and another intron/exon splice site may be encoded by other nucleotide sequences (e.g., nucleic acid sequences of the vector or a nucleic acid of interest). Nucleic acid splicing is well known to those skilled in the art and is discussed in the following publications: R. Reed, Curr. Opin. Genet. Devel. 6:215-220 (1996); S. Mount, Nucl. Acids. Res. 10:459-472, (1982); P. Sharp, Cell 77:805-815, (1994); K. Nelson and M. Green, Genes and Devel. 23:319-329 (1988); and T. Cooper and W. Mattox, Am. Hum. Genet. 61:259-266 (1997).

Splice sites can be suitably positioned in a number of locations. For example, a vector designed to express an inserted ORF with an N-terminal fusion—for example, with a detectable marker—the first splice site could be encoded by vector sequences located 3′ to the detectable marker coding sequences and the second splice site could be partially embedded in the recombination site that separates the detectable marker coding sequences from the coding sequences of the ORF. Further, the second splice site either could abut the 3′ end of the recombination site or could be positioned a short distance (e.g., 2, 4, 8, 10, 20 nucleotides) 3′ to the recombination site. In addition, depending on the length of the recombination site, the second splice site could be fully embedded in the recombination site.

A modification of the method described above involves the connection of multiple (i.e., two or more) nucleic acid segments such that, upon expression, a fusion protein is produced. In one specific example, one nucleic acid segment encodes a detectable marker—for example, a vector comprising the GFP coding sequence—and another nucleic acid segment encodes an ORF of interest. Each of these segments may contain one or more recombination sites at one or both ends. In addition, the nucleic acid segment that encodes the detectable marker may contain an intron/exon splice site near its 3′ terminus and the nucleic acid segment that contains the ORF of interest may also contain an intron/exon splice site near its 5′ terminus. Upon recombination, the nucleic acid segment that encodes the detectable marker is positioned 5′ to the nucleic acid segment that encodes the ORF of interest. Further, these two nucleic acid segments are separated by a recombination site that is flanked by intron/exon splice sites. Excision of the intervening recombination site thus occurs after transcription of the fusion mRNA. Thus, in one aspect, the invention is directed to methods for removing RNA transcribed from recombination sites from transcripts generated from nucleic acids described herein. In many embodiments, the processed RNA will encode an ORF of interest which upon expression results in the production of a fusion protein.

Splice sites may be introduced into nucleic acid molecules to be used in the present invention in a variety of ways. One method that could be used to introduce intron/exon splice sites into nucleic acid segments is PCR. For example, primers could be used to generate nucleic acid segments corresponding to an ORF of interest and containing both a recombination site and an intron/exon splice site.

The above methods can also be used to remove RNA corresponding to recombination sites when the nucleic acid segment that is recombined with another nucleic acid segment encodes RNA that is not produced in a translatable format. One example of such an instance is where a nucleic acid segment is inserted into a vector in a manner that results in the production of antisense RNA. This antisense RNA may be fused, for example, with RNA that encodes a ribozyme. Thus, the invention also provides methods for removing RNA corresponding to recombination sites from such molecules.

The invention further provides methods for removing one or more amino acid sequences from protein expression products by protein splicing. Nucleotide sequences that encode protein splice sites may be fully or partially embedded in the sequence of the protein expression product and/or protein splice sites may be encoded by adjacent nucleotide sequences. In some embodiments, the invention provides methods of removing tag sequences by protein splicing. Suitable splice sites are encoded in the sequence of interest and/or in vector sequences and a tag sequence may be removed by splicing after translation. In some embodiments, the invention provides methods for removing amino acid sequences encoded by functional sequences (e.g., recombination sites) from protein expression products by protein splicing. Nucleotide sequences that encode protein splice sites may be fully or partially embedded in the recombination sites that encode amino acid sequences excised from proteins or protein splice sites may be encoded by adjacent nucleotide sequences. Similarly, one protein splice site may be encoded by a recombination site and another protein splice site may be encoded by other nucleotide sequences (e.g., nucleic acid sequences of the vector or a nucleic acid of interest).

It has been shown that protein splicing can occur by excision of an intein from a protein molecule and ligation of flanking segments (see, e.g., Derbyshire et al., Proc. Natl. Acad. Sci. (USA) 95:1356-1357 (1998)). In brief, inteins are amino acid segments that are post-translationally excised from proteins by a self-catalytic splicing process. A considerable number of intein consensus sequences have been identified (see, e.g., Perler, Nucleic Acids Res. 27:346-347 (1999)). Thus, inteins can be used, for example, to separate tags from proteins encoded by ORFs of interest.

Similar to intron/exon splicing, N- and C-terminal intein motifs have been shown to be involved in protein splicing. Thus, the invention further provides compositions and methods for removing one or more amino acid sequences from protein expression products by protein splicing. Nucleotide sequences that encode protein splice sites may be fully or partially embedded in the sequence of the protein expression product and/or protein splice sites may be encoded by adjacent nucleotide sequences. In some embodiments, the invention provides compositions and methods for removing amino acid residues encoded by functional sequences (e.g., recombination sites) from protein expression products by protein splicing. In a particular embodiment, this aspect of the invention is related to the positioning of nucleic acid sequences that encode intein splice sites on both the 5′ and 3′ end of recombination sites positioned between two coding regions. Thus, when the protein expression product is incubated under suitable conditions, amino acid residues encoded by these recombination sites will be excised. In another particular embodiment, this aspect of the invention is related to the positioning of nucleic acid sequences that encode intein splice sites on both the 5′ and 3′ end of amino acid tag sequences, which may be on the N-terminal, C-terminal and/or interior of the expression product. Thus, when the protein expression product is incubated under suitable conditions, amino acid residues of the tag sequence will be excised.

Protein splicing may be used to remove all or part of the amino acid sequences encoded by one or more recombination sites or amino acids sequences of one or more tags. Nucleic acid sequence that encode inteins may be, for example, fully or partially embedded in recombination sites or may adjacent to such sites. In certain circumstances, it may be desirable to remove a considerable number of amino acid residues. For example, an expression product may comprise a tag sequence and amino acids encoded by a recombination site. Such amino acids may extend beyond the N- and/or C-terminal ends of a polypeptide of interest. In such instances, intein coding sequence may be located a distance (e.g., 30, 50, 75, 100, etc. nucleotides) 5′ and/or 3′ of the sequences to be removed (e.g., the sequences encoded by the recombination site and the tag sequence).

While conditions suitable for intein excision will vary with the particular intein, as well as the protein that contains this intein, Chong et al., Gene 192:271-281 (1997), have demonstrated that a modified Saccharomyces cerevisiae intein, referred to as See VMA intein, can be induced to undergo self-cleavage by a number of agents including 1,4-dithiothreitol (DTT), β-mercaptoethanol, and cysteine. For example, intein excision/splicing can be induced by incubation in the presence of 30 mM DTT, at 4° C. for 16 hours.

### Polypeptides

In some embodiments, the present invention provides polypeptides expressed from clones containing ORFs. The polypeptides may be expressed as native polypeptides, i.e., without any modifications to the primary sequence. Polypeptides may also be expressed as fusion proteins (e.g., N-terminal and/or C-terminal) and/or may be post-translationally modified (e.g., glycosylated, etc.).

In some embodiments, the polypeptides expressed from cloned ORFs of the present invention may be modified to contain a tag (e.g., an affinity tag) in order to facilitate the purification of the polypeptide. Suitable tags are well known to those skilled in the art and include, but are not limited to, repeated sequences of amino acids such as six histidines, epitopes such as the hemagglutinin epitope, the V5 epitope, and the myc epitope, and other amino acid sequences that permit the simplified purification of the polypeptide.

The invention further relates to fusion proteins comprising (1) a polypeptide, or fragment thereof, having one or more desired characteristics and/or activities and (2) a tag (e.g., an affinity tag), as well as nucleic acid molecules and collections of nucleic acid molecules which encode such fusion proteins. In particular embodiments, the invention includes a polypeptide described herein having one or more (e.g., one, two, three, four, five, six, seven, eight, etc.) tags. These tags may be located, for example, (1) at the N-terminus, (2) at the C-terminus, or (3) at both the N-terminus and C-terminus of the protein, or a fragment thereof having one or more desired characteristic and/or activity. A tag may also be located internally (e.g., between regions of amino acid sequence derived from a polypeptide encoded by a cloned ORF). The invention further includes collections of RNA (e.g., mRNA) and polypeptide expression products (e.g., fusion proteins, non-fusion proteins etc.) encoded by clone collections described herein.

Tags used in the invention may vary in length but will typically be from about 5 to about 100, from about 10 to about 100, from about 15 to about 100, from about 20 to about 100, from about 25 to about 100, from about 30 to about 100 from about 35 to about 100, from about 40 to about 100, from about 45 to about 100, from about 50 to about 100, from about 55 to about 100, from about 60 to about 100, from about 65 to about 100, from about 70 to about 100, from about 75 to about 100, from about 80 to about 100, from about 85 to about 100, from about 90 to about 100, from about 95 to about 100, from about 5 to about 80, from about 10 to about 80, from about 20 to about 80, from about 30 to about 80, from about 40 to about 80, from about 50 to about 80, from about 60 to about 80, from about 70 to about 80, from about 5 to about 60, from about 10 to about 60, from about 20 to about 60, from about 30 to about 60, from about 40 to about 60, from about 50 to about 60, from about 5 to about 40, from about 10 to about 40, from about 20 to about 40, from about 30 to about 40, from about 5 to about 30, from about 10 to about 30, from about 20 to about 30, from about 5 to about 25, from about 10 to about 25, or from about 15 to about 25 amino acid residues in length.

Tags used in the practice of the invention may serve any number of purposes. For example, such tags may (1) contribute to protein-protein interactions both internally within a protein (e.g., between a tag sequence and a polypeptide sequence to which the tag has been attached) and with other protein molecules, (2) make the polypeptide amenable to particular purification methods (e.g., affinity purification), (3) enable one to identify whether the polypeptide is present in a composition (e.g. ELISA, Western blot, etc.), and/or (4) stabilize or destabilize intra-protein interactions with the protein to which the tag has been added (e.g., increase or decrease thermostability of the protein).

Examples of tags which may be used in the practice of the invention include metal binding domains (e.g., a poly-histidine segments such as a three, four, five, six, or seven histidine region), immunoglobulin binding domains (e.g., (1) Protein A; (2) Protein G; (3) T cell, B cell, and/or Fc receptors; and/or (4) complement protein antibody-binding domain); sugar binding domains (e.g., a maltose binding domain); and detectable domains (e.g., at least a portion of (3-galactosidase). Fusion proteins may contain one or more tags such as those described above. Typically, fusion proteins that contain more than one tag will contain these tags at one terminus or both termini (i.e., the N-terminus and the C-terminus) of the polypeptide, although one or more tags may be located internally in addition to those present at the termini. Further, more than one tag may be present at one terminus, internally and/or at both termini of the polypeptide. For example, three consecutive tags could be linked end-to-end at the N-terminus of the polypeptide. The invention further includes compositions and reaction mixture that contain the above fusion proteins, as well as methods for preparing these fusion proteins, nucleic acid molecules (e.g., vectors) which encode these fusion proteins and recombinant host cells that contain these nucleic acid molecules. The invention also includes methods for using these fusion proteins as described elsewhere herein.

Tags that enable one to identify whether the fusion protein is present in a composition include, for example, tags that can be used to identify the protein in an electrophoretic gel. A number of such tags are known in the art and include epitopes and antibody binding domains, which can be used for Western blots.

The amino acid composition of the tags for use in the present invention may vary. In some embodiments, a tag may contain from about 1% to about 5% amino acids that have a positive charge at physiological pH, e.g., lysine, arginine, and histidine, or from about 5% to about 10% amino acids that have a positive charge at physiological pH, or from about 10% to about 20% amino acids that have a positive charge at physiological pH, or from about 10% to about 30% amino acids that have a positive charge at physiological pH, or from about 10% to about 50% amino acids that have a positive charge at physiological pH, or from about 10% to about 75% amino acids that have a positive charge at physiological pH. In some embodiments, a tag may contain from about 1% to about 5% amino acids that have a negative charge at physiological pH; e.g., aspartic acid and glutamic acid, or from about 5% to about 10% amino acids that have a negative charge at physiological pH, or from about 10% to about 20% amino acids that have a negative charge at physiological pH, or from about 10% to about 30% amino acids that have a negative charge at physiological pH, or from about 10% to about 50% amino acids that have a negative charge at physiological pH, or from about 10% to about 75% amino acids that have a negative charge at physiological pH. In some embodiments, a tag may comprise a sequence of amino acids that contains two or more contiguous charged amino acids that may be the same or different and may be of the same or different charge. For example, a tag may contain a series (e.g., two, three, four, five, six, ten etc.) of positively charged amino acids that may be the same or different. A tag may contain a series (e.g., two, three, four, five, six, ten etc.) of negatively charged amino acids that may be the same or different. In some embodiments, a tag may contain a series (e.g., two, three, four, five, six, ten etc.) of alternating positively charged and negatively charged amino acids that may be the same or different (e.g., positive, negative, positive, negative, etc.). Any of the above-described series of amino acids (e.g., positively charged, negatively charged or alternating charge) may comprise one or more neutral polar or non-polar amino acids (e.g., two, three, four, five, six, ten etc.) spaced between the charged amino acids. Such neutral amino acids may be evenly distributed through out the series of charged amino acids (e.g., charged, neutral, charged, neutral) or may be unevenly distributed throughout the series (e.g., charged, a plurality of neutral, charged, neutral, a plurality of charged, etc.).

In some embodiments, tags to be attached to the polypeptides of the invention may have an overall charge at physiological pH (e.g., positive charge or negative charge). The size of the overall charge may vary, for example, the tag may contain a net plus one, two, three, four, five, etc. or may possess a net negative one, two, three, four, five, etc.

In some embodiments, it may be desirable to remove all or a portion of a tag sequence from a fusion protein comprising a tag sequence and a polypeptide sequence encoded by a cloned ORF of the invention. In embodiments of this type, one or more amino acids forming a cleavage site, e.g., for a protease enzyme, may be incorporated into the primary sequence of the fusion protein. The cleavage site may be located such that cleavage at the site may remove all or a portion of the tag sequence from the fusion protein. In some embodiments, the cleavage site may be located between the tag sequence and the sequence of the polypeptide such that all of the tag sequence is removed by cleavage with a protease enzyme that recognizes the cleavage site. Examples of suitable cleavage sites include, but are not limited to, the Factor Xa cleavage site having the sequence Ile-Glu-Gly-Arg (SEQ ID NO:), which is recognized and cleaved by blood coagulation factor Xa, and the thrombin cleavage site having the sequence Leu-Val-Pro-Arg (SEQ ID NO:), which is recognized and cleaved by thrombin. Other suitable cleavage sites are known to those skilled in the art and may be used in conjunction with the present invention.

Polypeptides of the invention may be post-translationally modified, for example, may be glycosylated, acylated, etc. Various eukaryotic expression systems may used to produce glycosylated polypeptides (e.g., baculovirus, vaccinia virus, yeast, etc.). Those skilled in the art will appreciate that the number and character of glycosyl chains that may be added to the polypeptides of the invention by post-translational modification may vary depending upon the expression system used (e.g., expression vector and host cell). The invention thus includes collections of vectors, which allow for the expression of glycosylated polypeptides, as well as vectors (e.g., an entry vector) that can be used to prepare such expression vectors.

### Antibodies

Antibodies may be prepared that are specific to one or more of the polypeptides encoded by the cloned ORFs of a collection. Antibodies may be polyclonal and/or monoclonal. They may be prepared against an entire polypeptide or against a fragment of the polypeptide.

In some instances, antibodies are prepared that recognize all, substantially all, or a representative number of the polypeptides encoded by the ORFs of a collection. In other instances, antibodies may be prepared that are specific to a single polypeptide. In some embodiments, antibodies may be prepared that specifically bind to a subset of the polypeptides encoded by the ORFs of a collection. Thus, the invention also includes collections of antibodies that bind to proteins encoded by one or more ORFs of a collection.

Antibodies may be used for the detection of the polypeptides in an immunoassay, such as ELISA, Western blot, radioimmunoassay, enzyme immunoassay, and may be used in immunocytochemistry. In some embodiments, an anti-polypeptide antibody may be in solution and the polypeptide to be recognized may be in solution (e.g., an immunoprecipitation) or may be on or attached to a solid surface (e.g., a Western blot). In other embodiments, the antibody may be attached to a solid surface and the polypeptide may be in solution (e.g., affinity chromatography).

Antibodies to the polypeptides encoded by the ORFs of a collection may be used to determine the presence, absence or amount of one or more of the polypeptides in a sample (e.g., a patient-derived sample). The amount of specifically bound polypeptide may be determined using an antibody to which is attached a label or other marker, such as a radioactive, a fluorescent, or an enzymatic label. Alternatively, a labeled secondary antibody (e.g., an antibody that recognizes the antibody that is specific to the polypeptide) may be used to detect a polypeptide-antibody complex between the specific antibody and the polypeptide.

cDNA and cDNA Libraries

In some embodiments, the present invention provides cDNA molecules and/or cDNA libraries.

In some embodiments, the present invention provides a collection of clones comprising all, substantially all, a majority, or a representative number of clones of a cDNA library. Clones of a cDNA library may be provided as full length clones, i.e., as DNA copies of the mRNAs, or may only contain the sequence corresponding to the ORF, i.e., from the start codon to the stop codon. As discussed above, clones containing an ORF may be provided with or without a stop codon and with or without one or more tag sequences.

cDNA and/or cDNA libraries can be prepared from any prokaryotic or eukaryotic cells, tissues and/or organs. The cells, tissues and/or organs may be normal, diseased, transformed, established, progenitors, precursors, fetal or embryonic. Diseased cells may, for example, include those involved in infectious diseases (caused by bacteria, fungi or yeast, viruses (including AIDS, HIV, HTLV, herpes, hepatitis and the like) or parasites), in genetic or biochemical pathologies (e.g., cystic fibrosis, hemophilia, Alzheimer's disease, muscular dystrophy or multiple sclerosis) or in cancerous processes. Transformed or established animal cell lines may include, for example, COS cells, CHO cells, VERO cells, BHK cells, HeLa cells, HepG2 cells, K562 cells, 293 cells, L929 cells, F9 cells, and the like.

cDNA libraries of the invention may be normalized. A normalized library is a library that has been produced such that all or substantially all of the members of the library can be isolated with approximately equal probability. Suitable examples of normalized libraries and method of making such libraries may be found in U.S. Pat. No. 6,399,334, which is specifically incorporated herein by reference.

### Kits

In another aspect, the invention provides kits that may be used in conjunction with the invention. Kits according to this aspect of the invention may comprise one or more containers, which may contain one or more components selected from the group consisting of one or more nucleic acid molecules (e.g., one or more vectors comprising a selectable marker, one or more vectors comprising one or more recombination sites and/or functional sequences, and the like) and/or clones comprising nucleic acid sequences of interest (e.g., sequences encoding ORFs, RNAi, ribozymes, etc.), one or more primers, one or more polymerases, one or more reverse transcriptases, one or more recombination proteins (or other enzymes for carrying out the methods of the invention), one or more buffers, one or more detergents, one or more restriction endonucleases, one or more nucleotides, one or more terminating agents (e.g., ddNTPs), one or more transfection reagents, pyrophosphatase, and the like. In some embodiments, kits of the invention may comprise a plurality of clones of the invention wherein each clone is in a different container. In some embodiments of this type, a kit may comprise a plurality of clones, each of which is separately contained in a well of a 96-well plate.

A wide variety of nucleic acid molecules and/or clones comprising nucleic acid sequences of interest (e.g., sequences encoding ORFs, RNAi, ribozymes, etc.) can be used with the invention. Further, when nucleic acid sequences of interest are provided with flanking recombination sites, these sequences can be combined with a wide range of other nucleic acid molecules comprising recombination sites (e.g., vectors, genomic, DNA, etc) in wide range of ways. Examples of nucleic acid molecules that can be supplied in kits of the invention include those that contain functional sequences such as promoters, signal peptides, enhancers, repressors, selection markers, transcription signals, translation signals, primer hybridization sites (e.g., for sequencing or PCR), recombination sites, restriction sites and polylinkers, sites that suppress the termination of translation in the presence of a suppressor tRNA, suppressor tRNA coding sequences, sequences that encode domains and/or regions (e.g., 6 His tag) for the preparation of fusion proteins, origins of replication, telomeres, centromeres, and the like.

Similarly, collections and/or libraries can be supplied in kits of the invention. These collections and/or libraries may be in the form of replicable nucleic acid molecules or they may comprise nucleic acid molecules that are not associated with an origin of replication. As one skilled in the art would recognize, the nucleic acid molecules of libraries, as well as other nucleic acid molecules that are not associated with an origin of replication, either could be inserted into other nucleic acid molecules that have an origin of replication or would be an expendable kit components.

Further, in some embodiments, collections and/or libraries supplied in kits of the invention may comprise two components: (1) the nucleic acid molecules of these collections and/or libraries and (2) 5′ and/or 3′ recombination sites and/or topoisomerase recognition sites. In some embodiments, when the nucleic acid molecules of a collection and/or library are supplied with 5′ and/or 3′ recombination sites, it will be possible to insert these molecules into nucleic acid molecules comprising one or more compatible recombination sites, which also may be supplied as a kit component, using recombination reactions. In other embodiments, recombination sites can be attached to the nucleic acid molecules of the collections and/or libraries before use (e.g., by the use of a ligase, which may also be supplied with the kit). In such cases, nucleic acid molecules that contain recombination sites or primers that can be used to generate recombination sites may be supplied with the kits.

Nucleic acid molecules to be supplied in kits of the invention (e.g., vectors, clones comprising ORFs, etc.) can vary greatly. In some instances, these molecules will contain an origin of replication, at least one selectable marker, and at least one recombination site. For example, molecules supplied in kits of the invention can have four separate recombination sites that allow for insertion of sequence of interest at two different locations. Other attributes of vectors supplied in kits of the invention are described elsewhere herein.

In some embodiments, the kits of the invention may comprise a plurality of containers, each container comprising one or more nucleic acid segments comprising a nucleic acid sequence of interest (e.g., sequence encoding an ORF, RNAi, ribozyme, etc.) and/or recombination sites. Segments may be provided with recombination sites such that a series of segments (e.g., two, three, four, five six, seven, eight, nine, ten, etc.) may be combined in order to construct a nucleic acid comprising multiple sequences of interest, which may be the same or different. Segments may be combined in reactions involving two or more segments (e.g., three, four, five, six, seven, eight, nine, ten, etc.). Each segment may be from about 100 bp to about 35 kb in length, or from about 100 bp to about 20 kb in length, or from about 100 bp to about 10 kb in length, or from about 100 bp to about 5 kb in length, or from about 100 bp to about 2.5 kb in length, or from about 100 bp to about 1 kb in length, or from about 100 bp to about 500 bp in length.

A kit of the present invention may comprise a container containing a nucleic acid molecule comprising all or a portion of a nucleic acid sequence of interest (e.g., sequence encoding an ORF, RNAi, ribozyme, etc.) and comprising two recombination sites that do not recombine with each other. The recombination sites may flank a selectable marker that allows selection for or against the presence of the nucleic acid molecule in a host cell or identification of a host cell containing or not containing the nucleic acid. A nucleic acid molecule to be included in a kit may comprise more than two recombination sites, for example, a nucleic acid molecule may comprise multiple pairs of recombination sites (e.g., two, three, four, five, six, seven, eight, nine, ten, etc.) where members of a pair of recombination sites do not recombine or substantially recombine with each other. In some embodiments, members of one pair of recombination sites do not recombine with members of another pair present in the same nucleic acid molecule.

Kits of the invention may comprise containers containing one or more recombination proteins. Suitable recombination proteins have been disclosed above and include, but are not limited to, Cre, Int, IHF, X is, Flp, F is, Hin, Gin, CM, Tn3 resolvase, ΦC31, TndX, XerC, and XerD.

Kits of the invention may also comprise one or more topoisomerase proteins and/or one or more nucleic acids comprising one or more topoisomerase recognition sequence. Suitable topoisomerases include Type IA topoisomerases, Type IB topoisomerases and/or Type II topoisomerases. Suitable topoisomerases include, but are not limited to, poxvirus topoisomerases, including vaccinia virus DNA topoisomerase I, E. coli topoisomerase III, E. coli topoisomerase I, topoisomerase III, eukaryotic topoisomerase II, archeal reverse gyrase, yeast topoisomerase. III, Drosophila topoisomerase III, human topoisomerase III, Streptococcus pneumoniae topoisomerase III, bacterial gyrase, bacterial DNA topoisomerase IV, eukaryotic DNA topoisomerase II, and T-even phage encoded DNA topoisomerases, and the like. Suitable recognition sequences have been described above.

In use, a nucleic acid molecule comprising all or a portion of a nucleic acid sequence of interest, which may be provided in a kit of the invention, may be combined with a nucleic acid molecule comprising a functional sequence (e.g., using recombinational cloning, topoisomerase-mediated cloning, etc.). The nucleic acid molecule comprising all or a nucleic acid sequence of interest may be provided, for example, with two recombination sites that do not recombine with each other. The nucleic acid molecule comprising a functional sequence may also be provided with two recombination sites, each of which is capable of recombining with one of the two sites present on the a nucleic acid molecule comprising all or a portion of a nucleic acid sequence of interest. In the presence of the appropriate recombination proteins, the nucleic acid molecule comprising a functional sequence recombines the nucleic acid molecule comprising all or a portion of a nucleic acid sequence of interest in order to form a recombinant nucleic acid molecule containing the functional sequence and all or a portion of a nucleic acid sequence of interest. In embodiments of this type, the functional sequence may become operably linked to the nucleic acid sequence of interest as a result of the recombination reaction. When the nucleic acid molecule comprising all or a portion of a nucleic acid sequence of interest comprises multiple pairs of recombination sites, multiple nucleic acid molecules comprising functional sequences and/or other sequences of interest, which may be the same or different, may be combined with the nucleic acid molecule comprising all or a portion of a nucleic acid sequence of interest in order to form a nucleic acid molecule comprising all or a portion of a nucleic acid sequence of interest and also comprising multiple functional sequences and/or multiple sequences of interest. In such embodiments, some or all of the functional sequences and/or other sequences of interest may be operably linked to one or more nucleic acid sequences of interest or portion thereof.

Kits of the invention can also be supplied with primers. These primers will generally be designed to anneal to molecules having specific nucleotide sequences. For example, these primers can be designed for use in PCR to amplify a particular nucleic acid molecule. Further, primers supplied with kits of the invention can be sequencing primers designed to hybridize to vector sequences. Thus, such primers will generally be supplied as part of a kit for sequencing nucleic acid molecules that have been inserted into a vector.

One or more buffers (e.g., one, two, three, four, five, eight, ten, fifteen) may be supplied in kits of the invention. These buffers may be supplied at a working concentrations or may be supplied in concentrated form and then diluted to the working concentrations. These buffers will often contain salt, metal ions, co-factors, metal ion chelating agents, etc. for the enhancement of activities of the stabilization of either the buffer itself or molecules in the buffer. Further, these buffers may be supplied in dried or aqueous forms. When buffers are supplied in a dried form, they will generally be dissolved in water prior to use.

Kits of the invention may contain virtually any combination of the components set out above or described elsewhere herein. As one skilled in the art would recognize, the components supplied with kits of the invention will vary with the intended use for the kits. Thus, kits may be designed to perform various functions set out in this application and the components of such kits will vary accordingly.

Kits of the invention may comprise one or more pages of written instructions for carrying out the methods of the invention. For example, instructions may comprise methods steps necessary to carryout recombinational cloning of an ORF provided with recombination sites and a vector also comprising recombination sites and optionally further comprising one or more functional sequences.

### 6. DETAILED EXEMPLARY SERVICES DESCRIPTION

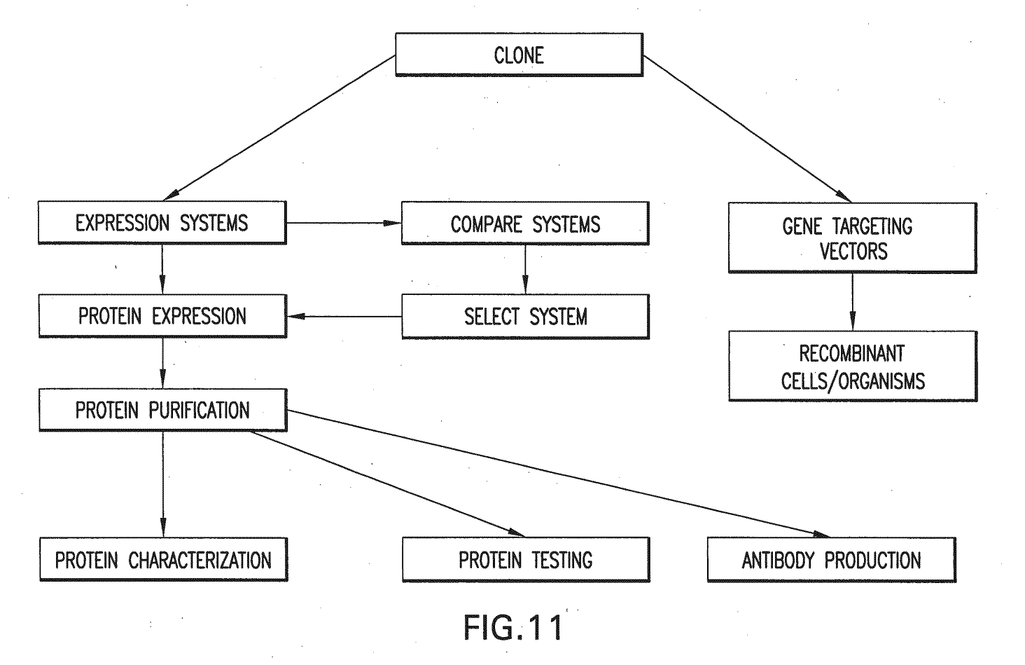

The present invention provides numerous services of value to business in the biotechnology and pharmaceutical fields. With reference to FIG. 11, a clone (e.g., an entry clone) may be prepared. A clone may comprise a nucleic acid sequence of interest to a subscriber, which sequence may be optionally flanked by one or more recognition sites (e.g., recombination sites, topoisomerase sites, etc.). Using recombinational cloning, the nucleic acid sequence of interest may be transferred to a plurality of expression vectors and tested in a plurality of expression systems to identify a suitable system or systems. Factors that may be considered in determining the expression system(s) of choice may include amount and/or activity of the polypeptide, cost per unit of polypeptide produced, and/or length of time required to produce a desired amount of polypeptide.

After a suitable expression system has been selected, the present invention also provides the service of producing and purifying the polypeptide of interest. This can be done using techniques known in the art including, but not limited to, chromatography, electrophoresis, differential precipitation and the like.

Purified polypeptide may be used for a variety of purposes. Purified polypeptide may be characterized by any number of methods. For example, crystals may be grown of the polypeptide and the crystal structure determined. This may be useful to identify an active site of a polypeptide, which may then be further used to model compounds to identify those that modulate polypeptide activity: Purified polypeptide may be used directly, for example in assays. Polypeptides also may be used to generate antibodies.

In some embodiments, clones (e.g., entry clones) containing nucleic acid sequences of interest may be further manipulated to produce vectors that may be used in gene targeting applications. For example, an ORF (with or without additional sequences) may be introduced into a cell and/or organism to produce a recombinant cell and/or organism that expresses the polypeptide encoded by the ORF.

### Construction of Clones and Clone Collections

Suitable nucleic acid sequences to be cloned and included in a collection may be identified using techniques known in the art. For example, a collection may comprise clones of members of a family of proteins. A collection of clones may comprise nucleic acids that do not encode proteins (e.g., ribozymes, tRNAs, RNAis, etc).

Suitable sequences (e.g., protein-encoding or otherwise) to be included in a collection may be identified by percentage sequence identity with, for example, a reference sequence. For example, a family may be a set of sequences having a sequence that is at least a specified percentage (e.g., 20%, 30%, 40%, 50%, 60%, 70%, 80%, 90%, 95%, etc.) identical to a reference sequence.

By a sequence of interest (e.g., amino acid or nucleotide) at least, for example, 70% “identical” to a reference sequence, it is intended that the sequence of interest is identical to the reference sequence except that the sequence of interest may include up to 30 alterations per each 100 positions (e.g., amino acids or nucleotides) of the reference sequence.

In other words, to obtain a protein having an amino acid sequence at least 70% identical to a reference amino acid sequence, up to 30% of the amino acid residues in the reference sequence may be deleted or substituted with another amino acid, or a number of amino acids up to 30% of the total amino acid residues in the reference sequence may be inserted into the reference sequence. These alterations of the reference sequence may occur at the amino (N-) and/or carboxy (C-) terminal positions of the reference amino acid sequence and/or anywhere between those terminal positions, interspersed either individually among residues in the reference sequence and/of in one or more contiguous groups within the reference sequence. As a practical matter, whether a given amino acid sequence is, for example, at least 70% identical to the amino acid sequence of a reference protein can be determined conventionally using known computer programs such as the CLUSTAL W program (Thompson, J. D., et al., Nucleic Acids Res. 22:4673-4680 (1994)).

To obtain a nucleic acid sequence at least 70% identical to a reference nucleic acid sequence, up to (30% of the nucleotides in the reference sequence may be deleted or substituted with another nucleotide, or a number of nucleotides up to 30% of the total nucleotides in the reference sequence may be inserted into the reference sequence. These alterations of the reference sequence may occur at the 5′-terminal, 3′-terminal and/or anywhere between those terminal positions, interspersed either individually among nucleotides in the reference sequence and/or in one or more contiguous groups within the reference sequence. Percent sequence identity may be determined using a computer program as discussed herein.

Sequence identity may be determined by comparing a reference sequence or a subsequence of the reference sequence to a test sequence. The reference sequence and the test sequence are optimally aligned over an arbitrary number of residues termed a comparison window. In order to obtain optimal alignment, additions or deletions, such as gaps, may be introduced into the test sequence. The percent sequence identity is determined by determining the number of positions at which the same residue is present in both sequences and dividing the number of matching positions by the total length of the sequences in the comparison window and multiplying by 100 to give the percentage. In addition to the number of matching positions, the number and size of gaps is also considered in calculating the percentage sequence identity.

Sequence identity is typically determined using computer programs. A representative program is the BLAST (Basic Local Alignment Search Tool) program publicly accessible at the National Center for Biotechnology Information (NCBI, http://www.ncbi.nlm.nih.gov/). This program compares segments in a test sequence to sequences in a database to determine the statistical significance of the matches, then identifies and reports only those matches that that are more significant than a threshold level. A suitable version of the BLAST program is one that allows gaps, for example, version 2.X (Altschul, et al., Nucleic Acids Res. 25(17):3389-402, 1997). Standard BLAST programs for searching nucleotide sequences (blastn) or protein (blastp) may be used. Translated query searches in which the query sequence is translated, i.e., from nucleotide sequence to protein (blastx) or from protein to nucleic acid sequence (tbblastn) may also be used as well as queries in which a nucleotide query sequence is translated into protein sequences in all 6 reading frames and then compared to an NCBI nucleotide database which has been translated in all six reading frames (tbblastx).

Additional suitable programs for identifying ORFs to be included in a collection of a family of proteins include, but are not limited to, PHI-BLAST (Pattern Hit Initiated BLAST, Zhang, et al., Nucleic Acids Res. 26(17):3986-90, 1998) and PSI-BLAST (Position-Specific Iterated BLAST, Altschul, et al., Nucleic Acids Res. 25(17):3389-402, 1997).

Programs may be used with default searching parameters.

Alternatively, one or more search parameter may be adjusted. Selecting suitable search parameter values is within the abilities of one of ordinary skill in the art.

Once a suitable nucleic acid molecule comprising the nucleic acid sequence of interest has been identified, the nucleic acid sequence of interest (e.g., ORF) may be prepared from the nucleic acid molecule. In some embodiments, the sequence of interest may be amplified by PCR using primers constructed to contain a sequence corresponding to all or a portion of a recombination site. After amplification, the amplification product may be contacted with one or more recombination proteins and one or more vectors comprising recombination sites to effect insertion of the amplification product into the vector.

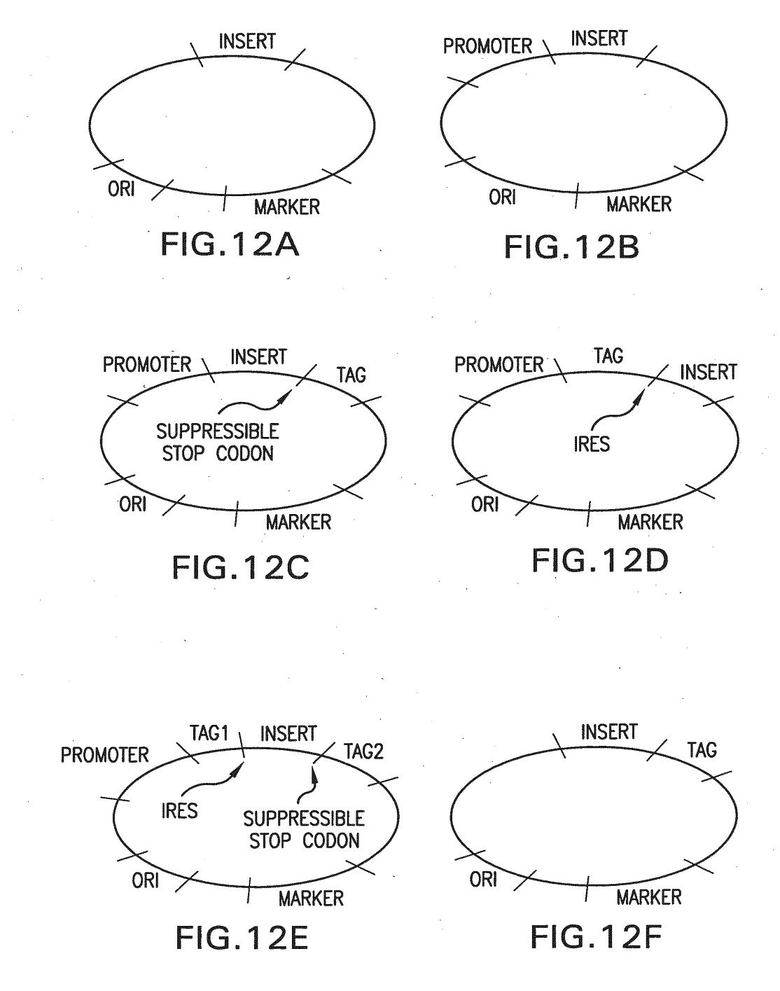

With reference to FIG. 12, a vector used to prepare a clone of the invention may or may not provide one or more sequences that may be operably linked to the sequence of interest. In FIG. 12A, a sequence of interest (Insert) is cloned into a vector. The vector contains an origin of replication and a selectable marker and does not contain any sequences that are operably linked to the Insert. FIG. 12B shows the case where the sequence of interest is cloned into a vector containing one or more transcriptional regulatory sequences (e.g., promoters). Such transcriptional regulatory sequences may be operably linked to the sequence of interest (Insert). The promoter can be used to produce RNA corresponding to the sequence of interest, which may or may not be translated into a polypeptide. FIG. 12C shows the situation where the vector comprises a tag sequence located at the 3′ end of the sequence of interest. The tag sequence is separated from the sequence of interest by a suppressible stop codon. The tag is also followed by a stop codon. Transcription and translation in the absence of a suppressor tRNA results in the expression of a polypeptide having a native C-terminal. Expression of a suppressor tRNA that suppresses the suppressible stop codon results in the expression of a polypeptide containing a C-terminal tag. FIG. 12D shows the case where the vector contains a promoter followed by a tag sequence and an internal ribosome entry site (IRES) operably linked to a sequence of interest (Insert). Transcription from the promoter and translation of the resultant mRNA results in the production of two different polypeptides. Translation starting at the ATG of the tag sequence results in the production of a polypeptide having an N-terminal tag. Translation starting at an ATG in the context of an IRES results in a polypeptide not containing an N-terminal tag sequence. FIG. 12E shows the case where the vector contains the promoter, tag, and IRES structure of FIG. 12D in combination with the suppressible stop codon and tag sequence of FIG. 12C. A tag at the N-terminal (Tag1) may be the same or different as a tag at the C-terminal (Tag2). A construct of this sort permits the expression of native polypeptide when translation is initiated at the IRES and terminated at the suppressible stop codon, an N-terminal tagged protein when translation begins at the ATG of the Tag1 sequence and terminates at the suppressible stop codon, an N- and C-terminal tagged polypeptide when translation begins at the ATG of the Tag1 sequence and termination at the suppressible stop codon is suppressed by the presence of the appropriate suppressor tRNA, and a C-terminal tagged polypeptide when translation is initiated at the IRES and termination at the suppressible stop codon is suppressed by the presence of the appropriate suppressor tRNA. FIG. 12E shows the case when the vector provides a tag sequence that may be operably linked to the sequence of interest. In embodiments of this type, the sequence of interest may or may not contain a promoter.

Recognition sites (e.g., recombination sites, topoisomerase recognition sites, restriction enzyme recognition sites, etc.) may be provided at one or both ends of any one or more of the segments of the vectors identified in FIGS. 12A-F (e.g., promoter, Insert, Tag1, Tag2, ori, IRES, and/or suppressible stop codon). When more than one recombination sites are provided, they may have the same or different specificities. Vectors used to prepare clones and/or collections of clones may be any vector that can be used for molecular cloning and/or expression, including, but not limited to, plasmids, cosmids, phagemids, BACs, YACS, baculoviruses, adenovirus, and the like

In some embodiments, the present invention provides the service of constructing a clone comprising the entire coding sequence of an open reading frame. A customer may have a portion of a sequence of interest, for example, may have the sequence of a proteolytic fragment of a polypeptide of interest. Using the sequence information provided by the customer, a sequence corresponding to the full-length coding sequence can be obtained and used to construct a clone of the invention.

In some embodiments, the present invention provides the service of constructing a clone comprising a sequence corresponding to the full-length of an mRNA molecule. For example, an mRNA molecule may be identified by a customer, for example, by providing a sequence of the polypeptide encoded by the mRNA. Using techniques known in the art, for example, 5′-RACE, a cDNA molecule corresponding to the full-length of the mRNA (including 5′ and/or 3′-un-translated regions) may be obtained and used to construct a clone of the invention. Any method known in the art may be used to construct the full length clones of the invention.

### Protein Expression Services

### Expression of Polypeptides

In some embodiments, the present invention provides the service of optimizing the expression of a polypeptide for a subscriber. In addition, the invention contemplates the construction of a panel of expression vectors comprising the ORF of a polypeptide.

To optimize expression of the polypeptides of the present invention, inducible or constitutive promoters may be used to express high levels of a polypeptide in a recombinant host. Similarly, high copy number vectors, well known in the art, may be used to achieve high levels of expression. Vectors having an inducible high copy number may also be useful to enhance expression of the polypeptides of the invention in a recombinant host.

To express the desired polypeptide in a prokaryotic cell (such as, E. coli, B. subtilis, Pseudomonas, etc.), it is necessary to operably link the ORF encoding the polypeptide to a functional prokaryotic promoter. Such promoters may be used to enhance expression and may either be constitutive or regulatable (i.e., inducible or derepressible) promoters. Examples of constitutive promoters include the int promoter of bacteriophage λ, and the bla promoter of the β-lactamase gene of pBR322. Examples of inducible prokaryotic promoters include the major right and left promoters of bacteriophage λ (P_{R} and P_{L}), trp, recA, lacZ, lad, tet, gal, trc, and tac promoters of E. coli. The B. subtilis promoters include α-amylase (Ulmanen, et al., J. Bacteriol 162:176-182 (1985)) and Bacillus bacteriophage promoters (Gryczan, T., In: The Molecular Biology Of Bacilli, Academic Press, New York (1982)). Streptomyces promoters are described by Ward, et al., Mol. Gen. Genet. 203:468478 (1986)). Prokaryotic promoters are also reviewed by Glick, J. Ind. Microbiol. 1:277-282 (1987); Cenatiempto, Y., Biochimie 68:505-516 (1986); and Gottesman, Ann. Rev. Genet. 18:415-442 (1984). Expression in a prokaryotic cell also requires the presence of a ribosomal binding site upstream of the gene-encoding sequence. Such ribosomal binding sites are disclosed, for example, by Gold, et al., Ann. Rev. Microbiol. 35:365404 (1981).

To enhance the expression of polypeptides of the invention in a eukaryotic cell, well known eukaryotic promoters and hosts may be used. Suitable promoters include, for example, the cytomegalovirus promoter, the gal 10 promoter and the Autographa californica multiple nuclear polyhcdrosis virus (AcMNPV) polyhedral promoter.

Examples of eukaryotic hosts suitable for use with the present invention include fungal cells (e.g., Saccharomyces cerevisiae cells, Pichia pastoris cells, etc.), plant cells, and animal (e.g., insect and mammalian) cells (e.g., Drosophila melanogaster cells, Spodoptera frugiperda Sf9 and Sf21 cells, Trichoplusa High-Five cells, C. elegans cells, Xenopus laevis cells, CHO cells, COS cells, VERO cells, BHK cells, Hela cells, 293 cells, etc.).

Those skilled in the art will appreciate that each organism has preferred codons for each amino acid. Thus, the present invention contemplates optimizing the codon usage to comport with the host cell type chosen. A nucleic acid encoding the polypeptide of interest can be constructed so as to contain the codons most commonly used by a particular organism in order to optimize the expression of the polypeptide in the particular organism.

A polypeptide encoded by a cloned ORF of the present invention is preferably produced by growth in culture of the recombinant host containing and expressing the desired polypeptide. Fragments of a polypeptide encoded by an ORF of the invention are also included in the present invention. Such fragments include proteolytic fragments and fragments having a desired characteristic and/or activity (e.g., antigenic fragments, enzymatically active fragments, etc.).

Any nutrient that can be assimilated by a host containing a clone comprising an ORF may be added to the culture medium. Optimal culture conditions should be selected case by case according to the strain used and the composition of the culture medium. Antibiotics may also be added to the growth media to insure maintenance of vector DNA containing the desired ORF to be expressed. Media formulations have been described in DSM or ATCC Catalogs and Sambrook et al., In: Molecular Cloning, a Laboratory Manual (2nd ed.), Cold Spring Harbor Laboratory Press, Cold Spring Harbor, N.Y. (1989).

Recombinant host cells producing polypeptide expressed from a cloned ORF of the invention can be separated from liquid culture, for example, by centrifugation. In general, the collected cells (e.g., eukaryotic or prokaryotic) are dispersed in a suitable buffer, and then broken open by well known procedures (e.g., hypotionic lysis, detergent treatment, enzyme treatment, french press, sonication, and the like) to allow extraction of the polypeptide by the buffer solution. After removal of cell debris by ultracentrifugation or centrifugation, the polypeptide can be purified by standard protein purification techniques such as extraction, precipitation, chromatography, affinity chromatography, electrophoresis or the like. Assays to detect the presence of the polypeptide during purification are well known in the art and can be used during conventional biochemical purification methods to determine the presence of the polypeptide.

The invention also relates to host cells comprising one or more of the vectors and/or nucleic acids molecules of the invention containing one or more nucleic acids of interest (e.g., two, three, four, five, seven, ten, twelve, fifteen, twenty, thirty, fifty, etc.), particularly those vectors described in detail herein. Representative host cells that may be used according to this aspect of the invention include, but are not limited to, bacterial cells, yeast cells, plant cells and animal cells. Preferred bacterial host cells include Escherichia spp. cells (particularly E. coli cells and most particularly E. coli strains DH10B, Stb12, DH5a, DB3, DB3.1 (preferably E. coli LIBRARY EFFICIENCY® DB3.1™ Competent Cells; Invitrogen Corp., Carlsbad, Calif.), DB4 and DB5 (see U.S. application Ser. No. 09/518,188, filed on Mar. 2, 2000, and U.S. Provisional Application No. 60/122,392, filed on Mar. 2, 1999, the disclosures of which are incorporated by reference herein in their entireties), Bacillus spp. cells (particularly B. subtilis and B. megaterium cells), Streptomyces spp. cells, Erwinia spp. cells, Klebsiella spp. cells, Serratia spp. cells (particularly S. marcessans cells), Pseudomonas spp. cells (particularly P. aeruginosa cells), and Salmonella spp. cells (particularly S. typhimurium and S. typhi cells). Preferred animal host cells include insect cells (most particularly Drosophila melanogaster cells, Spodoptera frugiperda Sp and Sf21 cells and Trichoplusa High-Five, cells), nematode cells (particularly C. elegans cells), avian cells, amphibian cells (particularly Xenopus laevis cells), reptilian cells, and mammalian cells (most particularly NIH3T3, 293, CHO, COS, VERO, BHK and human cells). Preferred yeast host cells include Saccharomyces cerevisiae cells and Pichia pastoris cells. These and other suitable host cells are available commercially, for example, from Invitrogen Corp., (Carlsbad, Calif.), American Type Culture Collection (Manassas, Va.), and Agricultural Research Culture Collection (NRRL; Peoria, Ill.).

Methods for introducing the vectors and/or nucleic acids molecules of the invention into the host cells described herein, to produce host cells comprising one or more of the vectors and/or nucleic acids molecules of the invention, will be familiar to those of ordinary skill in the art. For instance, the nucleic acid molecules and/or vectors of the invention may be introduced into host cells using well known techniques of infection, transduction, electroporation, transfection, and transformation. The nucleic acid molecules and/or vectors of the invention may be introduced alone or in conjunction with other nucleic acid molecules and/or vectors and/or proteins, peptides or RNAs. Alternatively, the nucleic acid molecules and/or vectors of the invention may be introduced into host cells as a precipitate, such as a calcium phosphate precipitate, or in a complex with a lipid. Electroporation also may be used to introduce the nucleic acid molecules and/or vectors of the invention into a host. Likewise, such molecules may be introduced into chemically competent cells such as E. coli. If the vector is a virus, it may be packaged in vitro or introduced into a packaging cell and the packaged virus may be transduced into cells. Thus nucleic acid molecules of the invention may contain and/or encode one or more packaging signal (e.g., viral packaging signals that direct the packaging of viral nucleic acid molecules). Hence, a wide variety of techniques suitable for introducing the nucleic acid molecules and/or vectors of the invention into cells in accordance with this aspect of the invention are well known and routine to those of skill in the art. Such techniques are reviewed at length, for example, in Sambrook, J., et al., Molecular Cloning, a Laboratory Manual, 2nd Ed., Cold Spring Harbor, N.Y.: Cold Spring Harbor Laboratory Press, pp. 16.30-16.55 (1989), Watson, J. D., et al., Recombinant DNA, 2nd Ed., New York: W.H. Freeman and Co., pp. 213-234 (1992), and Winnacker, E.-L., From Genes to Clones, New York: VCH Publishers (1987), which are illustrative of the many laboratory manuals that detail these techniques and which are incorporated by reference herein in their entireties for their relevant disclosures.

The present invention also provides the option of producing a polypeptide with a tag sequence from the same clone used to produce the un-tagged polypeptide by suppressing one or more stop codons present in the clone. Mutant tRNA molecules that recognize what are ordinarily stop codons suppress the termination of translation of an mRNA molecule and are termed suppressor tRNAs. Three codons are used by both eukaryotes and prokaryotes to signal the end of gene. When transcribed into mRNA, the codons have the following sequences: UAG (amber), UGA (opal) and UAA (ochre). Under most circumstances, the cell does not contain any tRNA molecules that recognize these codons. Thus, when a ribosome translating an mRNA reaches one of these codons, the ribosome stalls and falls off the RNA, terminating translation of the mRNA. The release of the ribosome from the mRNA is mediated by specific factors (see S. Mottagui-Tabar, Nucleic Acids Research 26(11), 2789, 1998). A gene with an in-frame stop codon (TAA, TAG, or TGA) will ordinarily encode a protein with a native carboxy terminus. However, suppressor tRNAs, can result in the insertion of amino acids and continuation of translation past stop codons.

A number of such suppressor tRNAs have been found. Examples include, but are not limited to, the supE, supP, supD, supF and supZ suppressors, which suppress the termination of translation of the amber stop codon, supB, glT, supL, supN, supC and supM suppressors, which suppress the function of the ochre stop codon and glyT, trpT and Su-9 suppressors, which suppress the function of the opal stop codon. In general, suppressor tRNAs contain one or more mutations in the anti-codon loop of the tRNA that allows the tRNA to base pair with a codon that ordinarily functions as a stop codon. The mutant tRNA is charged with its cognate amino acid residue and the cognate amino acid residue is inserted into the translating polypeptide when the stop codon is encountered. For a more detailed discussion of suppressor tRNAs, the reader may consult Eggertsson, et al., (1988) Microbiological Review 52(3):354-374, and Engleerg-Kukla, et al. (1996) in Escherichia coli and Salmonella Cellular and Molecular Biology, Chapter 60, pps 909-921, Neidhardt, et al. eds., ASM Press, Washington, D.C.

Mutations that enhance the efficiency of termination suppressors, i.e., increase the read through of the stop codon, have been identified. These include, but are not limited to, mutations in the uar gene (also known as the prfA gene), mutations in the ups gene, mutations in the sueA, sueB and sueC genes, mutations in the rpsD (ramA) and rpsE (spcA) genes and mutations in the rpIL gene. Suppression in some organisms (e.g., E. coli) may be improved when the stop codon is followed immediately by the nucleotide adenosine. Thus, the present invention contemplates nucleic acid sequences comprising stop codons followed by adenosine (e.g., comprising the sequences TAGA, TAAA and/or TGAA).

Under ordinary circumstances, host cells would not be expected to be healthy if suppression of stop codons is too efficient. This is because of the thousands or tens of thousands of genes in a genome, a significant fraction will naturally have one of the three stop codons; complete read-through of these would result in a large number of aberrant proteins containing additional amino acids at their carboxy termini. If some level of suppressing tRNA is present, there is a race between the incorporation of the amino acid and the release of the ribosome. Higher levels of tRNA may lead to more read-through although other factors, such as the codon context, can influence the efficiency of suppression.

Organisms ordinarily have multiple genes for tRNAs. Combined with the redundancy of the genetic code (multiple codons for many of the amino acids), mutation of one tRNA gene to a suppressor tRNA status does not lead to high levels of suppression. The TAA stop codon is the strongest, and most difficult to suppress. The TGA is the weakest, and naturally (in E. coli) leaks to the extent of 3%. The TAG (amber) codon is relatively tight, with a read-through of ˜1% without suppression. In addition, the amber codon can be suppressed with efficiencies on the order of 50% with naturally occurring suppressor mutants.

Suppression has been studied for decades in bacteria and bacteriophages. In addition, suppression is known in yeast, flies, plants and other eukaryotic cells including mammalian cells. For example, Capone, et al. (Molecular and Cellular Biology 6(9):3059-3067, 1986) demonstrated that suppressor tRNAs derived from mammalian tRNAs could be used to suppress a stop codon in mammalian cells. A copy of the E. coli chloramphenicol acetyltransferase (cat) gene having a stop codon in place of the codon for serine 27 was transfected into mammalian cells along with a gene encoding a human serine tRNA that had been mutated to form an amber, ochre, or opal suppressor derivative of the gene. Successful expression of the cat gene was observed. An inducible mammalian amber suppressor has been used to suppress a mutation in the replicase gene of polio virus and cell lines expressing the suppressor were successfully used to propagate the mutated virus (Sedivy, et al., Cell 50: 379-389 (1987)). The context effects on the efficiency of suppression of stop codons by suppressor tRNAs has been shown to be different in mammalian cells as compared to E. coli (Phillips-Jones, et al., Molecular and Cellular Biology 15(12): 6593-6600 (1995), Martin, et al., Biochemical Society Transactions 21: (1993)) Since some human diseases are caused by nonsense mutations in essential genes, the potential of suppression for gene therapy has long been recognized (see Temple, et al., Nature 296(5857):537-40 (1982)). The suppression of single and double nonsense mutations introduced into the diphtheria toxin A-gene has been used as the basis of a binary system for toxin gene therapy (Robinson, et al., Human Gene Therapy 6:137-143 (1995)).

The present invention contemplates fusion polypeptides wherein a portion of the fusion protein is translated from an mRNA sequence that is 3′- to at least one stop codon. In general terms, a gene may be expressed in four forms: native at both amino and carboxy termini, modified at either end, or modified at both ends. A construct containing an ORF of interest may include the N-terminal methionine ATG codon, and a stop codon at the carboxy end, of the open reading frame, or ORF, thus ATG-ORF-stop. Frequently, a gene construct will include translation initiation sequences, tis, that may be located upstream of the ATG that allow expression of the ORF, thus tis-ATG-ORF-stop. Constructs of this sort allow expression of a gene as a protein that contains the same amino and carboxy amino acids as in the native, uncloned, protein. When such a construct is fused in-frame with an amino-terminal protein tag, e.g., GST, the tag will have its own tis, thus tis-ATG-tag-tis-ATG-ORF-stop, and the bases comprising the tis of the ORF will be translated into amino acids between the tag and the ORF. In addition, some level of translation initiation may be expected in the interior of the mRNA (i.e., at the ORF's ATG and not the tag's ATG) resulting in a certain amount of native protein expression contaminating the desired protein.

DNA (lower case): tis1-atg-tag-tis2-atg-orf-stop

RNA (lower case, italics): tis1-atg-tag-tis2-atg-orf-stop

Protein (upper case): ATG-TAG-TIS2-ATG-ORF (tis1 and stop are not translated)+contaminating ATG-ORF (translation of ORF beginning at tis2).

Using one or more of the cloning techniques described herein (e.g., recombinational cloning, topoisomerase-mediated cloning, etc.) it is a simple matter for those skilled in the art to construct a vector containing a tag adjacent to a recombination site permitting the in frame fusion of a tag to the C- and/or N-terminus of the ORF of interest.

Given the ability to rapidly create a number of clones in a variety of vectors, there is a need in the art to maximize the number of ways a single cloned ORF can be expressed without the need to manipulate the ORF-containing clone itself. The present invention meets this need by providing materials and methods for the controlled expression of a C- and/or N-terminal fusion to a target ORF using one or more suppressor tRNAs to suppress the termination of translation at a stop codon. Thus, the present invention provides materials and methods in which an ORF-containing clone is prepared such that the ORF is flanked with recombination sites.

The construct may be prepared with a sequence coding for a stop codon preferably at the C-terminus of the ORF of interest. In some embodiments, a stop codon can be located adjacent to the ORF, for example, within a recombination site flanking the ORF or at or near the 3′ end of the sequence of the ORF before a recombination site. The ORF construct can be transferred through recombination to various vectors that can provide various C-terminal or N-terminal tags (e.g., GFP, GST, His Tag, GUS, etc.) to the ORF of interest. When the stop codon is located at the carboxy terminus of the ORF, expression of the corresponding polypeptide with a “native” carboxy end amino acid sequence occurs under non-suppressing conditions (i.e., when the suppressor tRNA is not expressed) while expression of the polypeptide as a carboxy fusion protein occurs under suppressing conditions. Those skilled in the art will recognize that any suppressors and any stop codons could be used in the practice of the present invention.

In some embodiments, the gene coding for the suppressing tRNA may be incorporated into the vector from which the ORF of interest is to be expressed. In other embodiments, the gene for the suppressor tRNA may be in the genome of the host cell. In still other embodiments, the gene for the suppressor may be located on a separate other vector—i.e., plasmid, cosmid, virus, etc.—and provided in trans.

More than one copy of a gene encoding a suppressor tRNA may be provided in all of the embodiments described herein. For example, a host cell may be provided that contains multiple copies of a gene encoding the suppressor tRNA. Alternatively, multiple gene copies of the suppressor tRNA under the same or different promoters may be provided in the same vector background as the target gene of interest. In some embodiments, multiple copies of a suppressor tRNA may be provided in a different vector than the one containing the target gene of interest. In other embodiments, one or more copies of the suppressor tRNA gene may be provided on the vector containing the ORF of the polypeptide of interest and/or on, another vector and/or in the genome of the host cell or in combinations of the above. When more than one copy of a suppressor tRNA gene is provided, the genes may be expressed from the same or different promoters that may be the same or different as the promoter used to express the ORF encoding the polypeptide of interest.

In some embodiments, two or more different suppressor tRNA genes may be provided. In embodiments of this type one or more of the individual suppressors may be provided in multiple copies and the number of copies of a particular suppressor tRNA gene may be the same or different as the number of copies of another suppressor tRNA gene. Each suppressor tRNA gene, independently of any other suppressor tRNA gene, may be provided on the vector used to express the ORF of interest and/or on a different vector and/or in the genome of the host cell. A given tRNA gene may be provided in more than one place in some embodiments. For example, a copy of the suppressor tRNA may be provided on the vector containing the ORF of interest while one or more additional copies may be provided on an additional vector and/or in the genome of the host cell. When more than one copy of a suppressor tRNA gene is provided, the genes may be expressed from the same or different promoters that may be the same or different as the promoter used to express the gene encoding the protein of interest and may be the same or different as a promoter used to express a different tRNA gene.

In some embodiments of the present invention, the ORF of interest and the gene expressing the suppressor tRNA may be controlled by the same promoter. In other embodiments, the ORF of interest may be expressed from a different promoter than the suppressor tRNA. Those skilled in the art will appreciate that, under certain circumstances, it may be desirable to control the expression of the suppressor tRNA and/or the ORF of interest using a regulatable promoter. For example, either the ORF of interest and/or the gene expressing the suppressor tRNA may be controlled by a promoter such as the lac promoter or derivatives thereof such as the tac promoter. In some embodiments, both the ORF of interest and the suppressor tRNA gene are expressed from the T7 RNA polymerase promoter and, optionally, are expressed as part of one RNA molecule. In embodiments of this type, the portion of the RNA corresponding to the suppressor tRNA is processed from the originally transcribed RNA molecule by cellular factors.

In some embodiments, the expression of the suppressor tRNA gene may be under the control of a different promoter from that of the ORF of interest. In some embodiments, it may be possible to express the suppressor gene before the expression of the ORF. This would allow levels of suppressor to build up to a high level, before they are needed to allow expression of a fusion protein by suppression of a the stop codon. For example, in embodiments of the invention where the suppressor gene is controlled by a promoter inducible with IPTG, the ORF may be controlled by the T7 RNA polymerase promoter and the expression of the T7 RNA polymerase may controlled by a promoter inducible with an inducing signal other than IPTG, e.g., NaCl, one could turn on expression of the suppressor tRNA gene with IPTG prior to the induction of the T7 RNA polymerase gene and subsequent expression of the ORF of interest. In some embodiments, the expression of the suppressor tRNA might be induced about 15 minutes to about one hour before the induction of the T7 RNA polymerase gene. In one embodiment, the expression of the suppressor tRNA may be induced from about 15 minutes to about 30 minutes before induction of the T7 RNA polymerase gene. In some embodiments, the expression of the T7 RNA polymerase gene is under the control of an inducible promoter.

In additional embodiments, the expression of the ORF of interest and the suppressor tRNA can be arranged in the form of a feedback loop. For example, the ORF of interest may be placed under the control of the T7 RNA polymerase promoter while the suppressor gene is under the control of both the T7 promoter and the lac promoter. The T7 RNA polymerase gene itself is also under the control of both the T7 promoter and the lac promoter. In addition, the T7 RNA polymerase gene has an amber stop mutation replacing a normal tyrosine codon, e.g., the 28th codon (out of 883). No active T7 RNA polymerase can be made before levels of suppressor are high enough to give significant suppression. Then expression of the polymerase rapidly rises, because the T7 polymerase expresses the suppressor gene as well as itself. In other preferred embodiments, only the suppressor gene is expressed from the T7 RNA polymerase promoter. Embodiments of this type would give a high level of suppressor without producing an excess amount of T7 RNA polymerase. In other preferred embodiments, the T7 RNA polymerase gene has more than one amber stop mutation. This will require higher levels of suppressor before active T7 RNA polymerase is produced.

In some embodiments of the present invention it may be desirable to have more than one stop codon suppressible by more than one suppressor tRNA. A recombinant vector may be constructed so as to permit the regulatable expression of N- and/or C-terminal fusions of a polypeptide expressed from an ORF of interest from the same construct. A vector may comprise a first tag sequence expressed from a promoter and may include a first stop codon in the same reading frame as the tag. The stop codon may be located anywhere in the tag sequence and is preferably located at or near the C-terminal of the tag sequence. The stop codon may also be located in a recombination site or in an internal ribosome entry sequence (IRES). The vector may also include an ORF of interest that includes a second stop codon. The first tag and the ORF of interest are preferably in the same reading frame although inclusion of a sequence that causes frame shifting to bring the first tag into the same reading frame as the ORF of interest is within the scope of the present invention. The second stop codon is preferably in the same reading frame as the ORF of interest and is preferably located at or near the end of the coding sequence of the ORF. The second stop codon may optionally be located within a recombination site located 3′ to the ORE of interest. The construct may also include a second tag sequence in the same reading frame as the ORF of interest and the second tag sequence may optionally include a third stop codon in the same reading frame as the second tag. A transcription terminator and/or a polyadenylation sequence may be included in the construct after the coding sequence of the second tag. The first, second and third stop codons may be the same or different. In some embodiments, all three stop codons are different. In embodiments where the first and the second stop codons are different, the same construct may be used to express an N-terminal fusion, a C-terminal fusion and the native protein by varying the expression of the appropriate suppressor tRNA. For example, to express the native protein, no suppressor tRNAs are expressed and protein translation is controlled by an appropriately located IRES. When an N-terminal fusion is desired, a suppressor tRNA that suppresses the first stop codon is expressed while a suppressor tRNA that suppresses the second stop codon is expressed in order to produce a C-terminal fusion. In some instances it may be desirable to express a doubly tagged protein of interest in which case suppressor tRNAs that suppress both the first and the second stop codons may be expressed.

### Antibody Production Services

One or more of the polypeptides encoded by the ORFs of a collection may be used as immunogens to prepare polyclonal an/or monoclonal antibodies capable of binding the polypeptides using techniques well known in the art (Harlow. & Lane, Antibodies: A Laboratory Manual, Cold Spring Harbor Laboratory, Cold Spring Harbor, N.Y., 1988). In brief, antibodies are prepared by immunization of suitable subjects (e.g., mice, rats, rabbits, goats, etc.) with all or a part of the polypeptides of the invention. If the polypeptide or fragment thereof is sufficiently immunogenic, it may be used to immunize the subject. If necessary or desired to increase immunogenicity, the polypeptide or fragment may be conjugated to a suitable carrier molecule (e.g., BSA, KLH, and the like). Polypeptides of the invention or fragments thereof may be conjugated to carriers using techniques well known in the art. For example, they may be directly conjugated to a carrier using, for example, carbodiimide reagents. Other suitable linking reagents are commercially available from, for example, Pierce Chemical Co., Rockford, Ill.

Suitably prepared polypeptides of the invention or fragments thereof may be administered by injection over a suitable time period. They may be administered with or without the use of an adjuvant (e.g., Freunds). They may be administered one or more times until antibody titers reach a desired level.

In some embodiments, it may be desirable to produce monoclonal antibodies to the polypeptides of the invention or fragments thereof. Immortalized cell lines that produce the desired monoclonal antibodies may be prepared using the standard method of Kohler and Milstein or other techniques well known in the art. Cells producing the desired monoclonal antibody can be cultured either in vitro or by production in ascites fluid.

In some embodiments, it may be desirable to use a fragment of an antibody that is capable of binding a polypeptide of the invention or fragment thereof. For example, Fab, Fab′, of F(ab′)₂ fragments may be produced using techniques well known in the art.

Construction of cDNA Libraries

In some embodiments, the present invention provides the service of preparing cDNA molecules and cDNA libraries for a subscriber. Such cDNAs and cDNA libraries may be prepared for any cell or tissue source.

In accordance with the invention, cDNA molecules (single-stranded or double-stranded) may be prepared from a variety of nucleic acid template molecules. Preferred nucleic acid molecules for use in the present invention include single-stranded or double-stranded DNA and RNA molecules, as well as double-stranded DNA:RNA hybrids. More preferred nucleic acid molecules include messenger RNA (mRNA), transfer RNA (tRNA) and ribosomal RNA (rRNA) molecules, although mRNA molecules are the preferred template according to the invention.

The nucleic acid molecules that are used to prepare cDNA molecules according to the methods of the present invention may be prepared synthetically according to standard organic chemical synthesis methods that will be familiar to one of ordinary skill. More preferably, the nucleic acid molecules may be obtained from natural sources, such as a variety of cells, tissues, organs or organisms. Cells that may be used as sources of nucleic acid molecules may be prokaryotic (bacterial cells, including but not limited to those of species of the genera Escherichia, Bacillus, Serratia, Salmonella, Staphylococcus, Streptococcus, Clostridium, Chlamydia, Neisseria, Treponema, Mycoplasma, Borrelia, Legionella, Pseudomonas, Mycobacterium, Helicobacter, Erwinia, Agrobacterium, Rhizobium, Xanthomonas and Streptomyces) or eukaryotic (including fungi (especially yeasts), plants, protozoans and other parasites, and animals including insects (particularly Drosophila spp. cells), nematodes (particularly Caenorhabditis elegans cells), and mammals (particularly human cells)).

Mammalian somatic cells that may be used as sources of nucleic acids include blood cells (reticulocytes and leukocytes), endothelial cells, epithelial cells, neuronal cells (from the central or peripheral nervous systems), muscle cells (including myocytes and myoblasts from skeletal, smooth or cardiac muscle), connective tissue cells (including fibroblasts, adipocytes, chondrocytes, chondroblasts, osteocytes and osteoblasts) and other stromal cells (e.g., macrophages, dendritic cells, Schwann cells). Mammalian germ cells (spermatocytes and oocytes) may also be used as sources of nucleic acids for use in the invention, as may the progenitors, precursors and stem cells that give rise to the above somatic and germ cells. Also suitable for use as nucleic acid sources are mammalian tissues or organs such as those derived from brain, kidney, liver, pancreas, blood, bone marrow, muscle, nervous, skin, genitourinary, circulatory, lymphoid, gastrointestinal and connective tissue sources, as well as those derived from a mammalian (including human) embryo or fetus.

Any of the above prokaryotic or eukaryotic cells, tissues and organs may be normal, diseased, transformed, established, progenitors, precursors, fetal or embryonic. Diseased cells may, for example, include those involved in infectious diseases (caused by bacteria, fungi or yeast, viruses (including AIDS, HIV, HTLV, herpes, hepatitis and the like) or parasites), in genetic or biochemical pathologies (e.g., cystic fibrosis, hemophilia, Alzheimer's disease, muscular dystrophy or/multiple sclerosis) or in cancerous processes. Transformed or established animal cell lines may include, for example, COS cells, CHO cells, VERO cells, BHK cells, HeLa cells, HepG2 cells, K562 cells, 293 cells, L929 cells, F9 cells, and the like. Other cells, cell lines, tissues, organs and organisms suitable as sources of nucleic acids for use in the present invention will be apparent to one of ordinary skill in the art.

Once the starting cells, tissues, organs or other samples are obtained, nucleic acid molecules (such as mRNA) may be isolated therefrom by methods that are well-known in the art (See, e.g., Maniatis, T., et al., Cell 15:687-701 (1978); Okayama, H., and Berg, P., Mol. Cell. Biol. 2:161-170 (1982); Gubler, U., and Hoffman, B. J., Gene 25:263-269 (1983)). The nucleic acid molecules thus isolated may then be used to prepare cDNA molecules and cDNA libraries in accordance with the present invention.

In the practice of the invention, cDNA molecules or cDNA libraries are produced by mixing one or more nucleic acid molecules obtained as described above, which is preferably one or more mRNA molecules such as a population of mRNA molecules, with a reverse transcriptase and/or a DNA polymerase under conditions favoring the reverse transcription of the nucleic acid molecule to form a cDNA molecule (single-stranded or double-stranded). Methods of preparing cDNA and cDNA libraries are well known in the art (see, e.g., Gubler, U., and Hoffman, B. J., Gene 25:263-269 (1983); Krug, M. S., and Berger, S. L., Meth. Enzymol. 152:316-325 (1987); Sambrook, J., et al., Molecular Cloning: A Laboratory Manual, 2nd ed., Cold Spring Harbor, N.Y.: Cold Spring Harbor Laboratory Press, pp. 8.60-8.63 (1989); WO 99/15702; WO 98/47912; and WO 98/51699). Other methods of cDNA synthesis which may advantageously use the present invention will be readily apparent to one of ordinary skill in the art.

Methods for generating full-length cDNA molecules are known in the art. For example, U.S. Pat. No. 6,197,554 issued to Lin, et al., discloses a method for preparing a full-length cDNA library from a single cell or a small number of cells suing repeated reverse transcription and amplification steps. U.S. Pat. No. 6,187,544, issued to Bergsma, et al., discloses a method for high throughput cloning of full length cDNA sequences using a plurality of clone arrays prepared from cDNA libraries which have been preferably enriched for 5′ mRNA sequences and size fractionated into several discrete ranges (sub-libraries). U.S. Pat. No. 6,174,669, issued to Hayashizaki, et al., relates to a method for making full-length cDNAs having a length corresponding to full-length mRNAs by binding a tag molecule to a diol structure present in the cap of mRNAs, reverse transcribing the mRNA to make a RNA-DNA hybrid and isolating the RNA-DNA hybrids using the tag molecule.

In some embodiments, the libraries constructed according to the present invention may be normalized. As discussed above, a normalized library is one that has been constructed so as to reduce the relative variation in abundance among member nucleic acid molecules in the library. In brief, a library may be normalized by reducing the abundance of molecules that are represented at a high level in the library.

The present invention encompasses methods of preparing normalized libraries and the normalized libraries (i.e., libraries of cloned nucleic acid molecules from which each member nucleic acid molecule can be isolated with approximately equivalent probability) prepared by such methods, clones comprising such members of such libraries, and compositions comprising such clones and/or libraries.

A normalized library may be produced by synthesizing one or more nucleic acid molecules complementary to all or a portion of the nucleic acid molecules of the library, wherein the synthesized nucleic acid molecules comprise at least one hapten, thereby producing haptenylated nucleic acid molecules (which may be RNA molecules or DNA molecules); incubating a nucleic acid library to be normalized with the haptenylated nucleic acid molecules (e.g. also referred to as driver) under conditions favoring the hybridization of the more highly abundant molecules of the library with the haptenylated nucleic acid molecules; and removing the hybridized molecules, thereby producing a normalized library.

In some embodiments, the relative concentration of all members of the normalized library are within one to two orders of magnitude. In another aspect, contaminating nucleic acid molecules (e.g., vectors without inserts) are removed from the normalized library. In this manner, all or a substantial portion of the normalized library will comprise vectors containing inserted nucleic acid molecules of the library.

In some embodiments, a population of mRNA is incubated under conditions sufficient to produce a population of cDNA molecules complementary to all or a portion of said mRNA molecules. Conditions may comprise mixing the population of mRNA molecules with one or more polypeptides having reverse transcriptase activity and incubating the mixture under conditions sufficient to produce a population of single stranded cDNA molecules complementary to all or a portion of the mRNA molecules. The single stranded cDNA molecules may then be used to make double stranded cDNA molecules by incubating the mixture under appropriate conditions in the presence of one or more DNA polymerases. The resulting population of double-stranded or single-stranded cDNA molecules makes up a library that may be normalized using the methods of the invention. Such cDNA libraries may be inserted into one or more vectors prior to normalization. Alternatively, the cDNA libraries may be normalized prior to insertion within one or more vectors, and after normalization may be cloned into one or more vectors.

The library to be normalized may be contained in (inserted in) one or more vectors, which may be a plasmid, a cosmid, a phagemid, a virus and the like. Such vectors preferably comprise one or more promoters that allow the synthesis of at least one RNA molecule from all or a portion of the nucleic acid molecules (preferably cDNA molecules) inserted in the vector. Thus, by use of the promoters, haptenylated RNA molecules complementary to all or a portion of the nucleic acid molecules of the library may be made and used to normalize the library in accordance with the invention. Such synthesized RNA molecules (which have been haptenylated) will be complementary to all or a portion of the vector inserts of the library. More highly abundant molecules in the library may then be preferentially removed by hybridizing the haptenylated RNA molecules to the library, thereby producing the normalized library of the invention. Without being limited, the synthesized RNA molecules are thought to be representative of the library; that is, more highly abundant species in the library result in more highly abundant haptenylated RNA using the above method. The relative abundance of the molecules within the library, and therefore, within the haptenylated RNA determines the rate of removal of particular species of the library; if a particular species abundance is high, such highly abundant species will be removed more readily while low abundant species will be removed less readily from the population. Normalization by this process thus allows one to substantially equalize the level of each species within the library.

In another aspect of the invention, the library to be normalized need not be inserted in one or more vectors prior to normalization. In such aspect of the invention, the nucleic acid molecules of the library may be used to synthesize haptenylated nucleic acid molecules using well known techniques. For example, haptenylated nucleic acid molecules may be synthesized in the presence of one or more DNA polymerases, one or more appropriate primers or probes and one or more nucleotides (the nucleotides and/or primers or probes may be haptenylated). In this manner, haptenylated DNA molecules will be produced and may be used to normalized the library in accordance with the invention. Alternatively, one or more promoters may be added to (e.g., ligated, attached using topoisomerase, attached via recombination, etc) the library molecules, thereby allowing synthesis of haptenylated RNA molecules for use to normalize the library in accordance with the invention. For example, adapters containing one or more promoters may be added to one or more ends of double stranded library molecules (e.g., cDNA library prepared from a population of mRNA molecules). Such promoters may then be used to prepare haptenylated RNA molecules complementary to all or a portion of the nucleic acid molecules of the library. In accordance with the invention, the library may then be normalized and, if desired, inserted into one or more vectors.

While haptenylated RNA is preferably used to normalize libraries, other haptenylated nucleic acid molecules may be used in accordance with the invention. For example, haptenylated DNA may be synthesized from the library and used in accordance with the invention.

Haptens suitable for use in the methods of the invention include, but are not limited to, avidin, streptavidin, protein A, protein G, a cell-surface Fc receptor, an antibody-specific antigen, an enzyme-specific substrate, polymyxin B, endotoxin-neutralizing protein (ENP), Fe+++, a transferrin receptor, an insulin receptor, a cytokine receptor, CD4, spectrin, fodrin, ICAM-1, ICAM-2, C3bi, fibrinogen, Factor X, ankyrin, an integrin, vitronectin, fibronectin, collagen, laminin, glycophorin, Mac-1, LFA-1, β-actin, gp120, a cytokine, insulin, ferrotransferrin, apotransferrin, lipopolysaccharide, an enzyme, an antibody, biotin and combinations thereof. A particularly preferred hapten is biotin.

In accordance with the invention, hybridized molecules produced by the above-described methods may be isolated, for example by extraction or by hapten-ligand interactions. Preferably, extraction methods (e.g. using organic solvents) are used. Isolation by hapten-ligand interactions may be accomplished by incubation of the haptenylated molecules with a solid support comprising at least one ligand that binds the hapten. Preferred ligands for use in such isolation methods correspond to the particular hapten used, and include, but are not limited to, biotin, an antibody, an enzyme, lipopolysaccharide, apotransferrin, ferrotransferrin, insulin, a cytokine, gp120, β-actin, LFA-1, Mac-1, glycophorin, laminin, collagen, fibronectin, vitronectin, an integrin, ankyrin, C3bi, fibrinogen, Factor X, ICAM-1, ICAM-2, spectrin, fodrin, CD4, a cytokine receptor, an insulin receptor, a transferrin receptor, Fe+++, polymyxin B, endotoxin-neutralizing protein (ENP), an enzyme-specific substrate, protein A, protein G, a cell-surface Fc receptor, an antibody-specific antigen, avidin, streptavidin or combinations thereof. The solid support used in these isolation methods may be nitrocellulose, diazocellulose, glass, polystyrene, polyvinylchloride, polypropylene, polyethylene, dextran, Sepharose, agar, starch, nylon, a latex bead, a magnetic bead, a paramagnetic bead, a superparamagnetic bead or a microtitre plate. Preferred solid supports are magnetic beads, paramagnetic beads and superparamagnetic beads, and particularly preferred are such beads comprising one or more streptavidin or avidin molecules.

In another aspect of the invention, normalized libraries are subjected to further isolation or selection steps which allow removal of unwanted contamination or background. Such contamination or background may include undesirable nucleic acids. For example, when a library to be normalized is constructed in one or more vectors, a low percentage of vector (without insert) may be present in the library. Upon normalization, such low abundance molecules (e.g. vector background) may become a more significant constituent as a result of the normalization process. That is, the relative level of such low abundance background may be increased as part of the normalization process.

Removal of such contaminating nucleic acids may be accomplished by incubating a normalized library with one or more haptenylated probes which are specific for the nucleic acid molecules of the library (e.g. target specific probes). In principal, removal of contaminating sequences can be accomplished by selecting those nucleic acids having the sequence of interest or by eliminating those molecules that do not contain sequences of interest. In accordance with the invention, removal of contaminating nucleic acid molecules may be performed on any normalized library (whether or not the library is constructed in a vector). Thus, the probes will be designed such that they will not recognize or hybridize to contaminating nucleic acids. Upon hybridization of the haptenylated probe with nucleic acid molecules of the library, the haptenylated probes will bind to and select desired sequences within the normalized library and leave behind contaminating nucleic acid molecules, resulting in a selected normalized library. The selected normalized library may then be isolated. In a preferred aspect, such isolated selected normalized libraries are single-stranded, and may be made double stranded following selection by incubating the single-stranded library under conditions sufficient to render the nucleic acid molecules double-stranded. The double stranded molecules may then be transformed into one or more host cells. Alternatively, the normalized library may be made double stranded using the haptenylated probe or primer (preferably target specific) and then selected by extraction or ligand-hapten interactions. Such selected double stranded molecules may then be transformed into one or more host cells.

In another aspect of the invention, contaminating nucleic acids may be reduced or eliminated, by incubating the normalized library in the presence of one or more primers specific for library sequences. This aspect of the invention may comprise incubating the single stranded normalized library with one or more nucleotides (preferably nucleotides which confer nuclease resistance to the synthesized nucleic acid molecules), and one or more polypeptides having polymerase activity, under conditions sufficient to render the nucleic acid molecules double-stranded. The resulting double stranded molecules may then be transformed into one or more host cells. Alternatively, resulting double stranded molecules containing nucleotides which confer nuclease resistance may be digested with such a nuclease and transformed into one or more host cells.

In yet another aspect, the elimination or removal of contaminating nucleic acid may be accomplished prior to normalization of the library, thereby resulting in selected normalized library of the invention. In such a method, the library to be normalized may be subjected to any of the methods described herein to remove unwanted nucleic acid molecules and then the library may then be normalized by the process of the invention to provide for the selected normalized libraries of the invention.

In accordance with the invention, double stranded nucleic acid molecules are preferably made single stranded before hybridization. Thus, the methods of the invention may further comprise treating the above-described double-stranded nucleic acid molecules of the library under conditions sufficient to render the nucleic acid molecules single-stranded. Such conditions may comprise degradation of one strand of the double-stranded nucleic acid molecules (preferably using gene II protein and Exonuclease III), or denaturing the double-stranded nucleic acid molecules using heat, alkali and the like.

The invention also relates to normalized nucleic acid libraries, selected normalized nucleic acid libraries and transformed host cells produced by the above-described methods.

The above-described technique may be used to prepare a normalized library from any organism or tissue source. In some embodiments, normalized libraries may be prepared from tissue of mammalian origin (e.g., human, rat, mouse, dog, etc.). Normalized libraries may be prepared from numerous tissue types from a single organism (e.g., from human heart, lung, liver, kidney, brain, etc.).

An additional service available in the present invention is the normalization of libraries prepared by a customer. For example, a customer may have previously prepared a library from a particular source. The customer may request that the provider prepare a normalized library from the previously prepared library. The provider may prepare the normalized library using the technique described above or any other suitable technique.

### Research and Development Consulting.

In some embodiments, the present invention provides the service of analyzing subscriber Research and Development. A provider may provide one or more individuals to a subscriber in order to analyze the methodology used by the subscriber. The individuals may identify portions of the subscriber's Research and Development that might be improved using materials and/or knowledge provided by the provider. For example, a subscriber may, as part of its business, analyze the effects of small molecules on enzymes. The provider may provide improved materials and/or methods to facilitate this type of analysis. For example, the provider may provide improved reaction conditions under which to assay an enzyme of interest. The provider might provide a more suitable assay to assess the effects of the small molecules on enzyme activity than the assay used by the customer.

It will be understood by one of ordinary skill in the relevant arts that other suitable modifications and adaptations to the methods and applications described herein are readily apparent from the description of the invention contained herein in view of information known to the ordinarily skilled artisan, and may be made without departing from the scope of the invention or any embodiment thereof.

The entire disclosures of U.S. application Ser. No. 08/486,139, (now abandoned), filed Jun. 7, 1995, U.S. application Ser. No. 08/663,002, filed Jun. 7, 1996 (now U.S. Pat. No. 5,888,732), U.S. application Ser. No. 09/233,492, filed Jan. 20, 1999, (now U.S. Pat. No. 6,270,969), U.S. application Ser. No. 09/233,493, filed Jan. 20, 1999, (now U.S. Pat. No. 6,143,557), U.S. application Ser. No. 09/005,476, filed Jan. 12, 1998, (now U.S. Pat. No. 6,171,861), U.S. application Ser. No. 09/432,085 filed Nov. 2, 1999, U.S. application Ser. No. 09/498,074 filed Feb. 4, 2000, U.S. Appl. No. 60/065,930, filed Oct. 24, 1997, U.S. application Ser. No. 09/177,387, filed Oct. 23, 1998, U.S. application Ser. No. 09/296,280, filed Apr. 22, 1999, (now U.S. Pat. No. 6,277,608), U.S. application Ser. No. 09/296,281, filed Apr. 22, 1999, (now abandoned), U.S. application Ser. No. 09/648,790, filed Aug. 28, 2000, U.S. application Ser. No. 09/855,797, filed May 16, 2001, U.S. application Ser. No. 09/907,719, filed Jul. 19, 2001, U.S. application Ser. No. 09/907,900, filed Jul. 19, 2001, U.S. application Ser. No. 09/985,448, filed Nov. 2, 2001, U.S. Appl. No. 60/108,324, filed Nov. 13, 1998, U.S. application Ser. No. 09/438,358, filed Nov. 12, 1999, U.S. Appl. No. 60/161,403, filed Oct. 25, 1999, U.S. application Ser. No. 09/695,065, filed Oct. 25, 2000, U.S. application Ser. No. 09/984,239, filed Oct. 29, 2001, U.S. Appl. No. 60/122,389, filed Mar. 2, 1999, U.S. Appl. No. 60/126,049, filed Mar. 23, 1999, U.S. Appl. No. 60/136,744, filed May 28, 1999, U.S. application Ser. No. 09/517,466, filed Mar. 2, 2000, U.S. Appl. No. 60/122,392, filed Mar. 2, 1999, U.S. application Ser. No. 09/518,188, filed Mar. 2, 2000, U.S. Appl. No. 60/169,983, filed Dec. 10, 1999, U.S. Appl. No. 60/188,000, filed Mar. 9, 2000, U.S. application Ser. No. 09/732,914, filed Dec. 11, 2001, U.S. Appl. No. 60/284,528, filed Apr. 19, 2001, U.S. Appl. No. 60/291,973, filed May 21, 2001, U.S. Appl. No. 60/318,902, filed Sep. 14, 2001, U.S. Appl. No. 60/333,124, filed Nov. 27, 2001, and U.S. application Ser. No. 10/005,876, filed Dec. 7, 2001, are herein incorporated by reference.

Having now fully described the present invention in some detail by way of illustration and example for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

TABLE 1
GenBank Accession numbers of human sequence records identified
as related to nucleic acids encoding protein kinases potentially connected to
the cell cycle.

| | | | | | | | |
|---|---|---|---|---|---|---|---|
| 1: | NM_005858 | 2: | NM_144490 | 3: | NM_016248 | 4: | M37712 |
| 5: | NM_139323 | 6: | NM_003404 | 7: | NM_003157 | 8: | NM_001255 |
| 9: | NM_139014 | 10: | NM_139013 | 11: | NM_139012 | 12: | NT_008902 |
| 13: | NT_023678 | 14: | NT_030040 | 15: | NT_033984 | 16: | NT_033894 |
| 17: | NM_078467 | 18: | NM_031988 | 19: | NM_002758 | 20: | NM_001315 |
| 21: | NT_033944 | 22: | XM_005420 | 23: | NM_006142 | 24: | NT_006497 |
| 25: | NT_007819 | 26: | NT_033964 | 27: | NM_138923 | 28: | NM_004606 |
| 29: | NM_000051 | 30: | NM_138293 | 31: | NM_138292 | 32: | NM_001211 |
| 33: | NM_001184 | 34: | NM_003600 | 35: | NM_003390 | 36: | NM_001396 |
| 37: | NM_130438 | 38: | NM_130437 | 39: | NM_130436 | 40: | NM_101395 |
| 41: | NM_000389 | 42: | NM_001799 | 43: | NM_003503 | 44: | NM_004690 |
| 45: | NM_007194 | 46: | NM_006271 | 47: | NM_005400 | 48: | NM_024011 |
| 49: | NM_033621 | 50: | NM_033537 | 51: | NM_033536 | 52: | NM_033534 |
| 53: | NM_033532 | 54: | NM_033531 | 55: | NM_033529 | 56: | NM_033528 |
| 57: | NM_033527 | 58: | AF049105 | 59: | NM_016508 | 60: | NM_001261 |
| 61: | NM_001259 | 62: | NM_052988 | 63: | NM_052987 | 64: | NM_001260 |
| 65: | NM_003674 | 66: | NM_052984 | 67: | NM_000075 | 68: | NM_052827 |
| 69: | NM_001798 | 70: | NM_033493 | 71: | NM_033492 | 72: | NM_033491 |
| 73: | NM_033490 | 74: | NM_033489 | 75: | NM_033488 | 76: | NM_033487 |
| 77: | NM_033486 | 78: | NM_001787 | 79: | NM_033379 | 80: | NM_001786 |
| 81: | NM_003137 | 82: | NM_006575 | 83: | AX136049 | 84: | NM_031267 |
| 85: | NM_003718 | 86: | NM_005906 | 87: | NM_004954 | 88: | NM_017490 |
| 89: | AJ277546 | 90: | NM_001924 | 91: | NM_007186 | 92: | NM_004853 |
| 93: | NM_003158 | 94: | NM_003160 | 95: | NM_002497 | 96: | NM_001827 |
| 97: | NM_001826 | 98: | AF162667 | 99: | AF162666 | 100: | AF174135 |
| 101: | AF107297 | 102: | AB017332 | 103: | AF086904 | 104: | AF005209 |
| 105: | AF032874 | 106: | D84212 | 107: | Y13115 | 108: | U78073 |
| 109: | Z25437 | 110: | Z25436 | 111: | Z25435 | 112: | Z25434 |
| 113: | Z25433 | 114: | Z25432 | 115: | Z25431 | 116: | Z25430 |
| 117: | Z25429 | 118: | Z25428 | 119: | Z25427 | 120: | Z25426 |
| 121: | Z25425 | 122: | Z25424 | 123: | Z25423 | 124: | Z25422 |
| 125: | Z25421 | 126: | X73458 | 127: | Z29067 | 128: | Z29066 |
| 129: | Y00272 | 130: | L19559 | | | | |

TABLE 2
GenBank Accession numbers of human sequence records identified
as related to nucleic acids encoding polypeptides potentially related to inositol
metabolism and/or signaling.

| | | | |
|---|---|---|---|
| 1: AF469196 | 2: NM_022468 | 3: NM_144489 | 4: NM_144488 |
| 5: NM_134427 | 6: NM_017790 | 7: NM_021106 | 8: NM_130795 |
| 9: NM_000276 | 10: NM_001587 | 11: NM_022718 | 12: NM_014216 |
| 13: AF273055 | 14: NM_002649 | 15: NM_054111 | 16: NT_030828 |
| 17: NT_009458 | 18: NT_008902 | 19: NT_008769 | 20: NT_011139 |
| 21: NT_024040 | 22: NT_007972 | 23: NT_005990 | 24: NT_005927 |
| 25: NT_004525 | 26: NT_004511 | 27: NT_006258 | 28: NT_022760 |
| 29: NT_022439 | 30: NT_033930 | 31: NM_138687 | 32: NM_003559 |
| 33: NM_005028 | 34: NM_016532 | 35: NM_130766 | 36: NT_011903 |
| 37: NM_006085 | 38: NT_033291 | 39: NT_011512 | 40: NT_010692 |
| 41: NT_007592 | 42: XM_165804 | 43: XM_165697 | 44: NT_010956 |
| 45: NT_009471 | 46: NT_033944 | 47: XM_084759 | 48: XM_056913 |
| 49: XM_114817 | 50: NM_016368 | 51: XM_095533 | 52: XM_062470 |
| 53: XM_067111 | 54: XM_067089 | 55: NM_052885 | 56: XM_044063 |
| 57: XM_028610 | 58: NT_011526 | 59: XM_008065 | 60: XM_006747 |
| 61: XM_030060 | 62: XM_003530 | 63: NM_006319 | 64: NT_029991 |
| 65: NT_009799 | 66: XM_018252 | 67: NT_011288 | 68: XM_165960 |
| 69: XM_114004 | 70: NT_026437 | 71: XM_029288 | 72: NT_005414 |
| 73: XM_096169 | 74: NT_005403 | 75: XM_115825 | 76: NT_022197 |
| 77: NT_022171 | 78: XM_002493 | 79: XM_002279 | 80: XM_029748 |
| 81: BC027960 | 82: NM_002676 | 83: NM_017584 | 84: BC026331 |
| 85: NM_004897 | 86: NM_130785 | 87: AF009963 | 88: NM_014845 |
| 89: NM_025194 | 90: NM_006069 | 91: NM_130385 | 92: AL365444 |
| 93: AY064416 | 94: NM_078488 | 95: NM_004665 | 96: BC018952 |
| 97: NM_003866 | 98: NM_019892 | 99: NM_014937 | 100: Y18024 |
| 101: AK057550 | 102: AK056586 | 103: AF039945 | 104: BC018192 |
| 105: NM_005086 | 106: BC017189 | 107: BC017176 | 108: BC009565 |
| 109: BC015496 | 110: AF393812 | 111: U84400 | 112: AF368319 |
| 113: AB057723 | 114: AJ315644 | 115: NM_007368 | 116: BC008381 |
| 117: BC005274 | 118: BC004362 | 119: BC003622 | 120: BC001864 |
| 121: BC001444 | 122: AJ290975 | 123: AB057724 | 124: AF279372 |
| 125: AJ242780 | 126: AY032885 | 127: AL136579 | 128: AL050356 |
| 129: X83558 | 130: M88162 | 131: AF184215 | 132: NM_004027 |
| 133: NM_001566 | 134: NM_006506 | 135: AF063823 | 136: AF063822 |
| 137: AB042328 | 138: AL096840 | 139: AF207640 | 140: NM_002222 |
| 141: NM_000717 | 142: NM_005536 | 143: NM_016291 | 144: NM_014214 |
| 145: NM_006933 | 146: NM_005541 | 147: NM_005539 | 148: NM_005139 |
| 149: NM_001567 | 150: NM_002194 | 151: NM_003895 | 152: NM_002224 |
| 153: NM_002223 | 154: NM_002221 | 155: NM_002220 | 156: AC023051 |
| 157: AK024596 | 158: AK024045 | 159: AK022846 | 160: AK021526 |
| 161: AY007091 | 162: AF251265 | 163: AH009098 | 164: AF220249 |
| 165: AF220259 | 166: AF220258 | 167: AF220257 | 168: AF220256 |
| 169: AF220255 | 170: AF220254 | 171: AF220253 | 172: AF220252 |
| 173: AF220251 | 174: AF220250 | 175: AF220530 | 176: AF218361 |
| 177: AF187891 | 178: AF025878 | 179: AH007532 | 180: AF014398 |
| 181: AP001719 | 182: AF025886 | 183: AF025885 | 184: AF025884 |
| 185: AF025883 | 186: AF085632 | 187: AF085631 | 188: AF085630 |
| 189: AF085629 | 190: AF085628 | 191: AF085627 | 192: AF025882 |
| 193: AF025881 | 194: AF025880 | 195: AF025879 | 196: AF042729 |
| 197: AF178754 | 198: AF016028 | 199: AB036831 | 200: AB036830 |
| 201: AB036829 | 202: AK001325 | 203: AL137749 | 204: AJ251881 |
| 205: D13435 | 206: AF141325 | 207: AJ249339 | 208: AF177145 |
| 209: AF200432 | 210: AF125042 | 211: D89974 | 212: AH007823 |
| 213: AF157102 | 214: AF157101 | 215: AF157100 | 216: AF157099 |
| 217: AF157098 | 218: AF157097 | 219: AF157096 | 220: AF046915 |
| 221: AF046914 | 222: AC007192 | 223: S82269 | 224: S74936 |
| 225: AF115573 | 226: AF084944 | 227: AF084943 | 228: U53470 |
| 229: AB012610 | 230: U88725 | 231: AF009040 | 232: AF009039 |
| 233: U51336 | 234: U50041 | 235: U50040 | 236: U01062 |
| 237: L38500 | 238: AF027153 | 239: X80907 | 240: U23850 |
| 241: Y15056 | 242: Y14385 | 243: Y11366 | 244: Y11365 |
| 245: Y11364 | 246: Y11363 | 247: Y11367 | 248: Y11362 |
| 249: Y11361 | 250: Y11360 | 251: U96922 | 252: U96919 |
| 253: D38169 | 254: D26070 | 255: D26351 | 256: D26350 |
| 257: U57650 | 258: Y11999 | 259: X89105 | 260: X98429 |
| 261: L38019 | 262: U26398 | 263: X66922 | 264: X57206 |
| 265: X77567 | 266: Z31695 | 267: X54938 | 268: L36818 |
| 269: M74161 | 270: L47220 | 271: M63310 | 272: L08488 |
| 273: AH001430 | 274: L10955 | 275: L10954 | 276: L10953 |

TABLE 3
GenBank Accession numbers of human sequence records identified
as related to nucleic acids encoding polypeptides potentially related to
adenylate cyclase metabolism and/or signaling.

| | | | | | | | |
|---|---|---|---|---|---|---|---|
| 1: | NM_139247 | 2: | D17516 | 3: | NM_020983 | 4: | NM_015270 |
| 5: | NT_008769 | 6: | NT_023709 | 7: | NT_028053 | 8: | XM_007897 |
| 9: | XM_012740 | 10: | XM_028817 | 11: | XM_036725 | 12: | XM_096265 |
| 13: | XM_113762 | 14: | XM_036671 | 15: | XM_041507 | 16: | NT_006859 |
| 17: | NT_009984 | 18: | XM_036383 | 19: | NT_010164 | 20: | NT_007819 |
| 21: | XM_166593 | 22: | XM_039712 | 23: | XM_090617 | 24: | XM_036413 |
| 25: | BC028085 | 26: | BC027943 | 27: | BC020148 | 28: | NM_001841 |
| 29: | AK056745 | 30: | NM_033181 | 31: | D86984 | 32: | NM_000681 |
| 33: | NM_004624 | 34: | AK001637 | 35: | NM_016083 | 36: | NM_001840 |
| 37: | AY028959 | 38: | AY028957 | 39: | AY028956 | 40: | AY028955 |
| 41: | AY028954 | 42: | AY028953 | 43: | AY028952 | 44: | AY028951 |
| 45: | AY028950 | 46: | AY028949 | 47: | AY028948 | 48: | AH010599 |
| 49: | NM_000872 | 50: | NM_019860 | 51: | NM_019859 | 52: | NM_000025 |
| 53: | NM_001117 | 54: | NM_004036 | 55: | NM_000866 | 56: | NM_012125 |
| 57: | NM_000677 | 58: | NM_000054 | 59: | NM_005281 | 60: | NM_005145 |
| 61: | NM_001116 | 62: | NM_001115 | 63: | NM_001114 | 64: | NM_000741 |
| 65: | NM_000740 | 66: | NM_000739 | 67: | NM_000738 | 68: | NM_000676 |
| 69: | NM_000674 | 70: | NM_001118 | 71: | AK022951 | 72: | U09216 |
| 73: | AJ012074 | 74: | S56143 | 75: | AK001924 | 76: | AK001854 |
| 77: | AK001438 | 78: | X60435 | 79: | S83513 | 80: | U18810 |
| 81: | L21195 | 82: | AF088070 | 83: | AF086306 | 84: | AF086230 |
| 85: | Y12507 | 86: | Y12506 | 87: | Y12505 | 88: | D38299 |
| 89: | D38301 | 90: | D38300 | 91: | D28472 | 92: | X74210 |
| 93: | X83956 | 94: | X07036 | 95: | X04408 | 96: | X04409 |
| 97: | X04828 | 98: | M23533 | 99: | L04962 | 100: | L05597 |
| 101: | L25124 | | | | | | |

TABLE 4
GenBank Accession numbers of human sequence records identified
as related to nucleic acids encoding polypeptides potentially related to
potasium channel metabolism and/or signaling.

| | | | | | |
|---|---|---|---|---|---|
| 1: | AF348984 | 2: | AF348983 | 3: | AF348982 |
| 4: | NM_144633 | 5: | NM_138318 | 6: | NM_138317 |
| 7: | NM_021161 | 8: | NM_033456 | 9: | NM_033455 |
| 10: | NM_033348 | 11: | NM_033347 | 12: | NM_005714 |
| 13: | NM_002249 | 14: | NM_002243 | 15: | NM_001194 |
| 16: | AF493798 | 17: | AF472412 | 18: | AF000972 |
| 19: | NM_139318 | 20: | NM_002236 | 21: | NM_033311 |
| 22: | NM_033310 | 23: | NM_016611 | 24: | NM_002246 |
| 25: | NM_022358 | 26: | NM_014217 | 27: | AF065163 |
| 28: | SEG_HUMUKATPS | 29: | D50315 | 30: | D50314 |
| 31: | D50313 | 32: | NM_139137 | 33: | NM_139136 |
| 34: | NT_009307 | 35: | NT_010376 | 36: | NT_024375 |
| 37: | NT_030075 | 38: | NT_008104 | 39: | NT_008413 |
| 40: | NT_004612 | 41: | NT_004416 | 42: | NT_022517 |
| 43: | NT_021909 | 44: | NT_021877 | 45: | NT_019273 |
| 46: | NT_033262 | 47: | NT_033200 | 48: | NT_033241 |
| 49: | AF418206 | 50: | NT_010422 | 51: | NT_011512 |
| 52: | NT_033899 | 53: | NT_011333 | 54: | NT_010700 |
| 55: | NT_007592 | 56: | XM_056976 | 57: | XM_001299 |
| 58: | XM_059493 | 59: | XM_084080 | 60: | XM_115258 |
| 61: | XM_165593 | 62: | XM_115027 | 63: | XM_113221 |
| 64: | XM_114797 | 65: | NM_133329 | 66: | NM_133497 |
| 67: | XM_091498 | 68: | XM_084762 | 69: | XM_090187 |
| 70: | XM_084388 | 71: | XM_088998 | 72: | NT_011362 |
| 73: | XM_065997 | 74: | XM_028862 | 75: | XM_006988 |
| 76: | XM_018513 | 77: | NM_016121 | 78: | NT_011669 |
| 79: | NT_033316 | 80: | XM_113356 | 81: | NT_030171 |
| 82: | NT_011233 | 83: | NT_006576 | 84: | XM_116412 |
| 85: | NT_026437 | 86: | NT_005367 | 87: | NT_005334 |
| 88: | NT_005612 | 89: | XM_056742 | 90: | NT_015120 |
| 91: | XM_093482 | 92: | XM_066592 | 93: | XM_042027 |
| 94: | XM_010829 | 95: | XM_029336 | 96: | AF385400 |
| 97: | AF385399 | 98: | NM_133490 | 99: | BC028739 |
| 100: | AF305072 | 101: | AF302044 | 102: | NM_014505 |
| 103: | NM_002252 | 104: | NM_014407 | 105: | AF482710 |
| 106: | AH011548 | 107: | AC005833 | 108: | BC025726 |
| 109: | AF453246 | 110: | AF453244 | 111: | AJ272506 |
| 112: | M38217 | 113: | AJ272519 | 114: | AJ272518 |
| 115: | AJ272517 | 116: | AJ272516 | 117: | AJ272515 |
| 118: | AJ272514 | 119: | AJ272513 | 120: | AJ272512 |
| 121: | AJ272511 | 122: | AJ272510 | 123: | AJ272509 |
| 124: | AJ272508 | 125: | AJ272507 | 126: | AF294352 |
| 127: | AF294351 | 128: | AF294350 | 129: | AK074390 |
| 130: | NM_031460 | 131: | AF349445 | 132: | NM_001364 |
| 133: | NM_013348 | 134: | AF055989 | 135: | AF438203 |
| 136: | AF438202 | 137: | NM_016601 | 138: | NM_033272 |
| 139: | NM_020122 | 140: | AK055089 | 141: | BC018051 |
| 142: | AL158822 | 143: | NM_004974 | 144: | AY053503 |
| 145: | AY040849 | 146: | AF358910 | 147: | AF344826 |
| 148: | NM_022055 | 149: | NM_032115 | 150: | AF268897 |
| 151: | AF268896 | 152: | NM_022054 | 153: | AY049734 |
| 154: | AF074247 | 155: | AJ006128 | 156: | AL157833 |
| 157: | NM_003740 | 158: | NM_004823 | 159: | NM_002245 |
| 160: | AF294266 | 161: | BC012779 | 162: | AF397175 |
| 163: | BC004367 | 164: | BC000178 | 165: | AF257081 |
| 166: | AF257080 | 167: | AL121829 | 168: | AF315818 |
| 169: | AF336797 | 170: | AF171068 | 171: | AF319633 |
| 172: | AJ310479 | 173: | AJ251016 | 174: | AF031815 |
| 175: | U52155 | 176: | U52154 | 177: | U52153 |
| 178: | U52152 | 179: | AK027657 | 180: | AK027347 |
| 181: | NM_031886 | 182: | AF358909 | 183: | AF336342 |
| 184: | AF153819 | 185: | AF153818 | 186: | AH009400 |
| 187: | AC005559 | 188: | AL118522 | 189: | AL121827 |
| 190: | AL353658 | 191: | NM_030779 | 192: | AF339912 |
| 193: | NM_002251 | 194: | AF129399 | 195: | AF043473 |
| 196: | AB044585 | 197: | AB044584 | 198: | AF153814 |
| 199: | AF153813 | 200: | AF153812 | 201: | AF153811 |
| 202: | AF153810 | 203: | AF153809 | 204: | AH009401 |
| 205: | AF153820 | 206: | AF153817 | 207: | AF153816 |
| 208: | AF153815 | 209: | AF082182 | 210: | AL121785 |
| 211: | AL035685 | 212: | AF287303 | 213: | AF287302 |
| 214: | NM_020298 | 215: | NM_020297 | 216: | NM_006855 |
| 217: | NM_016657 | 218: | NM_005691 | 219: | AF029780 |
| 220: | AF311913 | 221: | AF239613 | 222: | AF305735 |
| 223: | AF305734 | 224: | AF305733 | 225: | AF305732 |
| 226: | AF305731 | 227: | AH009923 | 228: | U32376 |
| 229: | AF248242 | 230: | AF248241 | 231: | AJ297404 |
| 232: | AJ297405 | 233: | NM_000220 | 234: | NM_019842 |
| 235: | NM_014379 | 236: | NM_014406 | 237: | NM_012283 |
| 238: | NM_002248 | 239: | NM_005477 | 240: | NM_004983 |
| 241: | NM_004982 | 242: | NM_000890 | 243: | NM_004981 |
| 244: | NM_005136 | 245: | NM_004978 | 246: | NM_004977 |
| 247: | NM_004976 | 248: | NM_004975 | 249: | NM_004700 |
| 250: | NM_004519 | 251: | NM_004518 | 252: | NM_004732 |
| 253: | NM_000238 | 254: | NM_000218 | 255: | NM_000219 |
| 256: | NM_000217 | 257: | NM_001365 | 258: | NM_002250 |
| 259: | NM_002247 | 260: | NM_002244 | 261: | NM_002240 |
| 262: | NM_002239 | 263: | NM_000891 | 264: | NM_002241 |
| 265: | NM_002238 | 266: | NM_002237 | 267: | NM_003636 |
| 268: | NM_003471 | 269: | NM_002235 | 270: | NM_002234 |
| 271: | NM_002233 | 272: | NM_002232 | 273: | AF081466 |
| 274: | AK024857 | 275: | AK022344 | 276: | AF279890 |
| 277: | AL136087 | 278: | AF179353 | 279: | AF295530 |
| 280: | AF295076 | 281: | AF181988 | 282: | AF021139 |
| 283: | AF032897 | 284: | AF249278 | 285: | AF170917 |
| 286: | AF170916 | 287: | AF202977 | 288: | AF279809 |
| 289: | AB021865 | 290: | AF263835 | 291: | AP001730 |
| 292: | AP001729 | 293: | AP001731 | 294: | AP001720 |
| 295: | AP000365 | 296: | AF212829 | 297: | U11058 |
| 298: | AF160967 | 299: | AF166011 | 300: | AF166010 |
| 301: | AF166009 | 302: | AH009283 | 303: | AF160968 |
| 304: | AF155652 | 305: | AF166008 | 306: | AF166007 |
| 307: | AH009258 | 308: | AF166006 | 309: | AF166005 |
| 310: | AF166004 | 311: | AH009257 | 312: | AF166003 |
| 313: | AF120491 | 314: | AF247042 | 315: | AB032013 |
| 316: | AB032012 | 317: | AB032011 | 318: | SEG_AB032011S |
| 319: | SEG_AB01514S | 320: | AB015163 | 321: | AB015162 |
| 322: | AB015161 | 323: | AB015160 | 324: | AB015159 |
| 325: | AB015158 | 326: | AB015157 | 327: | AB015156 |
| 328: | AB015155 | 329: | AB015154 | 330: | AB015153 |
| 331: | AB015152 | 332: | AB015151 | 333: | AB015150 |
| 334: | AB015149 | 335: | AB015148 | 336: | AB015147 |
| 337: | AF011904 | 338: | AJ276317 | 339: | AC010072 |
| 340: | AF214561 | 341: | AF209747 | 342: | AF207992 |
| 343: | AL133016 | 344: | AL122115 | 345: | AF199599 |
| 346: | AF199598 | 347: | AF199597 | 348: | AF155110 |
| 349: | AF043472 | 350: | AF205857 | 351: | AF205856 |
| 352: | AC004946 | 353: | AC004888 | 354: | AF167082 |
| 355: | AF139471 | 356: | Z97056 | 357: | AF207550 |
| 358: | AB013891 | 359: | AB013889 | 360: | AF078742 |
| 361: | AF078741 | 362: | U69883 | 363: | AF187964 |
| 364: | AF187963 | 365: | AJ010969 | 366: | AJ011021 |
| 367: | AF142568 | 368: | AF117708 | 369: | U65406 |
| 370: | AF016411 | 371: | AH007779 | 372: | AF131948 |
| 373: | AF131947 | 374: | AF131946 | 375: | AF131945 |
| 376: | AF131944 | 377: | AF131943 | 378: | AF131942 |
| 379: | AF131941 | 380: | AF131940 | 381: | AF131939 |
| 382: | AF131938 | 383: | AF137071 | 384: | AJ006344 |
| 385: | AJ006343 | 386: | AF076531 | 387: | AF071002 |
| 388: | AF135188 | 389: | AF121104 | 390: | AF105373 |
| 391: | AF105372 | 392: | AF110020 | 393: | AH007377 |
| 394: | AF105216 | 395: | AF105215 | 396: | AF105214 |
| 397: | AF105213 | 398: | AF105212 | 399: | AF105211 |
| 400: | AF105210 | 401: | AF105209 | 402: | AF105208 |
| 403: | AF105207 | 404: | AF105206 | 405: | AF105205 |
| 406: | AF105204 | 407: | AF105203 | 408: | AF105202 |
| 409: | AF035046 | 410: | AF004711 | 411: | AH007067 |
| 412: | AF071491 | 413: | AF071490 | 414: | AF071489 |
| 415: | AF071488 | 416: | AF071487 | 417: | AF071486 |
| 418: | AF071485 | 419: | AF071484 | 420: | AF071483 |
| 421: | AF071482 | 422: | AF071481 | 423: | AF071480 |
| 424: | AF071479 | 425: | AF071478 | 426: | AJ012369 |
| 427: | Y10745 | 428: | AF052728 | 429: | Y13896 |
| 430: | Y13895 | 431: | AJ001891 | 432: | AJ001366 |
| 433: | AJ007557 | 434: | S72503 | 435: | AF015607 |
| 436: | AF015606 | 437: | AF015605 | 438: | AF022797 |
| 439: | U89364 | 440: | U96110 | 441: | U33429 |
| 442: | U73193 | 443: | U73192 | 444: | U73191 |
| 445: | U52432 | 446: | U33428 | 447: | U11717 |
| 448: | U24660 | 449: | U16953 | 450: | U17968 |
| 451: | U12507 | 452: | AF033021 | 453: | AF053478 |
| 454: | AF053477 | 455: | AJ010538 | 456: | L23499 |
| 457: | AJ005898 | 458: | AF022150 | 459: | AF061118 |
| 460: | AF033383 | 461: | AF033382 | 462: | AF048713 |
| 463: | AF048712 | 464: | Y15065 | 465: | AF003743 |
| 466: | AF044253 | 467: | U76996 | 468: | AF033348 |
| 469: | AF033347 | 470: | AF026005 | 471: | AF026002 |
| 472: | AF025999 | 473: | AF029749 | 474: | U61537 |
| 475: | U61536 | 476: | D87327 | 477: | D87291 |
| 478: | D50134 | 479: | U86146 | 480: | D50312 |
| 481: | U39196 | 482: | U39195 | 483: | U90065 |
| 484: | U24055 | 485: | U50964 | 486: | X83127 |
| 487: | S78737 | 488: | S56770 | 489: | U42600 |
| 490: | AH003672 | 491: | U42603 | 492: | U42602 |
| 493: | U42601 | 494: | U69962 | 495: | U25138 |
| 496: | L78480 | 497: | X83582 | 498: | X17622 |
| 499: | X68302 | 500: | Z11585 | 501: | U23767 |
| 502: | U16861 | 503: | U13913 | 504: | U24056 |
| 505: | L36069 | 506: | U22413 | 507: | L33815 |
| 508: | U04270 | 509: | U12545 | 510: | U12544 |
| 511: | U12543 | 512: | U12542 | 513: | U12541 |
| 514: | M60451 | 515: | M60450 | 516: | M83254 |
| 517: | M55514 | 518: | M96747 | 519: | M85217 |
| 520: | L28168 | 521: | M64676 | 522: | U09384 |
| 523: | U02632 | 524: | M55515 | 525: | M55513 |
| 526: | L02840 | 527: | L00621 | 528: | L02752 |
| 529: | L02751 | 530: | L02750 | 531: | M26685 |
| 532: | U07364 | 533: | U07918 | | |

TABLE 5
GenBank Accession numbers of human sequence records identified
as related to nucleic acids encoding polypeptides potentially related to sodium
channel metabolism and/or signaling.

| | | | |
|---|---|---|---|
| 1: NM_020039 | 2: NM_001095 | 3: NM_001094 | 4: NM_002976 |
| 5: NM_015277 | 6: NM_004588 | 7: BC030193 | 8: NT_009151 |
| 9: NT_009731 | 10: NT_009609 | 11: NT_006129 | 12: NT_033049 |
| 13: NM_005612 | 14: NT_033284 | 15: XM_113296 | 16: NT_033899 |
| 17: NT_010736 | 18: NT_011085 | 19: XM_114084 | 20: XM_113411 |
| 21: XM_116055 | 22: XM_083942 | 23: XM_028504 | 24: XM_064330 |
| 25: XM_008249 | 26: XM_032835 | 27: XM_007990 | 28: XM_097396 |
| 29: NT_007914 | 30: NT_033178 | 31: NT_005343 | 32: XM_010769 |
| 33: XM_114281 | 34: XM_054184 | 35: XM_033675 | 36: BQ268051 |
| 37: AY043484 | 38: AF260228 | 39: AF260227 | 40: AH011264 |
| 41: AF260226 | 42: NM_006922 | 43: U81961 | 44: AY007685 |
| 45: BD004564 | 46: BD004563 | 47: BD004562 | 48: E37451 |
| 49: AX354521 | 50: AX354520 | 51: NM_002837 | 52: NM_001649 |
| 53: BM353290 | 54: BM352813 | 55: AJ310898 | 56: AJ310897 |
| 57: AJ310896 | 58: AJ310895 | 59: AJ310894 | 60: AJ310893 |
| 61: AJ310892 | 62: AJ310891 | 63: AJ310890 | 64: AJ310889 |
| 65: AJ310888 | 66: AJ310887 | 67: AJ310886 | 68: AJ310885 |
| 69: AJ310884 | 70: AJ310883 | 71: AJ310882 | 72: BM314926 |
| 73: NM_018400 | 74: BC006526 | 75: BI964932 | 76: BI962702 |
| 77: AH005909 | 78: AF049497 | 79: AF049496 | 80: AB071179 |
| 81: BI789210 | 82: AF087511 | 83: AF087510 | 84: AY038064 |
| 85: AH007622 | 86: AF060913 | 87: AF060912 | 88: AF060911 |
| 89: AF060910 | 90: BG108767 | 91: AJ251507 | 92: AF356502 |
| 93: AF356501 | 94: AF356500 | 95: AF356499 | 96: AF356498 |
| 97: AF356497 | 98: AF356496 | 99: AF356495 | 100: AF356494 |
| 101: AF356493 | 102: AH010738 | 103: AU099675 | 104: AU099608 |
| 105: NM_001091 | 106: S82622 | 107: E36123 | 108: M55662 |
| 109: NM_021602 | 110: NM_000626 | 111: NM_020322 | 112: NM_020321 |
| 113: NM_004769 | 114: BG152517 | 115: AF225987 | 116: AF225986 |
| 117: AF225985 | 118: AF330135 | 119: AF330134 | 120: AF330133 |
| 121: AF330132 | 122: AF330131 | 123: AF330130 | 124: AF330129 |
| 125: AF330128 | 126: AF330127 | 127: AF330126 | 128: AF330125 |
| 129: AF330124 | 130: AF330123 | 131: AF330122 | 132: AF330121 |
| 133: AF330120 | 134: AF330119 | 135: AF330118 | 136: AF330117 |
| 137: AF330116 | 138: AH010233 | 139: AF327246 | 140: AF327245 |
| 141: AF327244 | 142: AF327243 | 143: AF327242 | 144: AF327241 |
| 145: AF327240 | 146: AF327239 | 147: AF327238 | 148: AF327237 |
| 149: AF327236 | 150: AF327235 | 151: AF327234 | 152: AF327233 |
| 153: AF327232 | 154: AF327231 | 155: AF327230 | 156: AF327229 |
| 157: AF327228 | 158: AF327227 | 159: AF327226 | 160: AF327225 |
| 161: AF327224 | 162: AH010232 | 163: BF941784 | 164: NM_000336 |
| 165: NM_000335 | 166: AF038871 | 167: AJ002484 | 168: AJ002483 |
| 169: BF195781 | 170: NM_021007 | 171: NM_014191 | 172: NM_014139 |
| 173: NM_006514 | 174: NM_001039 | 175: NM_002978 | 176: NM_001038 |
| 177: NM_002977 | 178: NM_000334 | 179: NM_001037 | 180: G64248 |
| 181: BF061009 | 182: BF002594 | 183: AX017233 | 184: AX017232 |
| 185: AX017231 | 186: AX017230 | 187: AX017229 | 188: AX017228 |
| 189: AX017227 | 190: AX017226 | 191: AX017225 | 192: AX017224 |
| 193: AX017223 | 194: AX017222 | 195: AX017221 | 196: AX017220 |
| 197: AX017219 | 198: BE671436 | 199: AJ277395 | 200: AJ277394 |
| 201: AJ277393 | 202: AJ276142 | 203: AJ276141 | 204: AJ276140 |
| 205: AJ276139 | 206: BE463571 | 207: AB037525 | 208: U48937 |
| 209: AW771930 | 210: AJ252011 | 211: L48689 | 212: AF239921 |
| 213: AJ243396 | 214: AW468811 | 215: AF225988 | 216: A82786 |
| 217: A82597 | 218: A82595 | 219: A82593 | 220: AF150882 |
| 221: AF109737 | 222: AW276630 | 223: U87555 | 224: AF188679 |
| 225: AC002300 | 226: AW190344 | 227: AW170363 | 228: AF059683 |
| 229: AW105326 | 230: AW025990 | 231: AW008644 | 232: AW002349 |
| 233: AW001231 | 234: AF126739 | 235: AF107028 | 236: AI932372 |
| 237: AI915394 | 238: AI884536 | 239: AI862563 | 240: AI796228 |
| 241: AB027567 | 242: AI683977 | 243: AI675767 | 244: AF117907 |
| 245: AH007414 | 246: AF050736 | 247: AF050735 | 248: AF050734 |
| 249: AF050733 | 250: AF050732 | 251: AF050731 | 252: AF050730 |
| 253: AF050729 | 254: AF050728 | 255: AF050727 | 256: AF050726 |
| 257: AF050725 | 258: AF050724 | 259: AF050723 | 260: AF050722 |
| 261: AF050721 | 262: AF050720 | 263: AF050719 | 264: AF050718 |
| 265: AF050717 | 266: AF050716 | 267: AF050715 | 268: AF050714 |
| 269: AF050713 | 270: AF050712 | 271: AF050711 | 272: AJ005393 |
| 273: AJ005392 | 274: AJ005391 | 275: AJ005390 | 276: AJ005389 |
| 277: AJ005388 | 278: AJ005387 | 279: AJ005386 | 280: AJ005385 |
| 281: AJ005384 | 282: AJ005383 | 283: AI567447 | 284: AI553866 |
| 285: AF049618 | 286: AI361695 | 287: S75992 | 288: AI401486 |
| 289: AI280308 | 290: AI277385 | 291: AI275868 | 292: AI377290 |
| 293: AI361696 | 294: AA885031 | 295: AA885211 | 296: AI338340 |
| 297: AI199647 | 298: AI241832 | 299: AI191453 | 300: AI131238 |
| 301: AI146968 | 302: AH006646 | 303: U53853 | 304: U53852 |
| 305: U53851 | 306: U53850 | 307: U53849 | 308: U53848 |
| 309: U53847 | 310: U53846 | 311: U53845 | 312: U53844 |
| 313: U53843 | 314: U53842 | 315: U53841 | 316: U53840 |
| 317: U53839 | 318: U53838 | 319: U53837 | 320: U53836 |
| 321: U53835 | 322: U48936 | 323: U50352 | 324: U38254 |
| 325: U35630 | 326: AI026646 | 327: AI027237 | 328: AI017422 |
| 329: AI016157 | 330: AI005419 | 331: AA994701 | 332: AA912739 |
| 333: AI091722 | 334: AF035686 | 335: AF035685 | 336: X65362 |
| 337: Z92978 | 338: Z92982 | 339: Z92981 | 340: Z92980 |
| 341: Z92979 | 342: AJ002482 | 343: AF007783 | 344: X97925 |
| 345: AA917500 | 346: AA913881 | 347: AA913423 | 348: AA887514 |
| 349: AA984063 | 350: X65361 | 351: AB010575 | 352: U24693 |
| 353: AA214661 | 354: AA211081 | 355: AF049498 | 356: AA778416 |
| 357: AH005825 | 358: U12194 | 359: U12193 | 360: U12192 |
| 361: U12188 | 362: U12191 | 363: U12190 | 364: U12189 |
| 365: AA666056 | 366: AA429417 | 367: AA428361 | 368: AA422068 |
| 369: AA620400 | 370: AA595839 | 371: AA397575 | 372: AA393950 |
| 373: AF007782 | 374: AF007781 | 375: AH005307 | 376: L04236 |
| 377: L04235 | 378: L04234 | 379: L04233 | 380: L04232 |
| 381: L04231 | 382: L04230 | 383: L04229 | 384: L04228 |
| 385: L04227 | 386: L04226 | 387: L04225 | 388: L04224 |
| 389: L04223 | 390: L04222 | 391: L04221 | 392: L04220 |
| 393: L04219 | 394: L04218 | 395: L04217 | 396: L04216 |
| 397: AA449579 | 398: AA446878 | 399: AA035472 | 400: AA035445 |
| 401: AA029133 | 402: AA383040 | 403: AA360938 | 404: AA322364 |
| 405: AA298508 | 406: AA297746 | 407: AA297047 | 408: AA295926 |
| 409: U57352 | 416: U78181 | 411: U78180 | 412: AA206530 |
| 413: S71446 | 414: S69887 | 415: Z50169 | 416: U22314 |
| 417: X82835 | 418: X87160 | 419: X87159 | 420: N53512 |
| 421: AH003201 | 422: L01968 | 423: L01964 | 424: L01983 |
| 425: L01982 | 426: L01981 | 427: L01980 | 428: L01979 |
| 429: L01978 | 430: L01977 | 431: L01976 | 432: L01975 |
| 433: L01974 | 434: L01973 | 435: L01972 | 436: L01971 |
| 437: L01970 | 438: L01969 | 439: L01967 | 440: L01966 |
| 441: L01965 | 442: L01963 | 443: L01962 | 444: L36593 |
| 445: L36592 | 446: T29303 | 447: T28389 | 448: R90820 |
| 449: H26938 | 450: H23297 | 451: R74525 | 452: U16023 |
| 453: R53503 | 454: L16242 | 455: M81758 | 456: L10338 |
| 457: M91556 | 458: M77235 | 459: T19733 | 460: M85046 |
| 461: M85045 | 462: M91804 | 463: M91803 | 464: L29007 |
| 465: M94055 | 466: U02693 | 467: T07957 | 468: T06279 |

TABLE 6
GenBank Accession numbers of human sequence records identified
as related to nucleic acids encoding polypeptides potentially related to
serotonin metabolism and/or signaling.

| | | | | | | | |
|---|---|---|---|---|---|---|---|
| 1: | NM_000870 | 2: | NT_009151 | 3: | NT_009714 | 4: | NT_008769 |
| 5: | NT_004610 | 6: | NT_029218 | 7: | NT_005791 | 8: | NT_024897 |
| 9: | NT_010641 | 10: | NT_028405 | 11: | XM_049607 | 12: | NT_025741 |
| 13: | NT_023399 | 14: | NT_033922 | 15: | XM_165640 | 16: | NT_006859 |
| 17: | NT_006431 | 18: | NT_007666 | 19: | NT_005403 | 20: | XM_004134 |
| 21: | XM_003692 | 22: | AF498985 | 23: | AF498984 | 24: | AF498983 |
| 25: | AF498982 | 26: | AF498981 | 27: | AF498980 | 28: | AF498979 |
| 29: | AF498978 | 30: | NM_003739 | 31: | NM_000864 | 32: | AJ011371 |
| 33: | NM_130770 | 34: | AF459285 | 35: | NM_000675 | 36: | AX253256 |
| 37: | AB041403 | 38: | BC007720 | 39: | BC002354 | 40: | AB061801 |
| 41: | AB061800 | 42: | AB061799 | 43: | AJ308680 | 44: | AJ308679 |
| 45: | NM_002383 | 46: | S78723 | 47: | NM_024012 | 48: | NM_000872 |
| 49: | NM_019860 | 50: | NM_019859 | 51: | AJ131724 | 52: | NM_001088 |
| 53: | NM_000866 | 54: | NM_000621 | 55: | NM_014626 | 56: | NM_014627 |
| 57: | NM_006028 | 58: | NM_004179 | 59: | NM_000240 | 60: | NM_001045 |
| 61: | NM_000871 | 62: | NM_000869 | 63: | NM_000868 | 64: | NM_000867 |
| 65: | NM_000865 | 66: | NM_000863 | 67: | NM_000524 | 68: | NM_000674 |
| 69: | AF298814 | 70: | AF149416 | 71: | AL157777 | 72: | AJ005205 |
| 73: | AB037533 | 74: | AB037513 | 75: | AF208053 | 76: | D49394 |
| 77: | AB041373 | 78: | AB041370 | 79: | AF233399 | 80: | AL049576 |
| 81: | AF112461 | 82: | AF112460 | 83: | AJ003080 | 84: | AJ003078 |
| 85: | AJ243213 | 86: | AB031259 | 87: | AB031258 | 88: | AB031257 |
| 89: | AB031256 | 90: | AB031255 | 91: | AB031254 | 92: | AB031253 |
| 93: | AB031252 | 94: | AB031251 | 95: | AB031250 | 96: | AB031249 |
| 97: | AB031248 | 98: | AB031247 | 99: | AL049595 | 100: | X80763 |
| 101: | AF169255 | 102: | AH003966 | 103: | S42168 | 104: | S42167 |
| 105: | AH001421 | 106: | M84601 | 107: | M84592 | 108: | M84591 |
| 109: | M84590 | 110: | M84589 | 111: | M84588 | 112: | M84599 |
| 113: | M84598 | 114: | M84595 | 115: | M84597 | 116: | M84596 |
| 117: | M84594 | 118: | M84593 | 119: | M84600 | 120: | M77828 |
| 121: | L13665 | 122: | AF126506 | 123: | AI819939 | 124: | X57829 |
| 125: | AF117826 | 126: | X76753 | 127: | Y13147 | 128: | AF080582 |
| 129: | Y09586 | 130: | U40391 | 131: | U40347 | 132: | L21195 |
| 133: | AF072904 | 134: | Y12507 | 135: | Y12506 | 136: | U88828 |
| 137: | Y12505 | 138: | Y08756 | 139: | AF007141 | 140: | Y13584 |
| 141: | U86813 | 142: | AA757429 | 143: | Y10437 | 144: | AA722177 |
| 145: | U79746 | 146: | AA708262 | 147: | AA700086 | 148: | AA700070 |
| 149: | Z49119 | 150: | Z48150 | 151: | U73443 | 152: | D10995 |
| 153: | D87030 | 154: | AA365330 | 155: | AA364412 | 156: | U49648 |
| 157: | U49516 | 158: | X76757 | 159: | X76756 | 160: | X76754 |
| 161: | X76762 | 162: | X76761 | 163: | X76760 | 164: | X76759 |
| 165: | X76758 | 166: | X76755 | 167: | X98194 | 168: | X98147 |
| 169: | X98193 | 170: | S71229 | 171: | C06167 | 172: | Z36748 |
| 173: | Z11168 | 174: | U33819 | 175: | X81412 | 176: | X81411 |
| 177: | X77307 | 178: | X52836 | 179: | Z34845 | 180: | X70697 |
| 181: | X57830 | 182: | Z11166 | 183: | L41147 | 184: | M83181 |
| 185: | M81778 | 186: | M81590 | 187: | M81589 | 188: | M75128 |
| 189: | M92826 | 190: | M86841 | 191: | M91467 | 192: | L04962 |
| 193: | L05597 | 194: | M83180 | 195: | L06179 | 196: | L05568 |
| 197: | M89955 | 198: | M89478 | | | | |

TABLE 7
GenBank Accession numbers of human sequence records identified
as related to nucleic acids encoding polypeptides potentially related to
fibroblast growth factors metabolism and/or signaling.

| | | | |
|---|---|---|---|
| 1: BC032697 | 2: NM_139266 | 3: NM_007315 | 4: AF508782 |
| 5: AF520763 | 6: NM_004385 | 7: NM_006654 | 8: D14872 |
| 9: NT_009151 | 10: NT_024192 | 11: NT_024413 | 12: NT_010194 |
| 13: NT_008769 | 14: NT_030764 | 15: NT_030040 | 16: NT_005501 |
| 17: NT_006111 | 18: NT_006109 | 19: NT_022865 | 20: NT_016354 |
| 21: NT_033229 | 22: NT_024773 | 23: NT_010478 | 24: XM_049890 |
| 25: NT_010823 | 26: NT_033929 | 27: XM_169242 | 28: XM_167430 |
| 29: NT_033944 | 30: XM_084481 | 31: XM_044120 | 32: XM_064055 |
| 33: XM_055784 | 34: XM_003444 | 35: XM_017651 | 36: XM_042695 |
| 37: NM_013394 | 38: NT_011719 | 39: NT_009799 | 40: NT_033316 |
| 41: NT_024524 | 42: NT_030171 | 43: NT_006859 | 44: XM_096234 |
| 45: NT_009952 | 46: NT_006725 | 47: NT_008300 | 48: NT_008251 |
| 49: XM_049463 | 50: NT_007819 | 51: NT_030737 | 52: NT_023132 |
| 53: NT_023098 | 54: NT_033210 | 55: NT_005367 | 56: XM_090648 |
| 57: XM_084273 | 58: M88272 | 59: BQ269244 | 60: AF487554 |
| 61: AY094623 | 62: AF487555 | 63: NM_007083 | 64: AF497475 |
| 65: NM_133336 | 66: NM_133335 | 67: NM_133334 | 68: NM_133333 |
| 69: NM_133332 | 70: NM_133331 | 71: NM_133330 | 72: NM_014919 |
| 73: NM_007331 | 74: AF245114 | 75: NM_007050 | 76: NM_133170 |
| 77: AF360695 | 78: AH010989 | 79: AF410480 | 80: AX378915 |
| 81: AX378914 | 82: BM874752 | 83: BM874259 | 84: NM_080838 |
| 85: NM_003882 | 86: AF359246 | 87: NM_012201 | 88: NM_006595 |
| 89: BM311972 | 90: AX318785 | 91: AX318710 | 92: AX318684 |
| 93: NM_007373 | 94: NM_006824 | 95: M34641 | 96: AX275080 |
| 97: AX275079 | 98: AX275054 | 99: AX275053 | 100: AX275042 |
| 101: BC017664 | 102: AF035374 | 103: AX287610 | 104: AX287608 |
| 105: AX287596 | 106: BC017448 | 107: AJ298918 | 108: AJ298917 |
| 109: AJ298916 | 110: AY049782 | 111: NM_033649 | 112: NM_004114 |
| 113: NM_033642 | 114: NM_003862 | 115: NM_003867 | 116: AX250592 |
| 117: AF359241 | 118: AB014615 | 119: AF411527 | 120: BC014388 |
| 121: AX235431 | 122: NM_005247 | 123: NM_002006 | 124: NM_003868 |
| 125: NM_006119 | 126: NM_033165 | 127: NM_033164 | 128: NM_033163 |
| 129: NM_002009 | 130: NM_020996 | 131: NM_004112 | 132: NM_004465 |
| 133: NM_002010 | 134: AX179562 | 135: AX179564 | 136: BC011847 |
| 137: NM_004464 | 138: NM_033143 | 139: NM_020638 | 140: NM_000800 |
| 141: NM_033137 | 142: NM_033136 | 143: NM_020637 | 144: NM_019113 |
| 145: NM_002007 | 146: BC010956 | 147: NM_005117 | 148: NM_019851 |
| 149: NM_004115 | 150: NM_000088 | 151: BC006245 | 152: BC002537 |
| 153: AX156438 | 154: AX156436 | 155: AX156434 | 156: AL160153 |
| 157: AF369213 | 158: AF369212 | 159: AF369211 | 160: AX105677 |
| 161: AX105675 | 162: AX105674 | 163: AX105673 | 164: AX105671 |
| 165: AX105669 | 166: AX105667 | 167: AX105665 | 168: AX105663 |
| 169: AX105661 | 170: AF110400 | 171: AU100202 | 172: AX097639 |
| 173: AX092981 | 174: AF279689 | 175: S67291 | 176: NM_023031 |
| 177: NM_023030 | 178: NM_023028 | 179: NM_022976 | 180: NM_022975 |
| 181: NM_022974 | 182: NM_022973 | 183: NM_022972 | 184: NM_022971 |
| 185: NM_022970 | 186: NM_022969 | 187: NM_015850 | 188: NM_023111 |
| 189: NM_023110 | 190: NM_023109 | 191: NM_023029 | 192: NM_023108 |
| 193: NM_000141 | 194: NM_023107 | 195: NM_023106 | 196: NM_023105 |
| 197: NM_000604 | 198: AF312678 | 199: AX080371 | 200: AX080370 |
| 201: AX080369 | 202: AX080368 | 203: AX080364 | 204: NM_021923 |
| 205: NM_002011 | 206: NM_022963 | 207: NM_022965 | 208: NM_000142 |
| 209: AB021925 | 210: E30326 | 211: NM_004214 | 212: AF229254 |
| 213: AF229253 | 214: AF250392 | 215: AF250391 | 216: U69263 |
| 217: BF739878 | 218: BF739773 | 219: AL139378 | 220: AB037973 |
| 221: AB030648 | 222: NM_021032 | 223: BF221906 | 224: NM_004339 |
| 225: NM_004219 | 226: NM_000214 | 227: NM_007045 | 228: NM_004113 |
| 229: NM_005211 | 230: NM_004383 | 231: NM_000428 | 232: NM_003453 |
| 233: NM_003199 | 234: NM_002660 | 235: NM_001553 | 236: AJ277437 |
| 237: BF110834 | 238: BF062689 | 239: BF059273 | 240: BF058753 |
| 241: BF056554 | 242: BF002774 | 243: AK026508 | 244: BE673878 |
| 245: BE673874 | 246: BE673061 | 247: BE672701 | 248: BE672483 |
| 249: BE671952 | 250: BE671715 | 251: BE552216 | 252: BE551725 |
| 253: BE551556 | 254: BE550968 | 255: BE549662 | 256: AF238374 |
| 257: BE504886 | 258: BE502050 | 259: BE501873 | 260: AF171928 |
| 261: BE466386 | 262: BE466124 | 263: BE208220 | 264: BE207666 |
| 265: BE205845 | 266: BE350605 | 267: BE349962 | 268: BE348962 |
| 269: BE328768 | 270: BE301283 | 271: BE301278 | 272: BE221273 |
| 273: BE047232 | 274: AF239155 | 275: BE019402 | 276: BE019081 |
| 277: S81809 | 278: AW873016 | 279: AW779920 | 280: AW779255 |
| 281: AW779029 | 282: AW778975 | 283: AH003714 | 284: S41873 |
| 285: AH003713 | 286: S41870 | 287: S41845 | 288: S41355 |
| 289: AW770670 | 290: AC004416 | 291: AW662345 | 292: AU077033 |
| 293: AU076629 | 294: AF043644 | 295: AW629787 | 296: AW628470 |
| 297: AW590506 | 298: AW583780 | 299: AF233344 | 300: AF169399 |
| 301: AW571604 | 302: AW518111 | 303: AW515079 | 304: AW514184 |
| 305: AW510973 | 306: AW474533 | 307: AW474496 | 308: AF010187 |
| 309: AL096753 | 310: X68559 | 311: AW418776 | 312: AF199613 |
| 313: AF199612 | 314: AW341130 | 315: AW338831 | 316: AW338787 |
| 317: AW338133 | 318: AF202063 | 319: AW301094 | 320: AW299662 |
| 321: AF211188 | 322: AF211169 | 323: AW275471 | 324: AW273483 |
| 325: AW271784 | 326: AW271769 | 327: AW270662 | 328: AW268519 |
| 329: AW264608 | 330: AW262507 | 331: AW237589 | 332: AW237163 |
| 333: AW235776 | 334: AW196650 | 335: AW196066 | 336: AJ250952 |
| 337: AL031386 | 338: AW172838 | 339: AW167176 | 340: AW157414 |
| 341: AW151574 | 342: AW118881 | 343: AW086037 | 344: AW081195 |
| 345: AW074378 | 346: AW074098 | 347: AW073347 | 348: AW057787 |
| 349: AW052021 | 350: AW025920 | 351: AW009550 | 352: AW003200 |
| 353: AW002405 | 354: AW001782 | 355: AW000986 | 356: AI991116 |
| 357: AI989589 | 358: AI989525 | 359: AI984931 | 360: AI972087 |
| 361: AI971057 | 362: AI969759 | 363: AI968746 | 364: AI962257 |
| 365: AI952845 | 366: AI937526 | 367: AI936283 | 368: AI932287 |
| 369: AI929112 | 370: AI927457 | 371: AI927348 | 372: AI927305 |
| 373: AI926324 | 374: AI924133 | 375: AI921760 | 376: AF036718 |
| 377: AF036717 | 378: AI918567 | 379: AI918460 | 380: AI915058 |
| 381: AI889594 | 382: AI887836 | 383: AI887420 | 384: AI885536 |
| 385: AI884363 | 386: AI873746 | 387: AI871363 | 388: AI871071 |
| 389: AI869111 | 390: AI868556 | 391: AI858722 | 392: AI858707 |
| 393: AI831133 | 394: AI828125 | 395: AI825718 | 396: U76381 |
| 397: AI819406 | 398: AI815637 | 399: AI814182 | 400: Y17131 |
| 401: AI811355 | 402: AI810411 | 403: AI807481 | 404: AI807060 |
| 405: AI805693 | 406: AI805484 | 407: AI804152 | 408: AI802531 |
| 409: AI801468 | 410: AI796742 | 411: AI768439 | 412: AI767738 |
| 413: AI762738 | 414: AI762110 | 415: AI762100 | 416: AI743298 |
| 417: AH007696 | 418: AF097354 | 419: AF097353 | 420: AF097352 |
| 421: AF097351 | 422: AF097350 | 423: AF097349 | 424: AF097348 |
| 425: AF097347 | 426: AF097346 | 427: AF097345 | 428: AF097344 |
| 429: AF097343 | 430: AF097342 | 431: AF097341 | 432: AF097340 |
| 433: AF097339 | 434: AF097338 | 435: AF097337 | 436: AF097336 |
| 437: AI721131 | 438: AI720427 | 439: AI708818 | 440: AI703144 |
| 441: AI702628 | 442: AI701349 | 443: AI699955 | 444: AI698883 |
| 445: AI698843 | 446: AI695161 | 447: AI694924 | 448: AI690405 |
| 449: AI689479 | 450: AI689318 | 451: AI684499 | 452: AI683268 |
| 453: AI681540 | 454: AI671094 | 455: AI670114 | 456: AB002097 |
| 457: AI659722 | 458: AI655715 | 459: AI655144 | 460: AI654503 |
| 461: AI653112 | 462: AI652947 | 463: AI651153 | 464: AI650627 |
| 465: AI640755 | 466: AI640605 | 467: AF019633 | 468: AF019632 |
| 469: AF019634 | 470: AI638490 | 471: AI638387 | 472: AI638356 |
| 473: AI638328 | 474: AI638209 | 475: AI630825 | 476: AI628825 |
| 477: AI624745 | 478: AI624729 | 479: AI621022 | 480: AI608828 |
| 481: AI598047 | 482: AI587337 | 483: AI583394 | 484: AI572541 |
| 485: AF108756 | 486: AI560207 | 487: AI559529 | 488: X14071 |
| 489: X14073 | 490: X14072 | 491: Y18046 | 492: AI539845 |
| 493: AI538706 | 494: AI521743 | 495: AI493472 | 496: AI493152 |
| 497: AI500404 | 498: AI500276 | 499: AI498743 | 500: AI480167 |
| 501: Y13468 | 502: AF100144 | 503: AF100143 | 504: AI474895 |
| 505: AI474284 | 506: AI472373 | 507: AI459892 | 508: AI436212 |
| 509: AI433806 | 510: AI433805 | 511: AI423809 | 512: AI423808 |
| 513: AI422168 | 514: AI421090 | 515: AI374640 | 516: AI369615 |
| 517: AI368565 | 518: AI367719 | 519: AI360211 | 520: AI341373 |
| 521: AI341329 | 522: AI338128 | 523: AI143675 | 524: AI140801 |
| 525: S82438 | 526: S76658 | 527: S47380 | 528: AI400425 |
| 529: AI400423 | 530: AI264866 | 531: AI263615 | 532: AI263602 |
| 533: AI263355 | 534: AI306634 | 535: AI302760 | 536: AI266466 |
| 537: AI266461 | 538: AI292351 | 539: AI290617 | 540: AI273321 |
| 541: AI261528 | 542: AI245969 | 543: AI245767 | 544: AI379638 |
| 545: AI379298 | 546: AI379172 | 547: AI378807 | 548: AI377468 |
| 549: AI369220 | 550: AA889062 | 551: AA843793 | 552: AI343936 |
| 553: AA774439 | 554: AA772399 | 555: AA772398 | 556: AA772257 |
| 557: AI341894 | 558: AI336070 | 559: AI332806 | 560: AI284647 |
| 561: AI275235 | 562: AI274671 | 563: AI247085 | 564: AI270451 |
| 565: AI199217 | 566: AI218552 | 567: AI217705 | 568: AB016517 |
| 569: X04431 | 570: AI083781 | 571: AA985469 | 572: AI244735 |
| 573: AI219687 | 574: AI192569 | 575: AI185500 | 576: AI192433 |
| 577: AI188214 | 578: AI126344 | 579: AI127918 | 580: AI143063 |
| 581: AI142488 | 582: AI168407 | 583: AI167998 | 584: AI146896 |
| 585: AI146864 | 586: AA975393 | 587: AI199931 | 588: AI189158 |
| 589: AI186077 | 590: U73663 | 591: U73662 | 592: U73661 |
| 593: U73660 | 594: AI092048 | 595: AI092260 | 596: AF075292 |
| 597: AI087269 | 598: AI087201 | 599: AI087119 | 600: AI086966 |
| 601: AI086936 | 602: AI086833 | 603: AI086748 | 604: AI086711 |
| 605: AI086679 | 606: AI086487 | 607: AI084796 | 608: AI084737 |
| 609: AI084723 | 610: AI083989 | 611: AI082070 | 612: AI080060 |
| 613: AI079867 | 614: AI079236 | 615: AI079226 | 616: AI076759 |
| 617: AI076491 | 618: AI074202 | 619: AI074048 | 620: AI057095 |
| 621: AI052395 | 622: AI052337 | 623: AI052334 | 624: AI142967 |
| 625: AJ224901 | 626: AI095303 | 627: AI094703 | 628: AI085184 |
| 629: AI085149 | 630: AI081876 | 631: AI077609 | 632: AI075639 |
| 633: AI074992 | 634: AI074925 | 635: AI073629 | 636: AI042137 |
| 637: AI041763 | 638: AI039864 | 639: AI038887 | 640: AI037989 |
| 641: AA939239 | 642: U77720 | 643: U77914 | 644: AH006649 |
| 645: U47011 | 646: U47010 | 647: U47009 | 648: L49241 |
| 649: L49240 | 650: L49239 | 651: L49238 | 652: L49242 |
| 653: L49237 | 654: AF062639 | 655: L78738 | 656: L78737 |
| 657: L78736 | 658: L78735 | 659: L78734 | 660: L78733 |
| 661: L78732 | 662: L78731 | 663: L78730 | 664: L78729 |
| 665: L78728 | 666: L78727 | 667: L78726 | 668: L78725 |
| 669: L78724 | 670: L78723 | 671: L78722 | 672: L78721 |
| 673: L78720 | 674: L25647 | 675: AC005592 | 676: AI085805 |
| 677: AI023180 | 678: AI022940 | 679: AI073906 | 680: AI017114 |
| 681: AI005377 | 682: AI005374 | 683: AI004492 | 684: AA993569 |
| 685: AI086867 | 686: AI086860 | 687: AI085968 | 688: AI080594 |
| 689: AI078769 | 690: AI074256 | 691: AI066663 | 692: AB007422 |
| 693: AI052335 | 694: AI050058 | 695: AI049904 | 696: AF054828 |
| 697: AA939114 | 698: AA932095 | 699: AI042628 | 700: AI041773 |
| 701: AA928957 | 702: AA973525 | 703: AA922587 | 704: AA913131 |
| 705: AA909405 | 706: AI002948 | 707: AA916549 | 708: AA913622 |
| 709: AA912389 | 710: AA905041 | 711: AA902794 | 712: AA987837 |
| 713: AA984329 | 714: AA976463 | 715: AA975827 | 716: Y13472 |
| 717: AA953586 | 718: AA873489 | 719: AA934000 | 720: AB009249 |
| 721: AA910578 | 722: AA902796 | 723: AA878913 | 724: AA878580 |
| 725: AC004449 | 726: AA191059 | 727: AA190616 | 728: AA195894 |
| 729: AA164882 | 730: AA489435 | 731: AA599664 | 732: AA621648 |
| 733: AA621439 | 734: AA608928 | 735: AB009391 | 736: AA776567 |
| 737: AA776527 | 738: Y13901 | 739: AA757478 | 740: AA738073 |
| 741: AA724695 | 742: AA731115 | 743: AA723410 | 744: AA706746 |
| 745: AA131477 | 746: AA074576 | 747: AA100216 | 748: AA083999 |
| 749: AA081728 | 750: AA070651 | 751: AA070081 | 752: AA071169 |
| 753: AA070677 | 754: AA069659 | 755: AA702307 | 756: AA687581 |
| 757: AA658115 | 758: AA678868 | 759: AA664355 | 760: AA284286 |
| 761: Y08736 | 762: AA643845 | 763: AA635556 | 764: AA426235 |
| 765: AA424505 | 766: AA424365 | 767: AA424099 | 768: AA424022 |
| 769: AA417704 | 770: AA417654 | 771: AA417586 | 772: AA419620 |
| 773: AA419611 | 774: AA419508 | 775: AA419497 | 776: AA419484 |
| 777: AA621461 | 778: D38752 | 779: AA613015 | 780: AA587307 |
| 781: AA598537 | 782: AF007878 | 783: AA574041 | 784: AA551848 |
| 785: AA514485 | 786: AA288012 | 787: AA279375 | 788: AA516449 |
| 789: AA405082 | 790: AA548551 | 791: AA236812 | 792: AA235751 |
| 793: AA235346 | 794: AA256191 | 795: AA256152 | 796: AA253505 |
| 797: AA253402 | 798: AA258618 | 799: A46444 | 800: AA133849 |
| 801: AF015910 | 802: AF006657 | 803: U67918 | 804: Y08087 |
| 805: Z69640 | 806: Z69641 | 807: AH005423 | 808: M23534 |
| 809: M23536 | 810: M23535 | 811: L03840 | 812: E05102 |
| 813: E05101 | 814: E04557 | 815: E04552 | 816: E03194 |
| 817: E03043 | 818: E02544 | 819: E02243 | 820: E02144 |
| 821: D14838 | 822: AA446994 | 823: AA446876 | 824: AA446431 |
| 825: AA446123 | 826: AA443093 | 827: AA442053 | 828: AA442030 |
| 829: AA441940 | 830: AA441920 | 831: AA411000 | 832: AA410992 |
| 833: AA411626 | 834: AA406576 | 835: AA293228 | 836: AA293012 |
| 837: AA088648 | 838: AA088248 | 839: AA039680 | 840: AA033657 |
| 841: AA032183 | 842: AA009507 | 843: AA002254 | 844: AA001295 |
| 845: AA378797 | 846: AA377626 | 847: AA376435 | 848: AA376353 |
| 849: AA376295 | 850: AA376249 | 851: AA376219 | 852: AA376130 |
| 853: AA375854 | 854: AA375922 | 855: AA375695 | 856: AA375660 |
| 857: AA375650 | 858: AA375508 | 859: AA375435 | 860: AA375356 |
| 861: AA375129 | 862: AA375326 | 863: AA375309 | 864: AA375301 |
| 865: AA375208 | 866: AA375181 | 867: AA375167 | 868: AA375088 |
| 869: AA375052 | 870: AA374874 | 871: AA374628 | 872: AA374626 |
| 873: AA374622 | 874: AA374430 | 875: AA374371 | 876: AA374364 |
| 877: AA374328 | 878: AA374263 | 879: AA374161 | 880: AA374160 |
| 881: AA374044 | 882: AA374064 | 883: AA373980 | 884: AA373990 |
| 885: AA373825 | 886: AA373734 | 887: AA373568 | 888: AA373794 |
| 889: AA373788 | 890: AA373723 | 891: AA373667 | 892: AA373713 |
| 893: AA373674 | 894: AA373617 | 895: AA373597 | 896: AA373565 |
| 897: AA373516 | 898: AA373442 | 899: AA373379 | 900: AA373369 |
| 901: AA373305 | 902: AA373315 | 903: AA373300 | 904: AA373292 |
| 905: AA373257 | 906: AA373244 | 907: AA373018 | 908: AA373233 |
| 909: AA373074 | 910: AA373041 | 911: AA372212 | 912: AA366756 |
| 913: AA361781 | 914: AA360690 | 915: AA360561 | 916: AA357573 |
| 917: AA357468 | 918: AA356426 | 919: AA356425 | 920: AA344199 |
| 921: AA341853 | 922: AA330669 | 923: AA325962 | 924: AA323790 |
| 925: AA316916 | 926: AA311070 | 927: AA309032 | 928: AA309031 |
| 929: AA304140 | 930: AA298698 | 931: AA298681 | 932: AA298593 |
| 933: AA298620 | 934: AA298617 | 935: AA298614 | 936: AA298582 |
| 937: AA298500 | 938: AA298567 | 939: AA298557 | 940: AA298550 |
| 941: AA297966 | 942: AA297637 | 943: AA297311 | 944: AA297287 |
| 945: AA297220 | 946: AA297158 | 947: Y09852 | 948: Y08092 |
| 949: Y08091 | 950: Y08090 | 951: Y08089 | 952: Y08088 |
| 953: Y08086 | 954: Y08101 | 955: Y08100 | 956: Y08099 |
| 957: Y08098 | 958: Y08097 | 959: Y08096 | 960: Y08095 |
| 961: Y08094 | 962: Y08093 | 963: AA225910 | 964: AA232084 |
| 965: AA232083 | 966: Z50197 | 967: Z50196 | 968: Z50201 |
| 969: X56191 | 970: AA039601 | 971: AA039600 | 972: A4022484 |
| 973: AA022483 | 974: N77733 | 975: N58365 | 976: U46214 |
| 977: U46213 | 978: U46212 | 979: U46211 | 980: X84939 |
| 981: Z70276 | 982: Z70275 | 983: AA169370 | 984: AA152209 |
| 985: AA152243 | 986: S82451 | 987: AA037149 | 988: AA037148 |
| 989: W51760 | 990: W25492 | 991: W25484 | 992: W25323 |
| 993: W25340 | 994: S76733 | 995: AH004637 | 996: S74129 |
| 997: S74128 | 998: S67294 | 999: S67292 | 1000: S36271 |
| 1001: S36219 | 1002: S81661 | 1003: S41878 | 1004: AH003712 |
| 1005: S41350 | 1006: AH003711 | 1007: S40851 | 1008: S40858 |
| 1009: S40853 | 1010: AA115405 | 1011: U66200 | 1012: U66199 |
| 1013: U66198 | 1014: U66197 | 1015: AH003682 | 1016: U36228 |
| 1017: U36227 | 1018: U36226 | 1019: U36225 | 1020: U36223 |
| 1021: W72842 | 1022: W68006 | 1023: W61036 | 1024: W52234 |
| 1025: W53020 | 1026: W52295 | 1027: W52176 | 1028: W47310 |
| 1029: W47603 | 1030: W47575 | 1031: W47408 | 1032: W47218 |
| 1033: W46522 | 1034: W44678 | 1035: W44677 | 1036: W44455 |
| 1037: W44341 | 1038: W45667 | 1039: W45595 | 1040: W45594 |
| 1041: W45612 | 1042: 1445557 | 1043: W44900 | 1044: W39595 |
| 1045: AA053699 | 1046: AA037285 | 1047: AA037281 | 1048: AA037338 |
| 1049: M37825 | 1050: U64791 | 1051: W31071 | 1052: W23905 |
| 1053: N95383 | 1054: W24057 | 1055: N91902 | 1056: U56978 |
| 1057: W88635 | 1058: W88553 | 1059: W87790 | 1060: U28811 |
| 1061: U49177 | 1062: U49176 | 1063: U49175 | 1064: U49174 |
| 1065: U49173 | 1066: W52380 | 1067: W52112 | 1068: X65779 |
| 1069: Z14152 | 1070: Z14151 | 1071: Z14150 | 1072: Z14149 |
| 1073: X65778 | 1074: X66945 | 1075: X64875 | 1076: X51943 |
| 1077: X57121 | 1078: X57120 | 1079: X57119 | 1080: X57122 |
| 1081: X62586 | 1082: X52833 | 1083: X52832 | 1084: X57205 |
| 1085: X51803 | 1086: X04433 | 1087: X04432 | 1088: X59065 |
| 1089: X59612 | 1090: X59932 | 1091: W49577 | 1092: W49555 |
| 1093: W49554 | 1094: A29216 | 1095: A09132 | 1096: W47595 |
| 1097: W47556 | 1098: W47051 | 1099: W45649 | 1100: W44919 |
| 1101: W39566 | 1102: W37147 | 1103: W32691 | 1104: W31180 |
| 1105: W25267 | 1106: R58184 | 1107: W17139 | 1108: W07463 |
| 1109: W05259 | 1110: Z37976 | 1111: M30494 | 1112: N98876 |
| 1113: N92237 | 1114: N91660 | 1115: N85292 | 1116: N85228 |
| 1117: N84692 | 1118: N81103 | 1119: N75511 | 1120: N67307 |
| 1121: N69800 | 1122: N68644 | 1123: N66630 | 1124: N57287 |
| 1125: N55322 | 1126: N50463 | 1127: N50410 | 1128: N22749 |
| 1129: H89352 | 1130: H89359 | 1131: H88160 | 1132: H89545 |
| 1133: H89538 | 1134: H87979 | 1135: H87878 | 1136: H87341 |
| 1137: H84447 | 1138: H83199 | 1139: H82967 | 1140: H82912 |
| 1141: H80559 | 1142: H80508 | 1143: H74055 | 1144: H73434 |
| 1145: H73493 | 1146: H62035 | 1147: T29856 | 1148: T29711 |
| 1149: T29093 | 1150: T29091 | 1151: T28903 | 1152: T28486 |
| 1153: M37722 | 1154: R93497 | 1155: R93496 | 1156: R92862 |
| 1157: R92676 | 1158: R92588 | 1159: R91444 | 1160: R85021 |
| 1161: R84974 | 1162: R83219 | 1163: H45566 | 1164: H45559 |
| 1165: H42621 | 1166: H42118 | 1167: H26048 | 1168: H23526 |
| 1169: H11702 | 1170: H03123 | 1171: R81409 | 1172: R80670 |
| 1173: R80475 | 1174: R77173 | 1175: R77151 | 1176: U22410 |
| 1177: R71604 | 1178: R70205 | 1179: R68912 | 1180: U26555 |
| 1181: R59269 | 1182: L31408 | 1183: R54610 | 1184: R54846 |
| 1185: R48871 | 1186: R38513 | 1187: U03877 | 1188: R33868 |
| 1189: R28572 | 1190: R28404 | 1191: R25381 | 1192: U16306 |
| 1193: R13671 | 1194: R10619 | 1195: R10464 | 1196: R07270 |
| 1197: R07269 | 1198: T94993 | 1199: M73240 | 1200: M73239 |
| 1201: T94939 | 1202: T89898 | 1203: T89622 | 1204: T89263 |
| 1205: T84335 | 1206: T83836 | 1207: T83672 | 1208: T83170 |
| 1209: T82019 | 1210: T71565 | 1211: M60828 | 1212: U17170 |
| 1213: J03358 | 1214: M55614 | 1215: M87843 | 1216: M34057 |
| 1217: M96956 | 1218: M30493 | 1219: J03278 | 1220: M22734 |
| 1221: M17446 | 1222: M87772 | 1223: M87771 | 1224: M87770 |
| 1225: M64347 | 1226: M80635 | 1227: T12244 | 1228: T12243 |
| 1229: L01488 | 1230: L01486 | 1231: M85289 | 1232: L02931 |
| 1233: M23086 | 1234: M23017 | 1235: M17599 | 1236: J04513 |
| 1237: L01487 | 1238: M58051 | 1239: M97193 | 1240: M27968 |
| 1241: AH002695 | 1242: M30492 | 1243: M30491 | 1244: M30490 |
| 1245: L01485 | 1246: M74028 | 1247: M60516 | 1248: AH002592 |
| 1249: M60521 | 1250: M60520 | 1251: M60515 | 1252: AH002591 |
| 1253: M60519 | 1254: M60518 | 1255: AH001553 | 1256: M63978 |
| 1257: M63977 | 1258: M63976 | 1259: M63975 | 1260: M63974 |
| 1261: M63973 | 1262: M63972 | 1263: M63971 | 1264: M34667 |
| 1265: J02814 | 1266: M21616 | 1267: M55379 | 1268: M80638 |
| 1269: M80636 | 1270: M63889 | 1271: M63888 | 1272: M63887 |
| 1273: M60485 | 1274: M34188 | 1275: M34187 | 1276: M34186 |
| 1277: M34185 | 1278: L22970 | 1279: L22969 | 1280: L22968 |
| 1281: L22967 | 1282: J02683 | 1283: M78197 | |

TABLE 8
GenBank Accession numbers of human sequence records identified
as related to nucleic acids encoding polypeptides potentially related to
numbers of human sequences identified as related to arachidonate metabolism
and/or signaling.

| | | | |
|---|---|---|---|
| 1: BC032594 | 2: NM_138318 | 3: NM_138317 | 4: NM_021161 |
| 5: NM_033311 | 6: NM_033310 | 7: NM_016611 | 8: BC029032 |
| 9: NT_008476 | 10: NT_004641 | 11: NT_033241 | 12: NT_033985 |
| 13: NT_033299 | 14: NT_010823 | 15: XM_113327 | 16: XM_115027 |
| 17: XM_165564 | 18: XM_091607 | 19: XM_034446 | 20: XM_071012 |
| 21: XM_036599 | 22: NT_033997 | 23: AJ305028 | 24: AJ305026 |
| 25: AJ305020 | 26: AJ305031 | 27: AJ305030 | 28: AJ305029 |
| 29: AJ305027 | 30: AJ305025 | 31: AJ305024 | 32: AJ305023 |
| 33: AJ305022 | 34: AJ305021 | 35: BC028174 | 36: AF468054 |
| 37: AF468053 | 38: AF468052 | 39: AF468051 | 40: NG_001072 |
| 41: NM_000775 | 42: U37143 | 43: NM_016601 | 44: AF039089 |
| 45: D12638 | 46: NM_022054 | 47: NM_001629 | 48: NM_004823 |
| 49: BI712628 | 50: BI712395 | 51: G73175 | 52: G73174 |
| 53: NM_013402 | 54: NM_023944 | 55: NM_022977 | 56: NM_004457 |
| 57: NM_004458 | 58: BF593874 | 59: BF589297 | 60: BF445948 |
| 61: NM_021628 | 62: BF435282 | 63: NM_003647 | 64: NM_001141 |
| 65: NM_000698 | 66: NM_001140 | 67: NM_001139 | 68: NM_000697 |
| 69: BF055436 | 70: BF002497 | 71: BE676451 | 72: BE676267 |
| 73: BE674834 | 74: AF221943 | 75: BE222781 | 76: BE222767 |
| 77: BE222760 | 78: AF226273 | 79: AW779220 | 80: AF247042 |
| 81: SEG_HUMCPLA | 82: D38177 | 83: D38176 | 84: AW594003 |
| 85: AW518813 | 86: AW236332 | 87: AW169993 | 88: AB019692 |
| 89: AW087663 | 90: AW082242 | 91: AW081721 | 92: AW051026 |
| 93: AW044581 | 94: AW044543 | 95: AW026639 | 96: AW007295 |
| 97: AI922141 | 98: AI913434 | 99: AI911767 | 100: AI864921 |
| 101: AI830710 | 102: AI824788 | 103: AI804734 | 104: AI802680 |
| 105: AI799008 | 106: AI798007 | 107: AI768011 | 108: AI762841 |
| 109: AI762560 | 110: AI744699 | 111: AI698814 | 112: AI696859 |
| 113: AI660644 | 114: AI598073 | 115: AI572375 | 116: AI524200 |
| 117: AI523931 | 118: AI523842 | 119: AI479105 | 120: AI439947 |
| 121: AI436362 | 122: AI423500 | 123: AI372974 | 124: AI372944 |
| 125: AI371675 | 126: AI365403 | 127: AI363782 | 128: AI361850 |
| 129: AI360992 | 130: S68587 | 131: S68588 | 132: AI401142 |
| 133: AI400783 | 134: AI393821 | 135: AI393457 | 136: AI300995 |
| 137: AI288519 | 138: AI380545 | 139: AI243470 | 140: AA897232 |
| 141: AA860302 | 142: AA724768 | 143: AI282525 | 144: AI221308 |
| 145: AI219534 | 146: AI093644 | 147: AI219535 | 148: AI186139 |
| 149: AI148820 | 150: AI128268 | 151: AI168502 | 152: AI147982 |
| 153: AI142268 | 154: AI081242 | 155: AI075284 | 156: AI056468 |
| 157: U49379 | 158: AF038461 | 159: AI125083 | 160: AI123817 |
| 161: AI033442 | 162: AI025269 | 163: AA995910 | 164: AA994068 |
| 165: AA938017 | 166: AA931760 | 167: AA972081 | 168: AA922175 |
| 169: AA975447 | 170: AA926891 | 171: AA909607 | 172: AA904880 |
| 173: AA974928 | 174: AA961104 | 175: AA903058 | 176: AA873295 |
| 177: AA904309 | 178: AA825428 | 179: AA906097 | 180: AA905982 |
| 181: AA897656 | 182: AA835927 | 183: AA834872 | 184: AA876937 |
| 185: AA829467 | 186: AA810216 | 187: AA838239 | 188: AA872924 |
| 189: AA164575 | 190: AA629604 | 191: AA814032 | 192: AA835909 |
| 193: AA810409 | 194: AA806779 | 195: AA812165 | 196: AA811395 |
| 197: AA811107 | 198: AA765334 | 199: AA804368 | 200: AA748796 |
| 201: AA748538 | 202: AA748495 | 203: AA811906 | 204: AA808006 |
| 205: AA777140 | 206: AA741244 | 207: AA760798 | 208: AA761683 |
| 209: AA767202 | 210: AA765905 | 211: AA766333 | 212: AA767516 |
| 213: AA736656 | 214: AA748855 | 215: AA745655 | 216: AA743363 |
| 217: AA721294 | 218: AA737609 | 219: AA707722 | 220: AA122247 |
| 221: AA102430 | 222: AA702824 | 223: AA665475 | 224: AA652440 |
| 225: AA649213 | 226: AA613560 | 227: AA648464 | 228: AA632217 |
| 229: AA622768 | 230: AA593628 | 231: AA587388 | 232: AA587201 |
| 233: AA593920 | 234: AA569903 | 235: AA583219 | 236: AA552491 |
| 237: AA552112 | 238: AA521143 | 239: AA259174 | 240: AA228877 |
| 241: AA515026 | 242: AA505143 | 243 AA504178 | 244: AA504177 |
| 245: AA491374 | 246: AA279070 | 247: AA280714 | 248: AA281429 |
| 249: AA281261 | 250: AA258232 | 251: AA251106 | 252: AA262146 |
| 253: AA261947 | 254: AA487554 | 255: AA487262 | 256: AA548544 |
| 257: AA479055 | 258: AA410835 | 259: AA455503 | 260: AA455502 |
| 261: AA411551 | 262: AA411550 | 263: AA411441 | 264: AA411432 |
| 265: AA401645 | 266: AA398435 | 267: AA001754 | 268: AA355365 |
| 269: AA315865 | 270: AA021259 | 271: AA020955 | 272: AA018827 |
| 273: AA019064 | 274: N78045 | 275: AA013478 | 276: W81524 |
| 277: W47166 | 278: AA054258 | 279: W31083 | 280: W74172 |
| 281: M72393 | 282: N78291 | 283: N63856 | 284: N57659 |
| 285: N47673 | 286: N47638 | 287: N33729 | 288: H81930 |
| 289: H78331 | 290: H75692 | 291: H66675 | 292: H51574 |
| 293: H50910 | 294: R99246 | 295: T29353 | 296: R91299 |
| 297: H41485 | 298: H29144 | 299: H22440 | 300: H03094 |
| 301: R53728 | 302: R52945 | 303: R39192 | 304: R26797 |
| 305: R25994 | 306: R20635 | 307: R10655 | 308: T97526 |
| 309: T97446 | 310: T97387 | 311: T97276 | 312: T90253 |
| 313: T87977 | 314: T69964 | 315: T69914 | 316: T63581 |
| 317: T63549 | 318: T62206 | 319: T62015 | 320: T57850 |
| 321: M87004 | 322: M62982 | | |

TABLE 9
GenBank Accession numbers of human sequence records identified
as related to nucleic acids encoding polypeptides potentially related to
leukotriene metabolism and/or signaling.

| | | | |
|---|---|---|---|
| 1: BC029498 | 2: NT_008438 | 3: NT_004434 | 4: NT_033258 |
| 5: XM_088569 | 6: XM_060500 | 7: XM_033240 | 8: NT_011597 |
| 9: NT_033922 | 10: NT_006932 | 11: NT_025130 | 12: NT_011281 |
| 13: NT_010164 | 14: XM_065152 | 15: XM_065151 | 16: XM_029072 |
| 17: NM_080842 | 18: AX304816 | 19: AX304815 | 20: AX304814 |
| 21: AX304812 | 22: AX304811 | 23: AX304810 | 24: AX304809 |
| 25: AX304808 | 26: AX304807 | 27: AX304806 | 28: AX304804 |
| 29: AX250331 | 30: NM_001629 | 31: AX211656 | 32: U62025 |
| 33: AF133266 | 34: AC004597 | 35: BC004545 | 36: AF279611 |
| 37: AC005336 | 38: AU100177 | 39: AU099086 | 40: NM_001082 |
| 41: NM_000896 | 42: AL137118 | 43: BF939017 | 44: AL135787 |
| 45: AF308571 | 46: BF590658 | 47: BF590373 | 48: BF438819 |
| 49: BF438176 | 50: BF223033 | 51: NM_020377 | 52: NM_019839 |
| 53: NM_005036 | 54: NM_006639 | 55: NM_004121 | 56: NM_000897 |
| 57: NM_000752 | 58: NM_000895 | 59: BF114973 | 60: BF111542 |
| 61: BF109754 | 62: AB041644 | 63: BF001557 | 64: AF254664 |
| 65: AB044402 | 66: AB008193 | 67: AB029892 | 68: BE551649 |
| 69: AB038269 | 70: AF277230 | 71: BE468252 | 72: BE467347 |
| 73: BE465656 | 74: BE464525 | 75: BE208128 | 76: U02388 |
| 77: BE206519 | 78: AF221943 | 79: BE301515 | 80: AJ278605 |
| 81: BE222208 | 82: BE222016 | 83: BE042562 | 84: BE018008 |
| 85: AW780275 | 86: AW771680 | 87: AW769807 | 88: AW768775 |
| 89: AW768774 | 90: AB015307 | 91: SEG_AB01529S | 92: AB015306 |
| 93: AB015305 | 94: AB015304 | 95: AB015303 | 96: AB015302 |
| 97: AB015301 | 98: AB015300 | 99: AB015299 | 100: AB015298 |
| 101: AB015297 | 102: AB015296 | 103: AB015295 | 104: SEG_AB002455S |
| 105: AB002461 | 106: AB002460 | 107: AB002459 | 108: AB002458 |
| 109: AB002457 | 110: AB002456 | 111: AB002462 | 112: AB002455 |
| 113: AW663477 | 114: AU076907 | 115: AW615391 | 116: AW614119 |
| 117: AW612553 | 118: AW612542 | 119: AW594576 | 120: AW572845 |
| 121: AW518470 | 122: AW513073 | 123: AW474311 | 124: AW469906 |
| 125: AW418845 | 126: AW418767 | 127: AW339795 | 128: AW302266 |
| 129: AW301707 | 130: AW301232 | 131: AW300035 | 132: AW274396 |
| 133: AW236605 | 134: AW235789 | 135: AW235300 | 136: AW183518 |
| 137: AW173557 | 138: AW089665 | 139: AW087424 | 140: AW085086 |
| 141: AW075528 | 142: AW058452 | 143: AW051945 | 144: AW024508 |
| 145: AI985846 | 146: AI971682 | 147: AI962575 | 148: AI961053 |
| 149: AI942264 | 150: AI927415 | 151: AI921942 | 152: AI887357 |
| 153: AI867323 | 154: AI865127 | 155: D12620 | 156: D12621 |
| 157: AI819899 | 158: AI819721 | 159:.AI819193 | 160: AI817081 |
| 161: AI810292 | 162: AI797155 | 163: AF119711 | 164: AI769908 |
| 165: AI769157 | 166: AI768316 | 167: AI767278 | 168: AI766909 |
| 169: AI743746 | 170: AI741766 | 171: AI697874 | 172: AI697850 |
| 173: AI696788 | 174: AI690919 | 175: AI680647 | 176: AI675321 |
| 177: AI674309 | 178: AI670926 | 179: AI658628 | 180: AI655883 |
| 181: AI654958 | 182: AI653619 | 183: AI650452 | 184: AI640249 |
| 185: AI638776 | 186: AI638615 | 187: AI637513 | 188: AI636026 |
| 189: AI635095 | 190: AI624995 | 191: AI621247 | 192: AI621085 |
| 193: AI598016 | 194: AI589108 | 195: AI582379 | 196: AI568633 |
| 197: AI567317 | 198: AI539521 | 199: AI539253 | 200: AI538292 |
| 201: AI521212 | 202: AI494342 | 203: AI498676 | 204: AI480325 |
| 205: AI478687 | 206: AI471212 | 207: AI470813 | 208: AI470397 |
| 209: AI476663 | 210: AI474060 | 211: AI458191 | 212: AI453742 |
| 213: AI434588 | 214: AI424409 | 215: AI419536 | 216: AI373285 |
| 217: AI373189 | 218: AI366863 | 219: AI203390 | 220: AI342740 |
| 221: AI299075 | 222: AI268038 | 223: AI276610 | 224: AI244788 |
| 225: AI379927 | 226: H49887 | 227: AI373191 | 228: AA868493 |
| 229: AA860804 | 230: AI254358 | 231: AI197820 | 232: AI242991 |
| 233: AI251847 | 234: AA995855 | 235: AI097442 | 236: AI159898 |
| 237: AI092835 | 238: AI051125 | 239: AI038752 | 240: AA938888 |
| 241: U77604 | 242: U50136 | 243: AH006631 | 244: U43411 |
| 245: U43410 | 246: AI129804 | 247: AI027805 | 248: AI023562 |
| 249: AI017689 | 250: AI017654 | 251: AI016629 | 252: AI015315 |
| 253: AA992816 | 254: AA977614 | 255: AA919105 | 256: AI095208 |
| 257: AI091347 | 258: AI081983 | 259: U65080 | 260: AI025313 |
| 261: AA991238 | 262: AA987920 | 263: AB002454 | 264: AC004609 |
| 265: AA857997 | 266: AA903138 | 267: AA896996 | 268: AA830693 |
| 269: AC004523 | 270: AA847890 | 271: AA227874 | 272: AA227873 |
| 273: AA857983 | 274: AA486929 | 275: AA628131 | 276: AA743405 |
| 277: AA100843 | 278: AA677046 | 279: AA703053 | 280: AA694114 |
| 281: AA649092 | 282: AA143730 | 283: AA658381 | 284: AA649335 |
| 285: AA626145 | 286: AA594870 | 287: AA582641 | 288: AA559954 |
| 289: AA534720 | 290: AA533595 | 291: AA565266 | 292: AA286910 |
| 293: AA513348 | 294: AA281397 | 295: AA465366 | 296: AA204704 |
| 297: D89079 | 298: D89078 | 299: AA452952 | 300: D49387 |
| 301: D26480 | 302: AA447884 | 303: AA443448 | 304: AA443313 |
| 305: AA411483 | 306: AA293255 | 307: AA291372 | 308: AA122237 |
| 309: AA115940 | 310: AA381256 | 311: AA381240 | 312: AA376869 |
| 313: AA375164 | 314: AA361649 | 315: AA347345 | 316: AA346986 |
| 317: AA333760 | 318: AA316671 | 319: AA314593 | 320: AA303424 |
| 321: AA298616 | 322: AA297531 | 323: AA297320 | 324: AA297314 |
| 325: AA296166 | 326: AD000091 | 327: N76885 | 328: N55276 |
| 329: AA101453 | 330: AA100471 | 331: AA135238 | 332: AA135125 |
| 333: AA011245 | 334: AA010417 | 335: W80460 | 336: W67534 |
| 337: W67533 | 338: W45520 | 339: W45533 | 340: X52195 |
| 341: R57602 | 342: N79883 | 343: N89761 | 344: N86553 |
| 345: N84188 | 346: N62977 | 347: AH003354 | 348: U27293 |
| 349: U27292 | 350: U27291 | 351: U27290 | 352: U27289 |
| 353: U27288 | 354: U27287 | 355: U27286 | 356: U27285 |
| 357: U27284 | 358: U27283 | 359: U27282 | 360: U27281 |
| 361: U27280 | 362: U27279 | 363: U27278 | 364: U27277 |
| 365: U27276 | 366: U27275 | 367: N47508 | 368: N47507 |
| 369: N46659 | 370: N46112 | 371: N46111 | 372: N40365 |
| 373: N27550 | 374: N25087 | 375: N24395 | 376: H99146 |
| 377: H98865 | 378: H98864 | 379: H65433 | 380: H95493 |
| 381: H94973 | 382: H65432 | 383: H70526 | 384: H59380 |
| 385: T29585 | 386: R86096 | 387: R83819 | 388: R83378 |
| 389: H45442 | 390: H45141 | 391: H27032 | 392: H11149 |
| 393: R73358 | 394: R43438 | 395: R43393 | 396: R41544 |
| 397: R39103 | 398: R37480 | 399: R33232 | 400: R22687 |
| 401: R17948 | 402: R15120 | 403: R14197 | 404: R11911 |
| 405: R11267 | 406: R11209 | 407: R08919 | 408: R08229 |
| 409: R02521 | 410: R00042 | 411: T98002 | 412: T85456 |
| 413: T85359 | 414: T84363 | 415: T77751 | 416: T77750 |
| 417: T58950 | 418: T58888 | 419: T55357 | 420: U11552 |
| 421: J02959 | 422: J03459 | 423: U09353 | |

TABLE 10
GenBank Accession numbers of human sequence records identified
as related to nucleic acids encoding polypeptides potentially related to
interleukin metabolism and/or signaling.

| | | | |
|---|---|---|---|
| 1: BC032474 | 2: NM_012448 | 3: NM_003152 | 4: NM_003151 |
| 5: NM_005546 | 6: NM_001570 | 7: NM_145071 | 8: NM_013324 |
| 9: NM_003153 | 10: NM_033339 | 11: NM_033338 | 12: NM_003745 |
| 13: NM_004857 | 14: AF517934 | 15: BC030975 | 16: AY090769 |
| 17: NM_144701 | 18: AF293463 | 19: AF293462 | 20: NM_000155 |
| 21: NM_019009 | 22: NM_014339 | 23: AY099265 | 24: AF461422 |
| 25: NM_012455 | 26: AF512686 | 27: BC029569 | 28: BC029273 |
| 29: BC029493 | 30: BC029121 | 31: NT_009151 | 32: NT_009781 |
| 33: NT_009506 | 34: NT_009485 | 35: NT_009458 | 36: NT_010356 |
| 37: NT_029419 | 38: NT_011176 | 39: NT_008186 | 40: NT_011104 |
| 41: NT_024115 | 42: NT_008476 | 43: NT_004861 | 44: NT_004858 |
| 45: NT_030040 | 46: NT_005986 | 47: NT_005927 | 48: NT_004636 |
| 49: NT_005883 | 50: NT_006258 | 51: NT_004391 | 52: NT_030577 |
| 53: NT_029258 | 54: NT_028054 | 55: NT_021877 | 56: NT_016354 |
| 57: NT_015169 | 58: NT_033930 | 59: NT_033983 | 60: NT_033982 |
| 61: NM_138578 | 62: NM_001191 | 63: AY071841 | 64: AY071840 |
| 65: NM_032989 | 66: NM_004322 | 67: NM_006428 | 68: NT_010591 |
| 69: NT_010552 | 70: NT_010404 | 71: NT_011512 | 72: XM_114185 |
| 73: XM_090078 | 74: XM_006447 | 75: NT_011387 | 76: NT_033899 |
| 77: NT_010718 | 78: NT_010663 | 79: NT_007592 | 80: NT_011005 |
| 81: NT_033321 | 82: NT_030889 | 83: NT_028406 | 84: NT_028405 |
| 85: NT_025965 | 86: NT_025307 | 87: XM_034304 | 88: XM_055737 |
| 89: XM_059563 | 90: XM_010533 | 91: XM_040009 | 92: XM_113270 |
| 93: XM_116140 | 94: XM_165550 | 95: NM_032556 | 96: XM_064619 |
| 97: XM_085726 | 98: XM_084856 | 99: XM_061442 | 100: XM_067380 |
| 101: XM_086576 | 102: XM_029434 | 103: XM_089078 | 104: NT_011519 |
| 105: XM_066253 | 106: XM_062004 | 107: XM_062003 | 108: XM_063176 |
| 109: XM_035511 | 110: NT_011520 | 111: XM_049427 | 112: XM_027568 |
| 113: XM_028349 | 114: XM_032349 | 115: NM_032732 | 116: XM_013114 |
| 117: XM_015989 | 118: NM_016584 | 119: NM_012219 | 120: NM_007199 |
| 121: NM_004620 | 122: NM_004515 | 123: NT_025741 | 124: NT_011651 |
| 125: NT_009799 | 126: NT_007072 | 127: XM_098435 | 128: XM_085927 |
| 129: NT_006859 | 130: NT_025133 | 131: XM_115636 | 132: NT_006788 |
| 133: NT_011288 | 134: NT_011255 | 135: XM_035638 | 136: NT_011225 |
| 137: NT_010164 | 138: NT_023195 | 139: XM_096226 | 140: NT_016864 |
| 141: NT_033965 | 142: NT_005403 | 143: NT_005337 | 144: XM_115806 |
| 145: NT_005612 | 146: NT_005229 | 147: NT_005567 | 148: XM_087367 |
| 149: NT_005034 | 150: NT_022171 | 151: XM_002686 | 152: NT_019306 |
| 153: XM_114217 | 154: XM_114220 | 155: XM_031204 | 156: XM_031221 |
| 157: XM_034808 | 158: XM_008906 | 159: XM_004011 | 160: XM_004438 |
| 161: XM_002685 | 162: AF465829 | 163: BC027733 | 164: BC028082 |
| 165: BC028221 | 166: BC027599 | 167: NM_016123 | 168: NM_138284 |
| 169: AF213987 | 170: AF445802 | 171: AJ271338 | 172: AJ242738 |
| 173: AJ242737 | 174: AF276916 | 175: AF494012 | 176: NM_004512 |
| 177: NM_014439 | 178: NM_002994 | 179: NM_016026 | 180: NM_014143 |
| 181: NM_015650 | 182: NM_014438 | 183: NM_004103 | 184: NM_001561 |
| 185: NM_004513 | 186: NM_000628 | 187: NM_000577 | 188: NM_133336 |
| 189: NM_134470 | 190: NM_033307 | 191: NM_033306 | 192: NM_002182 |
| 193: NM_000635 | 194: NM_134433 | 195: NM_003268 | 196: NM_003264 |
| 197: NM_003263 | 198: AL136852 | 199: AF242456 | 200: NM_052872 |
| 201: AY078238 | 202: AF362378 | 203: AF481335 | 204: BC024747 |
| 205: BC025691 | 206: AY079002 | 207: AC007165 | 208: AF053412 |
| 209: L37036 | 210: NM_006504 | 211: NM_130435 | 212: AF469756 |
| 213: AF469755 | 214: AF469754 | 215: NM_001225 | 216: AF190052 |
| 217: AF172150 | 218: AF172149 | 219: NM_001560 | 220: AF093065 |
| 221: U58197 | 222: U58196 | 223: BC022315 | 224: AY071830 |
| 225: AL391280 | 226: BC020739 | 227: BC020717 | 228: NM_018725 |
| 229: NM_001247 | 230: NM_080591 | 231: NM_000962 | 232: NM_000963 |
| 233: AF247608 | 234: AF247607 | 235: AF247606 | 236: AF247605 |
| 237: AF247604 | 238: AF247603 | 239: AY029413 | 240: AJ297262 |
| 241: AY064474 | 242: NM_022304 | 243: AL121878 | 244: NM_004448 |
| 245: NM_003680 | 246: NM_002051 | 247: NM_001465 | 248: NM_001806 |
| 249: AF077611 | 250: NM_030804 | 251: NM_021258 | 252: NM_018402 |
| 253: AF206696 | 254: AF230377 | 255: AF039224 | 256: NM_004926 |
| 257: AL158080 | 258: AY062931 | 259: AB017505 | 260: SEG_HUMIL3RA |
| 261: D49412 | 262: D49410 | 263: D49408 | 264: D49409 |
| 265: D49407 | 266: D49406 | 267: D49404 | 268: D49403 |
| 269: D49402 | 270: D49401 | 271: D49411 | 272: D49405 |
| 273: AF416600 | 274: NM_005755 | 275: AF054013 | 276: BC009681 |
| 277: BC015768 | 278: BC014972 | 279: NM_052962 | 280: NM_052887 |
| 281: BC016141 | 282: BC009572 | 283: AF420465 | 284: AF420464 |
| 285: AF420463 | 286: NM_004347 | 287: BC015863 | 288: AF417842 |
| 289: AF401315 | 290: AF384857 | 291: U57613 | 292: AF421855 |
| 293: AJ289235 | 294: BC015511 | 295: X78437 | 296: NM_000575 |
| 297: AF302043 | 298: AF302042 | 299: AJ277248 | 300: AY008847 |
| 301: AY008332 | 302: AY008331 | 303: AF276915 | 304: AH008153 |
| 305: AF146427 | 306: AF146426 | 307: AF172151 | 308: L41142 |
| 309: AF418271 | 310: NM_033358 | 311: NM_033357 | 312: NM_033356 |
| 313: NM_033355 | 314: NM_001228 | 315: NM_033340 | 316: NM_001227 |
| 317: BC014096 | 318: AF349574 | 319: BC013615 | 320: NM_033295 |
| 321: NM_033294 | 322: NM_033293 | 323: NM_033292 | 324: NM_001223 |
| 325: U63015 | 326: AY044641 | 327: BC013142 | 328: BC012506 |
| 329: AY040367 | 330: BC012580 | 331: BC012346 | 332: AF005485 |
| 333: AY040568 | 334: AY040567 | 335: AY040566 | 336: AF404773 |
| 337: AF402002 | 338: BC012071 | 339: BC011624 | 340: AF346607 |
| 341: NM_032977 | 342: NM_032976 | 343: NM_032974 | 344: NM_001230 |
| 345: NM_032992 | 346: NM_001226 | 347: NM_032996 | 348: NM_001229 |
| 349: NM_004346 | 350: NM_032991 | 351: BC009960 | 352: BC009745 |
| 353: BC008678 | 354: AY026753 | 355: BC007461 | 356: BC007007 |
| 357: BC001770 | 358: BC005823 | 359: BC004973 | 360: BC004348 |
| 361: BC003110 | 362: BC001903 | 363: BC000382 | 364: AF395008 |
| 365: NM_004759 | 366: NM_032960 | 367: NM_006850 | 368: AF334756 |
| 369: AF334755 | 370: NM_006134 | 371: AF390905 | 372: AF386077 |
| 373: AF385628 | 374: AF387519 | 375: AF366364 | 376: AF366363 |
| 377: AF366362 | 378: AF377331 | 379: AF372214 | 380: AF365976 |
| 381: AF380360 | 382: AL135902 | 383: AF251120 | 384: AF251119 |
| 385: AF251118 | 386: U91746 | 387: AJ293654 | 388: AJ293653 |
| 389: AJ293652 | 390: AJ293651 | 391: AJ293650 | 392: AJ293649 |
| 393: AJ293648 | 394: AJ293647 | 395: AY029171 | 396: AF361105 |
| 397: AF359939 | 398: AF353265 | 399: NM_004248 | 400: AL035252 |
| 401: NM_030751 | 402: NM_002183 | 403: NM_002186 | 404: AF295024 |
| 405: S61784 | 406: NM_000104 | 407: NM_018724 | 408: Z30175 |
| 409: NM_014432 | 410: S81601 | 411: S71404 | 412: AJ271747 |
| 413: AJ271746 | 414: AJ271745 | 415: AJ271744 | 416: AJ271741 |
| 417: AF283296 | 418: NM_016232 | 419: NM_020525 | 420: NM_012218 |
| 421: NM_004516 | 422: NM_003856 | 423: AF043337 | 424: AF228636 |
| 425: AF224266 | 426: NM_022789 | 427: AF203083 | 428: AF114158 |
| 429: AF305200 | 430: U52112 | 431: AF218727 | 432: AF218728 |
| 433: AJ277247 | 434: AF110385 | 435: AF301620 | 436: U64198 |
| 437: AF079806 | 438: NM_017416 | 439: NM_021803 | 440: NM_021798 |
| 441: AF254069 | 442: AF254067 | 443: NM_002309 | 444: NM_021571 |
| 445: NM_005699 | 446: NM_000585 | 447: NM_000586 | 448: NM_000576 |
| 449: NM_000572 | 450: NM_000564 | 451: NM_000641 | 452: NM_000640 |
| 453: NM_000600 | 454: NM_000590 | 455: NM_000584 | 456: NM_020994 |
| 457: NM_006705 | 458: NM_019618 | 459: NM_018949 | 460: NM_014271 |
| 461: NM_014443 | 462: NM_014440 | 463: NM_005565 | 464: NM_002298 |
| 465: NM_013371 | 466: NM_013278 | 467: NM_012275 | 468: NM_012099 |
| 469: NM_006664 | 470: NM_006165 | 471: NM_005535 | 472: NM_005384 |
| 473: NM_005263 | 474: NM_004590 | 475: NM_004514 | 476: NM_004633 |
| 477: NM_001569 | 478: NM_000395 | 479: NM_000206 | 480: NM_000215 |
| 481: NM_000418 | 482: NM_000417 | 483: NM_001192 | 484: NM_002852 |
| 485: NM_003954 | 486: NM_003749 | 487: NM_001557 | 488: NM_000634 |
| 489: NM_002185 | 490: NM_000880 | 491: NM_002184 | 492: NM_000565 |
| 493: NM_000879 | 494: NM_000589 | 495: NM_000588 | 496: NM_000878 |
| 497: NM_003854 | 498: NM_000877 | 499: NM_003853 | 500: NM_003855 |
| 501: NM_001562 | 502: NM_002190 | 503: NM_002189 | 504: NM_002188 |
| 505: NM_001559 | 506: NM_002187 | 507: NM_000882 | 508: NM_001558 |
| 509: NM_001504 | 510: NM_001901 | 511: U55847 | 512: AF208005 |
| 513: AF269133 | 514: AF212016 | 515: AF284436 | 516: AF284435 |
| 517: AF284434 | 518: AF286095 | 519: AF279437 | 520: AF176907 |
| 521: L07295 | 522: AJ295724 | 523: AF244575 | 524: AF242300 |
| 525: AF193840 | 526: AF193839 | 527: AF193838 | 528: AF276953 |
| 529: AF121105 | 530: AF202445 | 531: AJ271736 | 532: AF035279 |
| 533: AJ242972 | 534: AF212311 | 535: AF235038 | 536: AF216693 |
| 537: AF045606 | 538: AF039906 | 539: AF167342 | 540: AF167341 |
| 541: AF167340 | 542: AF167339 | 543: AF167338 | 544: AF167337 |
| 545: AF167336 | 546: AF167335 | 547: AF167334 | 548: AF167333 |
| 549: AH009309 | 550: AF167343 | 551: AF200496 | 552: AF200494 |
| 553: AF200492 | 554: AF030876 | 555: AB015961 | 556: AB015021 |
| 557: D82874 | 558: D31968 | 559: D16358 | 560: D14283 |
| 561: AJ251550 | 562: AJ251551 | 563: AJ251549 | 564: AF215907 |
| 565: AF181286 | 566: AF181285 | 567: AF181284 | 568: AJ272096 |
| 569: U62858 | 570: U48258 | 571: U48257 | 572: U48256 |
| 573: AF098934 | 574: AF098933 | 575: AL034343 | 576: D11086 |
| 577: AF152099 | 578: AF152098 | 579: AF177937 | 580: AF201833 |
| 581: AF201832 | 582: AF201831 | 583: AF201830 | 584: AB022176 |
| 585: U67206 | 586: AF031075 | 587: AL022314 | 588: AB010445 |
| 589: AL031575 | 590: Z72522 | 591: Z69719 | 592: AF152113 |
| 593: AC004525 | 594: AJ012835 | 595: AJ012834 | 596: AJ012833 |
| 597: AF186094 | 598: AF038163 | 599: AF029213 | 600: AF180563 |
| 601: AF180562 | 602: AF001862 | 603: AJ243874 | 604: U81379 |
| 605: AF113136 | 606: AF168416 | 607: J00264 | 608: AF017633 |
| 609: U81380 | 610: AF118452 | 611: AF005095 | 612: U58146 |
| 613: AF039904 | 614: AF039905 | 615: AF039907 | 616: S77834 |
| 617: AF077011 | 618: D64068 | 619: AB019504 | 620: X06750 |
| 621: AJ005835 | 622: X67285 | 623: AF110801 | 624: AF110800 |
| 625: AF110799 | 626: AF110798 | 627: AF110460 | 628: AF101062 |
| 629: AH007439 | 630: AF085452 | 631: AF085451 | 632: U43895 |
| 633: AF054830 | 634: S81555 | 635: L27475 | 636: AH007359 |
| 637: S77835 | 638: S71420 | 639: 551359 | 640: S71419 |
| 641: S56892 | 642: AF069543 | 643: AF083251 | 644: AF043938 |
| 645: AF017653 | 646: U94587 | 647: U93690 | 648: U74649 |
| 649: U63127 | 650: AF104230 | 651: AH007043 | 652: AF043129 |
| 653: AF043128 | 654: AF043127 | 655: AF043126 | 656: AF043125 |
| 657: AF043124 | 658: AF043123 | 659: X53093 | 660: AF077346 |
| 661: AH006906 | 662: M29053 | 663: M29052 | 664: M29051 |
| 665: M29050 | 666: M29049 | 667: M29048 | 668: S72848 |
| 669: AF035593 | 670: AF035592 | 671: U67320 | 672: U67319 |
| 673: U60521 | 674: U60519 | 675: U60520 | 676: U47686 |
| 677: U43672 | 678: U40281 | 679: U32659 | 680: U31628 |
| 681: U37449 | 682: U37448 | 683: U32674 | 684: U32672 |
| 685: U20537 | 686: U20536 | 687: U23852 | 688: U20240 |
| 689: U13700 | 690: U13699 | 691: U13698 | 692: U13697 |
| 693: L76191 | 694: M54894 | 695: AF043143 | 696: AF016261 |
| 697: L10616 | 698: L19546 | 699: AF051152 | 700: AF051151 |
| 701: U88881 | 702: U88880 | 703: U88879 | 704: U88878 |
| 705: U88540 | 706: AC005578 | 707: L39064 | 708: AF078533 |
| 709: AJ002523 | 710: AF029894 | 711: AC004763 | 712: M99412 |
| 713: AF057168 | 714: AB006537 | 715: AC004511 | 716: AF048692 |
| 717: AF050083 | 718: M98335 | 719: AF043336 | 720: AF043335 |
| 721: AF043334 | 722: AF043333 | 723: U58917 | 724: AC004039 |
| 725: AC004042 | 726: AF031167 | 727: D13720 | 728: AF039228 |
| 729: AF039227 | 730: AF039226 | 731: AF039225 | 732: D00044 |
| 733: X01586 | 734: AF026273 | 735: AF031845 | 736: AC003112 |
| 737: X97748 | 738: AF023338 | 739: AF021799 | 740: AF008556 |
| 741: X64532 | 742: X65858 | 743: Z70243 | 744: AH005384 |
| 745: U11869 | 746: U11868 | 747: U11867 | 748: U11866 |
| 749: U18373 | 750: U13738 | 751: K03122 | 752: L19593 |
| 753: L19591 | 754: Y08768 | 755: D28118 | 756: Y09908 |
| 757: U97679 | 758: U97678 | 759: U97677 | 760: U97676 |
| 761: U82972 | 762: U49065 | 763: D78260 | 764: U90652 |
| 765: U89323 | 766: X80878 | 767: X69079 | 768: X03131 |
| 769: S82692 | 770: U86214 | 771: L39063 | 772: L39062 |
| 773: Z84723 | 774: M63099 | 775: X91233 | 776: U78798 |
| 777: U32324 | 778: U32323 | 779: S81089 | 780: S79880 |
| 781: S67780 | 782: S36271 | 783: S36219 | 784: S75511 |
| 785: S75512 | 786: S75513 | 787: S75514 | 788: S75515 |
| 789: S75516 | 790: S75517 | 791: S64248 | 792: X99404 |
| 793: U70981 | 794: X94223 | 795: X94222 | 796: Z58820 |
| 797: U43185 | 798: L78780 | 799: L78779 | 800: L78778 |
| 801: L78777 | 802: L78776 | 803: L78775 | 804: L78774 |
| 805: L78773 | 806: L78770 | 807: L78760 | 808: L78754 |
| 809: L78753 | 810: L78751 | 811: L78752 | 812: L78750 |
| 813: L78746 | 814: L78745 | 815: L78744 | 816: L78743 |
| 817: L78742 | 818: U64094 | 819: X95302 | 820: U58198 |
| 821: U31120 | 822: Z14320 | 823: Z14319 | 824: Z14318 |
| 825: Z14317 | 826: Z14954 | 827: X04664 | 828: X05232 |
| 829: X62156 | 830: X63053 | 831: X63613 | 832: Z48810 |
| 833: X52430 | 834: Y00787 | 835: X13967 | 836: X65859 |
| 837: Z11686 | 838: X81851 | 839: X60787 | 840: X04602 |
| 841: X12830 | 842: X61176 | 843: X61178 | 844: X61177 |
| 845: X04688 | 846: X52425 | 847: X03138 | 848: X03137 |
| 849: X03136 | 850: X03135 | 851: X03134 | 852: X03133 |
| 853: X03132 | 854: X01057 | 855: X84348 | 856: Z38000 |
| 857: Z46595 | 858: Z38102 | 859: Z46596 | 860: Z14955 |
| 861: X16896 | 862: X59770 | 863: X02851 | 864: X65019 |
| 865: X02532 | 866: X02531 | 867: X03833 | 868: X00695 |
| 869: V00564 | 870: X77090 | 871: X58298 | 872: X53296 |
| 873: X52015 | 874: X64802 | 875: Z47277 | 876: Z47276 |
| 877: Z47275 | 878: Z47274 | 879: Z47273 | 880: Z47272 |
| 881: Z47271 | 882: Z47270 | 883: Z47269 | 884: Z47268 |
| 885: Z47267 | 886: Z47266 | 887: Z47265 | 888: Z47264 |
| 889: Z47263 | 890: Z47262 | 891: Z47261 | 892: Z47260 |
| 893: Z47259 | 894: Z47258 | 895: Z47257 | 896: Z47256 |
| 897: Z47255 | 898: Z47254 | 899: Z47253 | 900: Z47252 |
| 901: Z47251 | 902: Z47250 | 903: Z47249 | 904: Z47248 |
| 905: Z47247 | 906: Z47246 | 907: Z47245 | 908: Z47244 |
| 909: X58377 | 910: K02056 | 911: J02971 | 912: X94993 |
| 913: U41806 | 914: L08187 | 915: L77073 | 916: L77072 |
| 917: L77071 | 918: L77070 | 919: L77069 | 920: L77068 |
| 921: L77067 | 922: L77060 | 923: L77044 | 924: L77040 |
| 925: L77039 | 926: L77036 | 927: L77035 | 928: L77034 |
| 929: L77033 | 930: L77032 | 931: L77031 | 932: X73536 |
| 933: M87879 | 934: U25804 | 935: U10307 | 936: M73969 |
| 937: L49046 | 938: U16720 | 939: L48479 | 940: L48478 |
| 941: L48477 | 942: L48476 | 943: L48475 | 944: L48474 |
| 945: L48473 | 946: L48472 | 947: U14750 | 948: U28015 |
| 949: U28014 | 950: L46904 | 951: L46900 | 952: L46899 |
| 953: J03478 | 954: M15840 | 955: U25676 | 956: L43412 |
| 957: L43411 | 958: L43399 | 959: L43398 | 960: L43393 |
| 961: L43392 | 962: L43391 | 963: L43387 | 964: L43386 |
| 965: U26540 | 966: AH003109 | 967: M11065 | 968: M11066 |
| 969: M11064 | 970: M11063 | 971: M11062 | 972: M11061 |
| 973: M11060 | 974: M10322 | 975: M87507 | 976: L42104 |
| 977: L42103 | 978: L42102 | 979: L42098 | 980: L42097 |
| 981: L42096 | 982: L42095 | 983: L42094 | 984: L42091 |
| 985: L42090 | 986: L42089 | 987: L42088 | 988: L42087 |
| 989: L42086 | 990: L42085 | 991: L42080 | 992: L42079 |
| 993: L42078 | 994: U13737 | 995: U11878 | 996: U11877 |
| 997: U11876 | 998: U11875 | 999: U11874 | 1000: U11873 |
| 1001: U11872 | 1002: U11871 | 1003: U11870 | 1004: J02923 |
| 1005: M57627 | 1006: M91557 | 1007: L19592 | 1008: M94654 |
| 1009: M15864 | 1010: M86593 | 1011: M97502 | 1012: M68932 |
| 1013: M28130 | 1014: AH002843 | 1015: L12183 | 1016: L12182 |
| 1017: L12181 | 1018: L12180 | 1019: L12179 | 1020: L12177 |
| 1021: L12176 | 1022: L12178 | 1023: M29696 | 1024: J04156 |
| 1025: M29150 | 1026: M22111 | 1027: M96652 | 1028: M96651 |
| 1029: M23442 | 1030: M13982 | 1031: M60870 | 1032: M74782 |
| 1033: M20137 | 1034: M14743 | 1035: M16285 | 1036: M26062 |
| 1037: M32979 | 1038: M14098 | 1039: M13879 | 1040: M22005 |
| 1041: AH002842 | 1042: M33198 | 1043: M33199 | 1044: M97748 |
| 1045: M55646 | 1046: M27492 | 1047: M54933 | 1048: M15330 |
| 1049: M28983 | 1050: M15329 | 1051: M81890 | 1052: M57765 |
| 1053: U13022 | 1054: U13021 | 1055: M84747 | 1056: L05921 |
| 1057: U16031 | 1058: U06844 | 1059: M18403 | 1060: J03049 |
| 1061: M14584 | 1062: M75914 | 1063: M94582 | 1064: L09701 |
| 1065: M13784 | 1066: L13029 | 1067: L06801 | 1068: K02770 |
| 1069: L07488 | 1070: M17115 | 1071: M65272 | 1072: M65271 |
| 1073: U14407 | 1074: U10324 | 1075: U10323 | 1076: U03688 |
| 1077: U00672 | 1078: U08191 | | |

TABLE 11
GenBank Accession numbers of human sequence records identified
as related to nucleic acids encoding polypeptides potentially related to G-
protein-coupled receptors metabolism and/or signaling.

| | | | |
|---|---|---|---|
| 1: AX429467 | 2: AX429465 | 3: AX427634 | 4: NM_021634 |
| 5: AX417288 | 6: AX417287 | 7: AX417286 | 8: AX417285 |
| 9: AX417284 | 10: AX417283 | 11: AX417281 | 12: AX417279 |
| 13: NM_144766 | 14: NM_002927 | 15: NM_013936 | 16: AX411685 |
| 17: AX411548 | 18: AX411478 | 19: AX411477 | 20: AX411476 |
| 21: AX411475 | 22: AX411474 | 23: AX411473 | 24: AX411472 |
| 25: AX411471 | 26: AX411470 | 27: AX411469 | 28: AX411468 |
| 29: AX411467 | 30: AX411464 | 31: AX407143 | 32: AX407142 |
| 33: AX407139 | 34: AX404911 | 35: NM_144773 | 36: BC030948 |
| 37: NM_002921 | 38: AF369708 | 39: AF232905 | 40: L12116 |
| 41: NM_032554 | 42: NM_004054 | 43: NM_005300 | 44: NM_054021 |
| 45: AX399470 | 46: AX399466 | 47: NM_139201 | 48: NM_057170 |
| 49: NM_057169 | 50: NM_014776 | 51: NM_139209 | 52: NM_017572 |
| 53: NM_013345 | 54: NM_006564 | 55: NM_004778 | 56: D17516 |
| 57: D13168 | 58: D13167 | 59: D13166 | 60: D13165 |
| 61: D13164 | 62: D13163 | 63: D13162 | 64: D11151 |
| 65: D11150 | 66: D11149 | 67: D11148 | 68: D11147 |
| 69: D11146 | 70: D11145 | 71: D11144 | 72: AF385432 |
| 73: AF385431 | 74: AB083632 | 75: AB083631 | 76: AB083630 |
| 77: AB083629 | 78: AB083628 | 79: AB083627 | 80: AB083626 |
| 81: AB083625 | 82: AB083624 | 83: AB083623 | 84: AB083622 |
| 85: AB083621 | 86: AB083620 | 87: AB083619 | 88: AB083618 |
| 89: AB083617 | 90: AB083616 | 91: AB083615 | 92: AB083614 |
| 93: AB083613 | 94: AB083612 | 95: AB083611 | 96: AB083610 |
| 97: AB083609 | 98: AB083608 | 99: AB083607 | 100: AB083606 |
| 101: AB083605 | 102: AB083604 | 103: AB083603 | 104: AB083602 |
| 105: AB083601 | 106: AB083600 | 107: AB083599 | 108: AB083598 |
| 109: AB083597 | 110: AB083596 | 111: AB083595 | 112: AB083594 |
| 113: AB083593 | 114: AB083592 | 115: AB083591 | 116: AB083590 |
| 117: AB083589 | 118: AB083588 | 119: AB083587 | 120: AB083586 |
| 121: AB083585 | 122: AB083584 | 123: AB083583 | 124: AX395171 |
| 125: AX395169 | 126: NM_018485 | 127: BC030147 | 128: BC029363 |
| 129: NT_009368 | 130: NT_009307 | 131: NT_009770 | 132: NT_009731 |
| 133: NT_009714 | 134: NT_030828 | 135: NT_009528 | 136: NT_009485 |
| 137: NT_009464 | 138: NT_008902 | 139: NT_011176 | 140: NT_011148 |
| 141: NT_011139 | 142: NT_011109 | 143: NT_011091 | 144: NT_024064 |
| 145: NT_030032 | 146: NT_023868 | 147: NT_008438 | 148: NT_004858 |
| 149: NT_019483 | 150: NT_004836 | 151: NT_004668 | 152: NT_004612 |
| 153: NT_005849 | 154: NT_005832 | 155: NT_005825 | 156: NT_006302 |
| 157: NT_004434 | 158: NT_006216 | 159: NT_004350 | 160: NT_005527 |
| 161: NT_004308 | 162: NT_006081 | 163: NT_006051 | 164: NT_025667 |
| 165: NT_028053 | 166: NT_026943 | 167: NT_022411 | 168: NT_033903 |
| 169: NT_033902 | 170: NT_033900 | 171: NT_022454 | 172: NT_022740 |
| 173: AY089976 | 174: 20143796 | 175: 20142348 | 176: NM_078473 |
| 177: NM_031940 | 178: NM_032027 | 179: NM_007264 | 180: AC008115 |
| 181: NM_003717 | 182: NT_024812 | 183: XM_115412 | 184: NT_024776 |
| 185: XM_064062 | 186: XM_165649 | 187: NT_010393 | 188: XM_061650 |
| 189: XM_089844 | 190: XM_045812 | 191: XM_085672 | 192: XM_089954 |
| 193: XM_089955 | 194: NT_011333 | 195: NT_033302 | 196: XM_115586 |
| 197: NT_010672 | 198: NT_007592 | 199: XM_167160 | 200: XM_167080 |
| 201: XM_167214 | 202: XM_167129 | 203: NT_033363 | 204: NT_009702 |
| 205: XM_115948 | 206: XM_114696 | 207: XM_090428 | 208: NT_033340 |
| 209: XM_166070 | 210: NT_033321 | 211: NT_009563 | 212: NT_028405 |
| 213: NT_007422 | 214: XM_090326 | 215: XM_015921 | 216: NT_011793 |
| 217: NT_011786 | 218: NT_033944 | 219: XM_061555 | 220: XM_005969 |
| 221: XM_085864 | 222: XM_085103 | 223: XM_070357 | 224: XM_097508 |
| 225: XM_067593 | 226: XM_003091 | 227: XM_001499 | 228: XM_068013 |
| 229: XM_093332 | 230: XM_115096 | 231: XM_115095 | 232: XM_115094 |
| 233: XM_115082 | 234: XM_115600 | 235: XM_116729 | 236: XM_166794 |
| 237: XM_166195 | 238: XM_113529 | 239: XM_116678 | 240: XM_116151 |
| 241: XM_116127 | 242: XM_113420 | 243: XM_116279 | 244: XM_114092 |
| 245: XM_057872 | 246: XM_115966 | 247: NM_138964 | 248: NM_130806 |
| 249: NM_031936 | 250: XM_045532 | 251: XM_006549 | 252: XM_089843 |
| 253: XM_060898 | 254: XM_010608 | 255: XM_086232 | 256: NM_080818 |
| 257: XM_066873 | 258: XM_066104 | 259: XM_064958 | 260: XM_064909 |
| 261: XM_064908 | 262: XM_047911 | 263: XM_062248 | 264: NT_030871 |
| 265: XM_064220 | 266: XM_068231 | 267: XM_060177 | 268: XM_057984 |
| 269: NT_011520 | 270: NM_020960 | 271: XM_001907 | 272: XM_009140 |
| 273: XM_001543 | 274: NM_020400 | 275: NM_013308 | 276: NM_006056 |
| 277: NM_004767 | 278: NT_011719 | 279: NT_011669 | 280: NT_025741 |
| 281: NT_009799 | 282: NT_033922 | 283: NT_019424 | 284: NT_024524 |
| 285: NT_006859 | 286: NT_009984 | 287: NT_011296 | 288: NT_011295 |
| 289: NT_011294 | 290: NT_009952 | 291: NT_011277 | 292: XM_044591 |
| 293: NT_011268 | 294: NT_011258 | 295: NM_000710 | 296: NT_026437 |
| 297: NT_007968 | 298: NT_007933 | 299: NT_010164 | 300: NT_028179 |
| 301: XM_057299 | 302: NT_023085 | 303: NT_029366 | 304: NT_005472 |
| 305: NT_005403 | 306: NT_005370 | 307: NT_005367 | 308: NT_005612 |
| 309: XM_067401 | 310: NT_005204 | 311: NT_005151 | 312: XM_115784 |
| 313: XM_051522 | 314: NT_005079 | 315: NT_005034 | 316: XM_115750 |
| 317: NT_022140 | 318: XM_115681 | 319: XM_116850 | 320: XM_092364 |
| 321: XM_007392 | 322: XM_018505 | 323: XM_096288 | 324: XM_092406 |
| 325: XM_086954 | 326: XM_066655 | 327: XM_062863 | 328: XM_066605 |
| 329: XM_063192 | 330: XM_033082 | 331: XM_068829 | 332: NM_053278 |
| 333: XM_057250 | 334: XM_003736 | 335: XM_046588 | 336: XM_033529 |
| 337: XM_010228 | 338: XM_002624 | 339: NM_680819 | 340: NM_080817 |
| 341: NM_030784 | 342: AF502962 | 343: NM_005302 | 344: BC028163 |
| 345: BC027597 | 346: AF498922 | 347: AF498919 | 348: AF498918 |
| 349: AF498917 | 350: AF498916 | 351: AF498915 | 352: NM_002054 |
| 353: AF502281 | 354: NG_001272 | 355: NG_001217 | 356: NG_001132 |
| 357: NG_001131 | 358: AF498961 | 359: AF498921 | 360: AF498920 |
| 361: AF458154 | 362: AF458153 | 363: AF458152 | 364: AF458151 |
| 365: AF458150 | 366: AF458149 | 367: AH011576 | 368: NM_005458 |
| 369: BC026357 | 370: NM_018969 | 371: NM_007227 | 372: NM_005682 |
| 371: NM_030774 | 374: NM_018697 | 375: NM_001337 | 376: NM_032119 |
| 377: AF293323 | 378: AF293322 | 379: AH011557 | 380: AX393069 |
| 381: AX392789 | 382: AX385030 | 383: AX391087 | 384: AX391083 |
| 385: AX385042 | 386: AX385040 | 387: AX385037 | 388: AX385035 |
| 389: AX385032 | 390: AX385027 | 391: AX384675 | 392: AX384666 |
| 393: AX384665 | 394: AX384664 | 395: AX384663 | 396: AX384661 |
| 397: AX384211 | 398: AX384210 | 399: AX384209 | 400: AX384207 |
| 401: AX379474 | 402: AX379473 | 403: AX379472 | 404: AX379470 |
| 405: AX379468 | 406: AX378810 | 407: AX378806 | 408: AX378804 |
| 409: AX378802 | 410: AC078860 | 411: BC025695 | 412: AF474992 |
| 413: AF474991 | 414: AF474990 | 415: AF474989 | 416: AF474988 |
| 417: AF474987 | 418: AX376587 | 419: AX376585 | 420: AX376583 |
| 421: AX376581 | 422: AX376579 | 423: AX376577 | 424: AX376575 |
| 425: BI480949 | 426: AX365511 | 427: AX369353 | 428: AX369349 |
| 429: AX369310 | 430: NM_006794 | 431: AF439409 | 432: AX365515 |
| 433: AX365514 | 434: AX360197 | 435: AX360195 | 436: AX358252 |
| 437: AX357037 | 438: BM503956 | 439: NM_057159 | 440: NM_001401 |
| 441: AH003177 | 442: L31584 | 443: L31583 | 444: L31582 |
| 445: NM_054032 | 446: NM_054031 | 447: NM_054030 | 448: BD010057 |
| 449: BD010056 | 450: BD010055 | 451: BD010054 | 452: BD010053 |
| 453: BD010052 | 454: BD010051 | 455: BD010050 | 456: BD010049 |
| 457: BD010046 | 458: BD010035 | 459: BD010034 | 460: BD010028 |
| 461: BD010022 | 462: E51301 | 463: E51300 | 464: E51299 |
| 465: E51298 | 466: E51297 | 467: E51296 | 468: E50838 |
| 469: E50837 | 470: E50836 | 471: E50835 | 472: E50834 |
| 473: E50833 | 474: BD003056 | 475: E55122 | 476: E55121 |
| 477: E55120 | 478: E55119 | 479: E55118 | 480: E55117 |
| 481: E58499 | 482: E58495 | 483: E58494 | 484: E58488 |
| 485: E58485 | 486: E58484 | 487: E58479 | 488: E44151 |
| 489: E44032 | 490: AX356204 | 491: AX355996 | 492: AX355871 |
| 493: AX355868 | 494: AX355867 | 495: AX355841 | 496: AX355837 |
| 497: AX354961 | 498: AX354959 | 499: AX353651 | 500: AX353650 |
| 501: AX353649 | 502: AX353643 | 503: AX351008 | 504: AX350707 |
| 505: AX350705 | 506: AX350702 | 507: AX350701 | 508: AX350698 |
| 509: AX350697 | 510: AX350694 | 511: AX350693 | 512: AX350689 |
| 513: AX350686 | 514: AX350685 | 515: AX350683 | 516: AX350679 |
| 517: AX350675 | 518: AX350673 | 519: AX350672 | 520: AX350669 |
| 521: AX350668 | 522: AX350664 | 523: AX350663 | 524: AX350661 |
| 525: AX350659 | 526: AX350653 | 527: AX350651 | 528: AX350647 |
| 529: AX350645 | 530: AX350643 | 531: AX350641 | 532: AX350639 |
| 533: AX350637 | 534: AX350635 | 535: AX350633 | 536: AX350631 |
| 537: AX350629 | 538: AX350627 | 539: AX350625 | 540: AX350623 |
| 541: AX350374 | 542: AX350372 | 543: AX343924 | 544: AX343922 |
| 545: AX343921 | 546: AX343917 | 547: AF453828 | 548: NM_023915 |
| 549: NM_018490 | 550: NM_003667 | 551: NM_016235 | 552: NM_006055 |
| 553: BC021553 | 554: BC020752 | 555: BC020614 | 556: BC020678 |
| 557: AJ298292 | 558: AX342691 | 559: AX342465 | 560: NM_030760 |
| 561: AX339742 | 562: AX339740 | 563: AX338965 | 564: AX338964 |
| 565: AX338963 | 566: AX338960 | 567: AX338958 | 568: AX338219 |
| 569: AX338078 | 570: AX338076 | 571: AX329226 | 572: AX327312 |
| 573: AX327310 | 574: AF258342 | 575: AF435925 | 576: NM_019888 |
| 577: NM_000795 | 578: NM_016574 | 579: AY062031 | 580: AY062030 |
| 581: AX318782 | 582: AX317852 | 583: AX317850 | 584: AX317848 |
| 585: AX317846 | 586: AX317844 | 587: AX317842 | 588: AX317840 |
| 589: AX317838 | 590: AX317836 | 591: AX317834 | 592: AX317832 |
| 593: AX317830 | 594: AX317828 | 595: AX317826 | 596: AX316190 |
| 597: AX316189 | 598: NM_078474 | 599: NM_025141 | 600: NM_014286 |
| 601: AX305114 | 602: AX305113 | 603: AX305111 | 604: L78805 |
| 605: NM_032966 | 606: NM_001716 | 607: NM_004951 | 608: NM_022304 |
| 609: NM_007232 | 610: NM_005307 | 611: NM_004230 | 612: NM_001841 |
| 613: NM_025195 | 614: AF257182 | 615: NM_007369 | 616: NM_007223 |
| 617: NM_006018 | 618: AL590083 | 619: AF411117 | 620: AF411116 |
| 621: AF411115 | 622: AF411114 | 623: AF411113 | 624: AF411112 |
| 625: AF411111 | 626: AF411110 | 627: AF411109 | 628: AF411108 |
| 629: AF411107 | 630: AK056697 | 631: AK056040 | 632: AX276991 |
| 633: AX276989 | 634: AX275089 | 635: AX275088 | 636: AX275087 |
| 637: AX275085 | 638: AX275083 | 639: AX268495 | 640: AX268494 |
| 641: AX268493 | 642: AX268492 | 643: AX268491 | 644: AX268489 |
| 645: AX262404 | 646: AX262402 | 647: AX259499 | 648: AX259498 |
| 649: AX259496 | 650: AX259494 | 651: AF406692 | 652: NM_023922 |
| 653: NM_023921 | 654: NM_023920 | 655: NM_023919 | 656: NM_023918 |
| 657: NM_023917 | 658: AL445495 | 659: BM141985 | 660: NM_000675 |
| 661: AX299707 | 662: AX299705 | 663: AX299475 | 664: AX299473 |
| 665: AX298070 | 666: BM129715 | 667: BM129426 | 668: BM128329 |
| 669: AF282269 | 670: AX286290 | 671: AX286289 | 672: AX286288 |
| 673: AX286287 | 674: AX286286 | 675: AX286285 | 676: AX286284 |
| 677: AX286283 | 678: AX286282 | 679: AX286281 | 680: AX286280 |
| 681: AX286279 | 682: AX286278 | 683: AX286277 | 684: AX286276 |
| 685: AX286275 | 686: AX286274 | 687: AX286272 | 688: AX283620 |
| 689: BM091360 | 690: BM091055 | 691: AF310685 | 692: AY033942 |
| 693: BC016860 | 694: BM053023 | 695: BM052746 | 696: AX282666 |
| 697: AX282663 | 698: AX282661 | 699: AX282660 | 700: AX282659 |
| 701: AX282658 | 702: AX282656 | 703: AX282654 | 704: AX282380 |
| 705: AX282378 | 706: AX282376 | 707: AX282374 | 708: AX282372 |
| 709: AX282370 | 710: AX282369 | 711: AX282367 | 712: AX282365 |
| 713: AX282363 | 714: AX282361 | 715: AX282359 | 716: AX282357 |
| 717: AX282355 | 718: AX282353 | 719: AX282351 | 720: AX281258 |
| 721: AX281256 | 722: AX277635 | 723: NM_053036 | 724: NM_032551 |
| 725: NM_000798 | 726: NM_000794 | 727: NM_014879 | 728: NM_000797 |
| 729: BI962766 | 730: BC009540 | 731: AF055084 | 732: AX254762 |
| 733: AX254760 | 734: AX254742 | 735: AX254632 | 736: AX254348 |
| 737: AX253448 | 738: AX253256 | 739: NM_033050 | 740: NM_023914 |
| 741: NM_020370 | 742: NM_005756 | 743: AX253152 | 744: AX253150 |
| 745: AX253148 | 746: AX253146 | 747: AX252471 | 748: AX252469 |
| 749: AX252467 | 750: AX252386 | 751: AX252384 | 752: AX252382 |
| 753: AX250688 | 754: AX250685 | 755: AX250683 | 756: AX250547 |
| 757: AX250545 | 758: AX250543 | 759: AX250541 | 760: AX250539 |
| 761: AX250331 | 762: AF303576 | 763: AY008280 | 764: BI792406 |
| 765: BI789257 | 766: AX240018 | 767: AX240016 | 768: AX240014 |
| 769: AX240012 | 770: AX240010 | 771: AX240008 | 772: AX240004 |
| 773: AX240002 | 774: AX240000 | 775: AX239998 | 776: AX239996 |
| 777: AX239993 | 778: AX239991 | 779: AX239989 | 780: AX239987 |
| 781: AX239985 | 782: AX239983 | 783: AX239981 | 784: AL035542 |
| 785: NM_000024 | 786: NM_000683 | 787: NM_000682 | 788: NM_000681 |
| 789: BI715205 | 790: BI712099 | 791: AF399937 | 792: AY029541 |
| 793: AY042216 | 794: AY042215 | 795: AY042214 | 796: AY042213 |
| 797: AX235352 | 798: AX235351 | 799: AX235350 | 800: AX235348 |
| 801: AX235262 | 802: AX235260 | 803: Y11395 | 804: AX214118 |
| 805: AX214117 | 806: AX214110 | 807: AX214107 | 808: AX214105 |
| 809: AX214103 | 810: AX214101 | 811: AX214099 | 812: AX214097 |
| 813: AX214095 | 814: AX214093 | 815: AX214091 | 816: AX214089 |
| 817: AX214087 | 818: AX211539 | 819: NM_000678 | 820: NM_000679 |
| 821: NM_033304 | 822: NM_033303 | 823: NM_033302 | 824: NM_000680 |
| 825: AX208080 | 826: AX208078 | 827: AX208076 | 828: AF317654 |
| 829: AF330055 | 830: AF330053 | 831: AF190501 | 832: AF190500 |
| 833: AJ309020 | 834: BC011634 | 835: AF343725 | 836: AF380193 |
| 837: AF380192 | 838: AF380189 | 839: AF380185 | 840: BC011349 |
| 841: NM_005292 | 842: AF395806 | 843: NM_032563 | 844: BC008770 |
| 845: AF345566 | 846: AF345565 | 847: BC008094 | 848: BC004555 |
| 849: BC004925 | 850: BC003187 | 851: BC000181 | 852: BC001736 |
| 853: BC001379 | 854: BC009277 | 855: AL121581 | 856: AX167470 |
| 857: AX167242 | 858: AF279611 | 859: AX163735 | 860: AX151331 |
| 861: AX151329 | 862: AX151327 | 863: AX151325 | 864: AX151323 |
| 865: AX151321 | 866: AX151319 | 867: AX151264 | 868: AX151263 |
| 869: AX151262 | 870: AX151260 | 871: AX151258 | 872: AX151256 |
| 873: AX151254 | 874: AX151252 | 875: AX151250 | 876: AX151248 |
| 877: AX151246 | 878: AX151244 | 879: AX151242 | 880: AX151240 |
| 881: AX151238 | 882: AX151236 | 883: AX151232 | 884: AX151230 |
| 885: AX151228 | 886: AX151226 | 887: AX151224 | 888: AX151222 |
| 889: AX151220 | 890: AX151218 | 891: AX151216 | 892: U73141 |
| 893: AF236083 | 894: AX139466 | 895: AX139465 | 896: AX139463 |
| 897: AX139441 | 898: AX139440 | 899: AX139438 | 900: AX139122 |
| 901: AX139121 | 902: AX139120 | 903: AX139119 | 904: AX139118 |
| 905: AX139117 | 906: AX139116 | 907: AX139115 | 908: AX139113 |
| 909: AX139112 | 910: AX139111 | 911: AX139110 | 912: AX139109 |
| 913: AX139107 | 914: AX139103 | 915: AX138881 | 916: AX138880 |
| 917: AX138878 | 918: AX138829 | 919: AX138796 | 920: AX138589 |
| 921: AX138588 | 922: AX138586 | 923: AB051065 | 924: AF347063 |
| 925: AX135421 | 926: AX134204 | 927: AH003248 | 928: U40771 |
| 929: AB060151 | 930: NM_031409 | 931: NM_004367 | 932: AK027784 |
| 933: AK027780 | 934: AF209923 | 935: AF207989 | 936: NM_018980 |
| 937: NM_016945 | 938: AF363791 | 939: AX109244 | 940: AX109242 |
| 941: AX109240 | 942: AX109238 | 943: AX109236 | 944: AX109234 |
| 945: AX107042 | 946: AX107041 | 947: AX107037 | 948: AF329449 |
| 949: AY029324 | 950: AF346711 | 951: AF346710 | 952: AF346709 |
| 953: AH010608 | 954: NM_030968 | 955: AU100154 | 956: AU099841 |
| 957: AU099821 | 958: AU099377 | 959: AU098961 | 960: AF295368 |
| 961: AF237763 | 962: AF237762 | 963: NM_004248 | 964: AX099247 |
| 965: AF348078 | 966: NM_019599 | 967: AX088165 | 968: AX087894 |
| 969: AX087885 | 970: NM_016944 | 971: NM_016943 | 972: AB038237 |
| 973: AF178982 | 974: AF321815 | 975: AL121755 | 976: BG370235 |
| 977: U48958 | 978: AX081250 | 979: AX081248 | 980: AX081246 |
| 981: AX080495 | 982: AX077889 | 983: AF317655 | 984: AF317653 |
| 985: AF317652 | 986: AX077691 | 987: NM_022036 | 988: NM_018653 |
| 989: NM_018654 | 990: AF312230 | 991: NM_001400 | 992: AF316895 |
| 993: AX076182 | 994: NM_000916 | 995: AF316894 | 996: NM_018971 |
| 997: NM_005242 | 998: NM_016334 | 999: NM_016602 | 1000: NM_000115 |
| 1001: NM_002980 | 1002: NM_003991 | 1003: BG150191 | 1004: AX068839 |
| 1005: BG057775 | 1006: BG057661 | 1007: BF941117 | 1008: BF940605 |
| 1009: BF939693 | 1010: AF313449 | 1011: BF733007 | 1012: BF732711 |
| 1013: BF732412 | 1014: NM_003979 | 1015: AJ272138 | 1016: NM_012152 |
| 1017: AF285095 | 1018: AF285094 | 1019: AF285093 | 1020: AL137000 |
| 1021: AF268899 | 1022: AF268898 | 1023: Y19228 | 1024: Y19231 |
| 1025: Y19230 | 1026: Y19229 | 1027: AJ272207 | 1028: AF311306 |
| 1029: NM_004885 | 1030: BF594242 | 1031: BF592107 | 1032: BF591300 |
| 1033: BF588506 | 1034: AF292402 | 1035: AL096774 | 1036: AF317676 |
| 1037: BF477409 | 1038: BF476145 | 1039: NM_022049 | 1040: AF281308 |
| 1041: BF447902 | 1042: BF447858 | 1043: BF447783 | 1044: BF446953 |
| 1045: BF446952 | 1046: AF205437 | 1047: BF439382 | 1048: BF439363 |
| 1049: BF435092 | 1050: BF434415 | 1051: BF434140 | 1052: BF432690 |
| 1053: BF432379 | 1054: BF431669 | 1055: BF431528 | 1056: AX041939 |
| 1057: AX041937 | 1058: AX041935 | 1059: AX041933 | 1060: AX041931 |
| 1061: AX041929 | 1062: AX041927 | 1063: AX041925 | 1064: AX041923 |
| 1065: AJ249248 | 1066: AB042411 | 1067: AB042410 | 1068: NM_004720 |
| 1069: NM_005226 | 1070: AF307973 | 1071: NM_005508 | 1072: NM_005283 |
| 1073: BF195014 | 1074: AF197929 | 1075: AF280400 | 1076: AF280399 |
| 1077: NM_018970 | 1078: NM_018949 | 1079: NM_016568 | 1080: NM_016540 |
| 1081: NM_014030 | 1082: NM_014626 | 1083: NM_014627 | 1084: NM_014373 |
| 1085: NM_013937 | 1086: NM_013941 | 1087: NM_001992 | 1088: NM_001526 |
| 1089: NM_006583 | 1090: NM_006143 | 1091: NM_005683 | 1092: NM_005684 |
| 1093: NM_000054 | 1094: NM_005308 | 1095: NM_005286 | 1096: NM_005285 |
| 1097: NM_005284 | 1098: NM_005282 | 1099: NM_005306 | 1100: NM_005305 |
| 1101: NM_005304 | 1102: NM_005303 | 1103: NM_005281 | 1104: NM_005301 |
| 1105: NM_005299 | 1106: NM_005298 | 1107: NM_005297 | 1108: NM_005296 |
| 1109: NM_005295 | 1110: NM_005294 | 1111: NM_005293 | 1112: NM_005279 |
| 1113: NM_005291 | 1114: NM_005290 | 1115: NM_005288 | 1116: NM_005161 |
| 1117: NM_005048 | 1118: NM_004224 | 1119: NM_004246 | 1120: NM_004072 |
| 1121: NM_001525 | 1122: NM_003272 | 1123: NM_003608 | 1124: NM_003485 |
| 1125: NM_000910 | 1126: NM_000752 | 1127: NM_000868 | 1128: NM_002082 |
| 1129: NM_001504 | 1130: NM_001508 | 1131: NM_001507 | 1132: NM_001506 |
| 1133: NM_001505 | 1134: NM_000164 | 1135: NM_003775 | 1136: NM_001838 |
| 1137: NM_000674 | 1138: AB019000 | 1139: AH007076 | 1140: AF019765 |
| 1141: AF019764 | 1142: AF272363 | 1143: AF272362 | 1144: BF109118 |
| 1145: BF062418 | 1146: BF061464 | 1147: BF061085 | 1148: BF060724 |
| 1149: BF058335 | 1150: BF055267 | 1151: BF054837 | 1152: BF054680 |
| 1153: AF239668 | 1154: AF029759 | 1155: AF089087 | 1156: AF254664 |
| 1157: AK024416 | 1158: BE858655 | 1159: BE858216 | 1160: AB041228 |
| 1161: AF250237 | 1162: AX018430 | 1163: AX018429 | 1164: AX018428 |
| 1165: AX018426 | 1166: AX014744 | 1167: AX014742 | 1168: BE677821 |
| 1169: BE671344 | 1170: BE671261 | 1171: BE671257 | 1172: BE670057 |
| 1173: BE646269 | 1174: AF257210 | 1175: AF233092 | 1176: BE503731 |
| 1177: BE503724 | 1178: BE502880 | 1179: BE502852 | 1180: BE502582 |
| 1181: BE501091 | 1182: AF282693 | 1183: AF236117 | 1184: BE467925 |
| 1185: BE466690 | 1186: BE465916 | 1187: BE464797 | 1188: BE464297 |
| 1189: AL121935 | 1190: BE208338 | 1191: BE350014 | 1192: BE328133 |
| 1193: BE328109 | 1194: BE328060 | 1195: BE219456 | 1196: BE218901 |
| 1197: BE218235 | 1198: BE218140 | 1199: BE218139 | 1200: AB040801 |
| 1201: AB040800 | 1202: AB040799 | 1203: BE049570 | 1204: BE046086 |
| 1205: BE042841 | 1206: BE041936 | 1207: AF208237 | 1208: AF073924 |
| 1209: D88437 | 1210: AW873727 | 1211: AW827198 | 1212: AW779207 |
| 1213: AW771926 | 1214: AW771412 | 1215: AW770712 | 1216: AW770705 |
| 1217: AW768971 | 1218: AF202640 | 1219: AF236081 | 1220: AF030335 |
| 1221: AF215981 | 1222: AF056085 | 1223: AW665207 | 1224: AW664477 |
| 1225: AU076620 | 1226: AW631295 | 1227: AW627455 | 1228: AW614983 |
| 1229: AW613556 | 1230: AW612883 | 1231: AW612249 | 1232: AW594595 |
| 1233: AW594481 | 1234: AW590950 | 1235: AW590629 | 1236: AF227139 |
| 1237: AF227138 | 1238: AF227137 | 1239: AF227136 | 1240: AF227135 |
| 1241: AF227134 | 1242: AF227133 | 1243: AF227132 | 1244: AF227131 |
| 1245: AF227130 | 1246: AF227129 | 1247: AW583167 | 1248: AW573093 |
| 1249: AF112462 | 1250: AF112461 | 1251: AF112460 | 1252: AW515813 |
| 1253: AW468602 | 1254: AW468498 | 1255: AW467603 | 1256: AW418550 |
| 1257: X89271 | 1258: AJ243213 | 1259: AC002381 | 1260: AW339203 |
| 1261: AW338938 | 1262: AW338568 | 1263: AW316632 | 1264: AW299960 |
| 1265: AW299685 | 1266: Z86090 | 1267: AW272269 | 1268: AW271290 |
| 1269: U78723 | 1270: AC004925 | 1271: AW239400 | 1272: AW239010 |
| 1273: AW197479 | 1274: AW193726 | 1275: AW191974 | 1276: AL022171 |
| 1277: AL009181 | 1278: Z85996 | 1279: Z69387 | 1280: Z68281 |
| 1281: Z68273 | 1282: Z68192 | 1283: AW188960 | 1284: AW188400 |
| 1285: AW173257 | 1286: AW173009 | 1287: AW170317 | 1288: AW150789 |
| 1289: AW149665 | 1290: AW148557 | 1291: AF181862 | 1292: X68149 |
| 1293: AW129012 | 1294: AW128849 | 1295: AW118213 | 1296: AW102735 |
| 1297: AW087372 | 1298: AW083550 | 1299: AW083541 | 1300: AW075850 |
| 1301: AW075598 | 1302: AW075549 | 1303: AW072548 | 1304: AW071110 |
| 1305: AF140631 | 1306: AF040752 | 1307: AF040751 | 1308: AF040753 |
| 1309: AF186380 | 1310: AF147204 | 1311: AW058177 | 1312: AF127138 |
| 1313: AF104939 | 1314: AF104266 | 1315: AW051846 | 1316: AW050562 |
| 1317: AF104938 | 1318: AW024131 | 1319: AH008056 | 1320: AF129514 |
| 1321: AW004908 | 1322: AW004735 | 1323: AF101472 | 1324: AF072693 |
| 1325: AW000832 | 1326: AI990500 | 1327: AI979039 | 1328: AI969765 |
| 1329: AI969011 | 1330: AI968199 | 1331: AI968062 | 1332: AF039686 |
| 1333: AI963290 | 1334: AI962628 | 1335: AI962439 | 1336: AI952936 |
| 1337: AI951598 | 1338: AJ238044 | 1339: AF083955 | 1340: E16188 |
| 1341: E16187 | 1342: E16186 | 1343: E14219 | 1344: E14218 |
| 1345: E14217 | 1346: AI937602 | 1347: AI936826 | 1348: AI936528 |
| 1349: AI934968 | 1350: AI929343 | 1351: AI921242 | 1352: AI920946 |
| 1353: AI910975 | 1354: AI890025 | 1355: AI889324 | 1356: AI884686 |
| 1357: AI884548 | 1358: AH005868 | 1359: AF044601 | 1360: AF044600 |
| 1361: AI870119 | 1362: AI869176 | 1363: AI867390 | 1364: AI866909 |
| 1365: AI864743 | 1366: AI861901 | 1367: AF153500 | 1368: AI859538 |
| 1369: AI858943 | 1370: AI857339 | 1371: AI831861 | 1372: AI830135 |
| 1373: AI817194 | 1374: X13556 | 1375: AI807566 | 1376: AI801319 |
| 1377: AI798928 | 1378: AI796432 | 1379: AF119711 | 1380: AI767062 |
| 1381: AI765236 | 1382: AI762692 | 1383: AI745026 | 1384: AI743546 |
| 1385: AI742092 | 1386: AI740732 | 1387: AI738477 | 1388: AF145207 |
| 1389: AI719098 | 1390: AI703458 | 1391: AI703188 | 1392: AI700112 |
| 1393: AI699236 | 1394: AI698562 | 1395: AI697249 | 1396: AI697103 |
| 1397: AI696158 | 1398: AI695339 | 1399: AI694940 | 1400: AI693678 |
| 1401: AI692576 | 1402: AF144308 | 1403: AI683322 | 1404: AI682902 |
| 1405: AI682706 | 1406: AI681718 | 1407: AI678669 | 1408: AI675038 |
| 1409: AI672910 | 1410: AI672677 | 1411: AI672434 | 1412: AI670734 |
| 1413: AF106858 | 1414: AI660355 | 1415: AI659965 | 1416: AI659657 |
| 1417: AI656746 | 1418: AI655538 | 1419: AI653213 | 1420: AI640447 |
| 1421: AI640213 | 1422: AI636061 | 1423: AI611298 | 1424: AI610565 |
| 1425: AF069755 | 1426: AI583169 | 1427: AI583146 | 1428: AI582682 |
| 1429: AI581657 | 1430: AF058762 | 1431: AF096786 | 1432: AF096785 |
| 1433: AF096784 | 1434: AI568975 | 1435: AF119815 | 1436: AI566829 |
| 1437: AC007136 | 1438: AF118266 | 1439: AF118265 | 1440: AI524429 |
| 1441: AI524007 | 1442: AF118670 | 1443: AI493618 | 1444: AI498729 |
| 1445: X97881 | 1446: X97880 | 1447: X97879 | 1448: AF105367 |
| 1449: AI470243 | 1450: AI470241 | 1451: AI470231 | 1452: AI468820 |
| 1453: AI476811 | 1454: AI473656 | 1455: AI457930 | 1456: AI439188 |
| 1457: AI434652 | 1458: AI422268 | 1459: AI370816 | 1460: AI368913 |
| 1461: AI359560 | 1462: AI358974 | 1463: AI358446 | 1464: AI355648 |
| 1465: AI308145 | 1466: AI338666 | 1467: AI338653 | 1468: AI123732 |
| 1469: U68031 | 1470: AI417609 | 1471: AI417456 | 1472: AI417427 |
| 1473: AI253178 | 1474: AI249788 | 1475: AI348152 | 1476: AI344724 |
| 1477: AI344626 | 1478: AI300807 | 1479: AI300764 | 1480: AI289854 |
| 1481: AI292165 | 1482: AI290226 | 1483: AI268995 | 1484: AI379767 |
| 1485: AI379745 | 1486: AI376916 | 1487: AI284206 | 1488: AI263529 |
| 1489: AI240328 | 1490: AI375269 | 1491: AF080586 | 1492: AA694447 |
| 1493: AF074483 | 1494: AA890050 | 1495: AA883367 | 1496: AF106941 |
| 1497: AI346265 | 1498: AA844623 | 1499: AA781110 | 1500: AA772427 |
| 1501: AF034780 | 1502: AI342261 | 1503: AI337353 | 1504: AI334621 |
| 1505: AI334042 | 1506: AF099148 | 1507: AF095448 | 1508: AC006132 |
| 1509: AI249966 | 1510: AI243295 | 1511: AH007062 | 1512: U90660 |
| 1513: U90659 | 1514: U90658 | 1515: AI243951 | 1516: AI239970 |
| 1517: AI218191 | 1518: AI215993 | 1519: AI208357 | 1520: Y12476 |
| 1521: AJ000479 | 1522: Y12477 | 1523: AF061444 | 1524: AI002547 |
| 1525: AI193140 | 1526: AI192675 | 1527: AI138606 | 1528: AI126520 |
| 1529: AI161367 | 1530: AI160744 | 1531: AI159856 | 1532: AI143180 |
| 1533: AI148328 | 1534: AI167285 | 1535: AF091890 | 1536: AI050884 |
| 1537: AI041787 | 1538: AF032132 | 1539: AF027957 | 1540: AF027956 |
| 1541: AF022137 | 1542: AF002986 | 1543: AF015257 | 1544: U83326 |
| 1545: AF012270 | 1546: U65402 | 1547: U94320 | 1548: U66581 |
| 1549: U66580 | 1550: U66579 | 1551: U66578 | 1552: U79527 |
| 1553: U79526 | 1554: U77827 | 1555: U68032 | 1556: U68030 |
| 1557: AH006663 | 1558: U50146 | 1559: U66275 | 1560: U62027 |
| 1561: U48405 | 1562: AH006647 | 1563: U47129 | 1564: U47128 |
| 1565: U47127 | 1566: U47126 | 1567: U34806 | 1568: U25341 |
| 1569: U28488 | 1570: U40223 | 1571: U32672 | 1572: AH006630 |
| 1573: U33168 | 1574: U33167 | 1575: U33166 | 1576: U33165 |
| 1577: U33164 | 1578: U33163 | 1579: U33162 | 1580: U33161 |
| 1581: U33160 | 1582: U33159 | 1583: U33158 | 1584: U33157 |
| 1585: U33156 | 1586: U33155 | 1587: U33154 | 1588: U33153 |
| 1589: U33056 | 1590: U33055 | 1591: U33054 | 1592: U22492 |
| 1593: U22491 | 1594: U31332 | 1595: U31099 | 1596: U31098 |
| 1597: U25128 | 1598: L40764 | 1599: AF045767 | 1600: AF045765 |
| 1601: AF045764 | 1602: AF027826 | 1603: AF041245 | 1604: AF041243 |
| 1605: AF073799 | 1606: D10202 | 1607: Y12546 | 1608: AI050992 |
| 1609: AI051919 | 1610: AI051863 | 1611: AI022030 | 1612: Z94155 |
| 1613: Z94154 | 1614: AF086432 | 1615: AI017452 | 1616: AA994898 |
| 1617: AA992531 | 1618: AA936395 | 1619: AI097347 | 1620: AI077789 |
| 1621: AF080214 | 1622: AF062006 | 1623: AF011466 | 1624: AI032237 |
| 1625: AI032226 | 1626: AA989434 | 1627: AF034633 | 1628: AF034632 |
| 1629: AI050023 | 1630: AA970139 | 1631: AA935899 | 1632: AA935648 |
| 1633: AA934643 | 1634: E12487 | 1635: E12484 | 1636: AA953688 |
| 1637: AA931357 | 1638: AA923762 | 1639: AA933596 | 1640: Y14838 |
| 1641: AA927880 | 1642: AA834277 | 1643: AA825595 | 1644: AF067733 |
| 1645: AA905915 | 1646: AA863264 | 1647: AA862435 | 1648: U71092 |
| 1649: AA857647 | 1650: Y16280 | 1651: AA834537 | 1652: AA826204 |
| 1653: AA808103 | 1654: AA829514 | 1655: AA883661 | 1656: AA836111 |
| 1657: AA836067 | 1658: AA832466 | 1659: AA824607 | 1660: AA205847 |
| 1661: AA197280 | 1662: AA181641 | 1663: AA634862 | 1664: AA634211 |
| 1665: AA451915 | 1666: AA827835 | 1667: AA804628 | 1668: AA811093 |
| 1669: AA760743 | 1670: AA748438 | 1671: AA804282 | 1672: AA779703 |
| 1673: AA780337 | 1674: AA731086 | 1675: AA744637 | 1676: AA760855 |
| 1677: AA769730 | 1678: AA768086 | 1679: U78192 | 1680: Z73157 |
| 1681: AA773241 | 1682: AA747545 | 1683: AA743645 | 1684: AA743379 |
| 1685: Y10530 | 1686: Y10529 | 1687: AA713608 | 1688: AA732228 |
| 1689: AF014826 | 1690: AA707668 | 1691: AA705077 | 1692: AA112062 |
| 1693: AA083607 | 1694: AH005747 | 1695: U15790 | 1696: U15789 |
| 1697: U15788 | 1698: U15787 | 1699: U15786 | 1700: U15785 |
| 1701: U14911 | 1702: AA661523 | 1703: AF007171 | 1704: U63917 |
| 1705: Y13583 | 1706: AF024690 | 1707: AF024689 | 1708: AF024688 |
| 1709: AF024687 | 1710: AA421523 | 1711: AA421558 | 1712: AA417176 |
| 1713: AA610463 | 1714: AA650037 | 1715: AF025375 | 1716: AA621854 |
| 1717: AA634201 | 1718: AA630455 | 1719: AA426566 | 1720: AA426644 |
| 1721: AA424850 | 1722: AA419064 | 1723: AA583854 | 1724: AF017263 |
| 1725: AF017264 | 1726: AF017262 | 1727: AA576017 | 1728: AA554406 |
| 1729: AC002511 | 1730: AA573161 | 1731: AA534523 | 1732: AA259199 |
| 1733: AA225739 | 1734: AA507254 | 1735: AA502605 | 1736: AA501992 |
| 1737: AA490436 | 1738: AA490329 | 1739: AA558023 | 1740: AA479467 |
| 1741: AA479357 | 1742: AA477030 | 1743: AA476919 | 1744: AA284569 |
| 1745: AA284857 | 1746: L42324 | 1747: AA148292 | 1748: AA148291 |
| 1749: AA523398 | 1750: AA059452 | 1751: AA059451 | 1752: AF007545 |
| 1753: Z79783 | 1754: AF004021 | 1755: U45984 | 1756: AF000546 |
| 1757: U90322 | 1758: U90323 | 1759: U45983 | 1760: X65857 |
| 1761: X65858 | 1762: AC002306 | 1763: U73531 | 1764: U73530 |
| 1765: U73529 | 1766: D89079 | 1767: D89078 | 1768: AH005415 |
| 1769: U48231 | 1770: U18550 | 1771: D38449 | 1772: Y09479 |
| 1773: AA436258 | 1774: AA194811 | 1775: AA194998 | 1776: X95876 |
| 1777: AF000545 | 1778: AA411265 | 1779: AA137186 | 1780: AA137185 |
| 1781: AA129610 | 1782: AA129609 | 1783: AA121357 | 1784: AA121265 |
| 1785: AA099858 | 1786: AA099323 | 1787: AA058812 | 1788: AA045235 |
| 1789: AA037526 | 1790: AA037376 | 1791: AA036907 | 1792: AA036853 |
| 1793: X98510 | 1794: AA314786 | 1795: AA298791 | 1796: AA297171 |
| 1797: U91939 | 1798: U64871 | 1799: U34038 | 1800: X70070 |
| 1801: AA193392 | 1802: N58609 | 1803: N54441 | 1804: U49516 |
| 1805: X98118 | 1806: X83864 | 1807: X70812 | 1808: AA127402 |
| 1809: AA127401 | 1810: X69680 | 1811: S45489 | 1812: Z79784 |
| 1813: Z79782 | 1814: U73304 | 1815: X98356 | 1816: W79920 |
| 1817: W77864 | 1818: W72081 | 1819: W73685 | 1820: U67784 |
| 1821: U33448 | 1822: U33447 | 1823: U49727 | 1824: X99393 |
| 1825: AA041219 | 1826: W40430 | 1827: W21494 | 1828: N93476 |
| 1829: W23870 | 1830: N95025 | 1831: AA007184 | 1832: AA007183 |
| 1833: L03718 | 1834: X96597 | 1835: N62053 | 1836: H97311 |
| 1837: X81121 | 1838: X81120 | 1839: X69920 | 1840: X69168 |
| 1841: X83956 | 1842: X72089 | 1843: X65181 | 1844: X65180 |
| 1845: X65179 | 1846: X65177 | 1847: X65178 | 1848: X68596 |
| 1849: X71635 | 1850: X65176 | 1851: X65175 | 1852: X65174 |
| 1853: X65173 | 1854: X65172 | 1855: X68829 | 1856: X52068 |
| 1857: X65859 | 1858: X64993 | 1859: X64992 | 1860: X64991 |
| 1861: X64990 | 1862: X64989 | 1863: X64988 | 1864: X64987 |
| 1865: X64986 | 1866: X64985 | 1867: X64984 | 1868: X64983 |
| 1869: X64982 | 1870: X64981 | 1871: X64980 | 1872: X64979 |
| 1873: X64974 | 1874: X64978 | 1875: X64977 | 1876: X64976 |
| 1877: X64975 | 1878: X64995 | 1879: X64994 | 1880: X75897 |
| 1881: X54937 | 1882: U55312 | 1883: W24753 | 1884: W17011 |
| 1885: U21051 | 1886: W01442 | 1887: U47124 | 1888: N93987 |
| 1889: N90783 | 1890: U45982 | 1891: N86436 | 1892: U32500 |
| 1893: U20350 | 1894: U18549 | 1895: U18548 | 1896: AH003369 |
| 1897: U23430 | 1898: U23429 | 1899: U23428 | 1900: M73481 |
| 1901: N49854 | 1902: U20760 | 1903: U20759 | 1904: N23898 |
| 1905: U39231 | 1906: H88656 | 1907: H88701 | 1908: U35399 |
| 1909: U35398 | 1910: L35318 | 1911: T29782 | 1912: T29676 |
| 1913: T28268 | 1914: R91585 | 1915: H37859 | 1916: L31581 |
| 1917: L32831 | 1918: L32830 | 1919: H45306 | 1920: H29103 |
| 1921: H29001 | 1922: H27787 | 1923: H14301 | 1924: H21565 |
| 1925: H20663 | 1926: H16711 | 1927: H16710 | 1928: H12955 |
| 1929: H06644 | 1930: R80054 | 1931: R78657 | 1932: R78620 |
| 1933: R76070 | 1934: R73329 | 1935: R72859 | 1936: R55156 |
| 1937: R55018 | 1938: R48699 | 1939: R48597 | 1940: R27256 |
| 1941: R23115 | 1942: R23114 | 1943: R20666 | 1944: R20475 |
| 1945: R15256 | 1946: R13546 | 1947: U13668 | 1948: U13667 |
| 1949: U13666 | 1950: T99860 | 1951: T98622 | 1952: U11878 |
| 1953: U11877 | 1954: U11876 | 1955: U11875 | 1956: U11874 |
| 1957: U11873 | 1958: U11872 | 1959: T87010 | 1960: L36150 |
| 1961: L36148 | 1962: T72605 | 1963: T64864 | 1964: L36149 |
| 1965: T62636 | 1966: T62491 | 1967: U17473 | 1968: T51359 |
| 1969: T51244 | 1970: U19487 | 1971: M74290 | 1972: L16862 |
| 1973: M73482 | 1974: L09237 | 1975: L15388 | 1976: L08176 |
| 1977: U14910 | 1978: M95489 | 1979: M67439 | 1980: L14856 |
| 1981: L10918 | 1982: L08177 | 1983: U03642 | 1984: L10820 |
| 1985: U00686 | 1986: L06797 | | |

TABLE 12
GenBank Accession numbers of human sequence records identified
as related to nucleic acids encoding polypeptides potentially related to orphan
G-protein-coupled receptors metabolism and/or signaling.

| | | | |
|---|---|---|---|
| 1: NM_005300 | 2: NM_004778 | 3: NM_018485 | 4: NT_009714 |
| 5: NT_009528 | 6: NT_008902 | 7: NT_005849 | 8: NT_028053 |
| 9: AY089976 | 10: NM_003717 | 11: NT_010672 | 12: NT_033363 |
| 13: XM_114696 | 14: XM_061555 | 15: NM_138964 | 16: NT_011520 |
| 17: NM_004767 | 18: NT_033922 | 19: NT_005612 | 20: NT_005151 |
| 21: XM_086954 | 22: NM_007227 | 23: NM_001337 | 24: AC078860 |
| 25: NM_006794 | 26: BM503956 | 27: NM_003667 | 28: NM_016235 |
| 29: NM_053036 | 30: NM_032551 | 31: NM_033050 | 32: NM_023914 |
| 33: AY029541 | 34: AF343725 | 35: U73141 | 36: AF209923 |
| 37: AF207989 | 38: AU099377 | 39: AF295368 | 40: AF237763 |
| 41: AF237762 | 42: AF348078 | 43: AF321815 | 44: NM_022036 |
| 45: NM_018653 | 46: NM_018654 | 47: NM_016602 | 48: NM_003979 |
| 49: Y19228 | 50: Y19231 | 51: Y19230 | 52: Y19229 |
| 53: NM_004885 | 54: BF592107 | 55: NM_018949 | 56: NM_005281 |
| 57: NM_005291 | 58: NM_001508 | 59: NM_001507 | 60: AF250237 |
| 61: AF257210 | 62: AF208237 | 63: AF202640 | 64: AF236081 |
| 65: AF215981 | 66: X89271 | 67: AF140631 | 68: AF101472 |
| 69: AF072693 | 70: AI969765 | 71: AI968199 | 72: AI962439 |
| 73: AI951598 | 74: AH005868 | 75: AF044601 | 76: AF044600 |
| 77: AI831861 | 78: AI703458 | 79: AI699236 | 80: AI697103 |
| 81: AI694940 | 82: AI692576 | 83: AI681718 | 84: AI640447 |
| 85: AF069755 | 86: AF118266 | 87: AF118265 | 88: AF118670 |
| 89: AI215993 | 90: AF091890 | 91: AF027957 | 92: AF027956 |
| 93: U79527 | 94: U79526 | 95: U77827 | 96: U32672 |
| 97: AF045764 | 98: Y12546 | 99: Z94155 | 100: Z94154 |
| 101: AF062006 | 102: AF034633 | 103: AF034632 | 104: Y14838 |
| 105: Y16280 | 106: U67784 | 107: X96597 | 108: X83956 |
| 109: U20350 | 110: U17473 | 111: L06797 | |

TABLE 13
GenBank Accession numbers of human sequence records identified
as related to nucleic acids encoding protein kinases potentially involved in
transcription metabolism and/or signaling.

| | | | |
|---|---|---|---|
| 1: NM_020168 | 2: NM_004857 | 3: NM_139070 | 4: NM_139069 |
| 5: NM_139068 | 6: NM_002752 | 7: D10022 | 8: NM_138957 |
| 9: NM_002745 | 10: NM_002754 | 11: NM_138993 | 12: NM_002751 |
| 13: NM_139049 | 14: NM_139047 | 15: NM_139046 | 16: NM_005456 |
| 17: NM_139014 | 18: NM_139013 | 19: NM_139012 | 20: NM_138982 |
| 21: NM_138981 | 22: NM_138980 | 23: NM_002753 | 24: NM_139034 |
| 25: NM_139033 | 26: NM_139032 | 27: NM_002749 | 28: NM_002750 |
| 29: NT_009307 | 30: NT_009237 | 31: NT_024229 | 32: NT_009770 |
| 33: NT_024654 | 34: NT_010274 | 35: NT_010194 | 36: NT_030059 |
| 37: NT_011139 | 38: NT_011109 | 39: NT_007993 | 40: NT_010019 |
| 41: NT_008413 | 42: NT_004858 | 43: NT_030040 | 44: NT_004734 |
| 45: NT_004658 | 46: NT_006397 | 47: NT_004525 | 48: NT_006371 |
| 49: NT_021877 | 50: NT_019273 | 51: NT_033927 | 52: NT_033241 |
| 53: NT_028327 | 54: NT_033984 | 55: NT_033982 | 56: NT_033892 |
| 57: NM_002401 | 58: NM_032989 | 59: NM_004322 | 60: NM_031988 |
| 61: NM_002758 | 62: NM_001315 | 63: NT_033291 | 64: NT_010552 |
| 65: NT_010478 | 66: NT_010441 | 67: NT_011512 | 68: NT_011387 |
| 69: NT_010808 | 70: NT_010783 | 71: NT_010755 | 72: NT_010748 |
| 73: NT_010736 | 74: NT_010718 | 75: NT_031911 | 76: NT_007592 |
| 77: NT_009563 | 78: NT_009526 | 79: NT_025965 | 80: NT_007422 |
| 81: NT_025273 | 82: NT_007299 | 83: NT_033944 | 84: NT_011362 |
| 85: NT_011520 | 86: NT_033167 | 87: NT_030710 | 88: NT_025741 |
| 89: NT_009799 | 90: NT_023399 | 91: NT_007072 | 92: NT_006859 |
| 93: NT_011295 | 94: NT_011271 | 95: NT_011255 | 96: NT_009910 |
| 97: NT_006654 | 98: NT_006497 | 99: NT_026437 | 100: NT_007968 |
| 101: NT_007933 | 102: NT_008046 | 103: NT_025892 | 104: NT_010164 |
| 105: NT_007758 | 106: NT_008580 | 107: NT_007688 | 108: NT_033965 |
| 109: NT_033964 | 110: NT_030001 | 111: NT_029366 | 112: NT_017168 |
| 113: NT_005367 | 114: NT_005334 | 115: NT_005332 | 116: NT_005190 |
| 117: NT_005151 | 118: NT_022171 | 119: NT_022135 | 120: NM_138923 |
| 121: NM_004606 | 122: NM_080601 | 123: NM_002834 | 124: NM_022740 |
| 125: NM_005806 | 126: NM_001799 | 127: NM_022304 | 128: NM_002005 |
| 129: NM_037370 | 130: NM_012142 | 131: NM_012333 | 132: AY028384 |
| 133: NM_001261 | 134: NM_052988 | 135: NM_052987 | 136: NM_001260 |
| 137: NM_003674 | 138: NM_052827 | 139: NM_001798 | 140: NM_021104 |
| 141: NM_000024 | 142: NM_000681 | 143: NM_002006 | 144: NM_012138 |
| 145: NM_002755 | 146: NM_004635 | 147: AD000092 | 148: NM_031965 |
| 149: AF289865 | 150: NM_022550 | 151: NM_022406 | 152: NM_003401 |
| 153: NM_005734 | 154: AJ277546 | 155: NM_001924 | 156: NM_013311 |
| 157: NM_005163 | 158: NM_000165 | 159: NM_002227 | 160: AF184924 |
| 161: AP001751 | 162: U83994 | 163: U87803 | 164: AH007140 |
| 165: U87276 | 166: U87275 | 167: U87274 | 168: U87273 |
| 169: U87272 | 170: U87271 | 171: AF074715 | 172: AF015256 |
| 173: AF009225 | 174: U64573 | 175: U35005 | 176: U35004 |
| 177: U35003 | 178: U35002 | 179: U34822 | 180: U34821 |
| 181: U34820 | 182: U34819 | 183: Z92868 | 184: AF049893 |
| 185: Y10256 | 186: Y07641 | 187: AH004914 | 188: U03874 |

TABLE 14
GenBank Accession numbers of human sequence records identified
as related to nucleic acids encoding protein kinases potentially involved in G-
protein coupled receptor metabolism and/or signaling.

| | | | |
|---|---|---|---|
| 1: NM_007202 | 2: NM_144489 | 3: NM_144488 | 4: NM_134427 |
| 5: NM_017790 | 6: NM_021106 | 7: NM_130795 | 8: NM_138957 |
| 9: NM_002745 | 10: NM_139034 | 11: NM_139033 | 12: NM_139032 |
| 13: NM_002749 | 14: NT_009307 | 15: NT_009770 | 16: NT_030828 |
| 17: NT_010194 | 18: NT_008902 | 19: NT_011151 | 20: NT_011139 |
| 21: NT_011109 | 22: NT_008413 | 23: NT_004858 | 24: NT_006014 |
| 25: NT_004771 | 26: NT_004434 | 27: NT_004350 | 28: NT_006051 |
| 29: NT_025667 | 30: NT_029860 | 31: NT_028053 | 32: NT_026943 |
| 33: NT_033903 | 34: NT_010552 | 35: NT_010823 | 36: NT_010808 |
| 37: NT_010783 | 38: NT_007592 | 39: NT_009563 | 40: NT_007422 |
| 41: NT_007299 | 42: NT_011793 | 43: NT_033944 | 44: NT_011362 |
| 45: NT_011520 | 46: NT_011719 | 47: NT_011669 | 48: NT_025741 |
| 49: NT_009799 | 50: NT_033922 | 51: NT_006859 | 52: NT_011295 |
| 53: NT_006519 | 54: NT_026437 | 55: NT_007968 | 56: NT_007933 |
| 57: NT_007914 | 58: NT_010164 | 59: NT_008580 | 60: NT_029366 |
| 61: NT_017168 | 62: NT_005367 | 63: NT_005151 | 64: NT_005079 |
| 65: NM_022304 | 66: NM_006098 | 67: AF282269 | 68: NM_002880 |
| 69: NM_000024 | 70: NM_000681 | 71: NM_032938 | 72: NM_004489 |
| 73: NM_032442 | 74: NM_004127 | 75: NM_004041 | 76: NM_020251 |
| 77: NM_005160 | 78: AL031282 | 79: U20285 | 80: AC007136 |
| 81: U28963 | | | |

TABLE 15
GenBank Accession numbers of human sequence records
identified as related to nucleic acids encoding protein kinases potentially
involved in apoptosis.

| | | | |
|---|---|---|---|
| 1: NM_005923 | 2: NM_020168 | 3: NM_144489 | 4: NM_144488 |
| 5: NM_134427 | 6: NM_017790 | 7: NM_021106 | 8: NM_130795 |
| 9: NM_139070 | 10: NM_139069 | 11: NM_139068 | 12: NM_002752 |
| 13: NM_006712 | 14: NM_033015 | 15: NM_025096 | 16: NM_139049 |
| 17: NM_139047 | 18: NM_139046 | 19: NM_005456 | 20: NM_139014 |
| 21: NM_139013 | 22: NM_139012 | 23: NM_138982 | 24: NM_138981 |
| 25: NM_138980 | 26: NM_002753 | 27: NM_002750 | 28: NT_024192 |
| 29: NT_009770 | 30: NT_010194 | 31: NT_030059 | 32: NT_011109 |
| 33: NT_021877 | 34: NM_078467 | 35: NM_032989 | 36: NM_004322 |
| 37: NM_031988 | 38: NM_002758 | 39: NM_001315 | 40: NT_010552 |
| 41: NT_010478 | 42: NT_010823 | 43: NT_010755 | 44: NT_010748 |
| 45: NT_007592 | 46: NT_033944 | 47: NT_011520 | 48: NT_011694 |
| 49: NT_006497 | 50: NT_026437 | 51: NT_010164 | 52: NT_007819 |
| 53: NT_007758 | 54: NT_033181 | 55: NT_005190 | 56: XM_050441 |
| 57: NM_003821 | 58: NM_004103 | 59: NM_131917 | 60: NM_007051 |
| 61: NM_003682 | 62: NM_130476 | 63: NM_130475 | 64: NM_130474 |
| 65: NM_130473 | 66: NM_130472 | 67: NM_130471 | 68: NM_130470 |
| 69: AB040057 | 70: NM_014326 | 71: NM_000389 | 72: NM_005400 |
| 73: NM_004226 | 74: NM_024011 | 75: NM_033621 | 76: NM_033537 |
| 77: NM_033536 | 78: NM_033534 | 79: NM_033532 | 80: NM_033531 |
| 81: NM_033529 | 82: NM_033528 | 83: NM_033527 | 84: AF305840 |
| 85: NM_033493 | 86: NM_033492 | 87: NM_033491 | 88: NM_033490 |
| 89: NM_033489 | 90: NM_033488 | 91: NM_033487 | 92: NM_033486 |
| 93: NM_001787 | 94: NM_006947 | 95: NM_002880 | 96: NM_012138 |
| 97: NM_031267 | 98: NM_003718 | 99: NM_014245 | 100: NM_005163 |
| 101: NM_004760 | 102: NM_001348 | 103: AF052941 | 104: AB018001 |
| 105: AB011421 | 106: AB011420 | 107: AF027706 | 108: AF021792 |

TABLE 16
Modifications of the First Three Nucleotides
of the att Site Seven Base Pair Overlap
Region that Alter Recombination Specificity.

| | | | |
|---|---|---|---|
| AAA | CAA | GAA | TAA |
| AAC | CAC | GAC | TAC |
| AAG | CAG | GAG | TAG |
| AAT | CAT | GAT | TAT |
| ACA | CCA | GCA | TCA |
| ACC | CCC | GCC | TCC |
| ACG | CCG | GCG | TCG |
| ACT | CCT | GCT | TCT |
| AGA | CGA | GGA | TGA |
| AGC | CGC | GGC | TGC |
| AGG | CGG | GGG | TGG |
| AGT | CGT | GGT | TGT |
| ATA | CTA | GTA | TTA |
| ATC | CTC | GTC | TTC |
| ATG | CTG | GTG | TTG |
| ATT | CTT | GTT | TTT |

TABLE 17
Representative Examples of Seven Base Pair
att Site Overlap Regions Suitable for use
in the recombination sites of the Invention.

| | | | |
|---|---|---|---|
| AAAATAC | CAAATAC | GAAATAC | TAAATAC |
| AACATAC | CACATAC | GACATAC | TACATAC |
| AAGATAC | CAGATAC | GAGATAC | TAGATAC |
| AATATAC | CATATAC | GATATAC | TATATAC |
| ACAATAC | CCAATAC | GCAATAC | TCAATAC |
| ACCATAC | CCCATAC | GCCATAC | TCCATAC |
| ACGATAC | CCGATAC | GCGATAC | TCGATAC |
| ACTATAC | CCTATAC | GCTATAC | TCTATAC |
| AGAATAC | CGAATAC | GGAATAC | TGAATAC |
| AGCATAC | CGCATAC | GGCATAC | TGCATAC |
| AGGATAC | CGGATAC | GGGATAC | TGGATAC |
| AGTATAC | CGTATAC | GGTATAC | TGTATAC |
| ATAATAC | CTAATAC | GTAATAC | TTAATAC |
| ATCATAC | CTCATAC | GTCATAC | TTCATAC |
| ATGATAC | CTGATAC | GTGATAC | TTGATAC |
| ATTATAC | CTTATAC | GTTATAC | TTTATAC |

TABLE 18
Nucleotide sequences of att sites.

| | | |
|---|---|---|
| attB0 | AGCCTGCTTT TTTATACTAA CTTGAGC | (SEQ ID NO: ) |
| attP0 | GTTCAGCTTT TTTATACTAA GTTGGCA | (SEQ ID NO: ) |
| attL0 | AGCCTGCTTT TTTATACTAA GTTGGCA | (SEQ ID NO: ) |
| attR0 | GTTCAGCTTT TTTATACTAA CTTGAGC | (SEQ ID NO: ) |
| attB1 | AGCCTGCTTT TTTGTACAAA CTTGT | (SEQ ID NO: ) |
| attP1 | GTTCAGCTTT TTTGTACAAA GTTGGCA | (SEQ ID NO: ) |
| attL1 | AGCCTGCTTT TTTGTACAAA GTTGGCA | (SEQ ID NO: ) |
| attR1 | GTTCAGCTTT TTTGTACAAA CTTGT | (SEQ ID NO: ) |
| attB2 | ACCCAGCTTT CTTGTACAAA GTGGT | (SEQ ID NO: ) |
| attP2 | GTTCAGCTTT CTTGTACAAA GTTGGCA | (SEQ ID NO: ) |
| attL2 | ACCCAGCTTT CTTGTACAAA GTTGGCA | (SEQ ID NO: ) |
| attR2 | GTTCAGCTTT CTTGTACAAA GTGGT | (SEQ ID NO: ) |
| attB5 | CAACTTTATT ATACAAAGTT GT | (SEQ ID NO: ) |
| attP5 | GTTCAACTTT ATTATACAAA GTTGGCA | (SEQ ID NO: ) |
| attL5 | CAACTTTATT ATACAAAGTT GGCA | (SEQ ID NO: ) |
| attR5 | GTTCAACTTT ATTATACAAA GTTGT | (SEQ ID NO: ) |
| attB11 | CAACTTTTCT ATACAAAGTT GT | (SEQ ID NO: ) |
| attP11 | GTTCAACTTT TCTATACAAA GTTGGCA | (SEQ ID NO: ) |
| attL11 | CAACTTTTCT ATACAAAGTT GGCA | (SEQ ID NO: ) |
| attR11 | GTTCAACTTT TCTATACAAA GTTGT | (SEQ ID NO: ) |
| attB17 | CAACTTTTGT ATACAAAGTT GT | (SEQ ID NO: ) |
| attP17 | GTTCAACTTT TGTATACAAA GTTGGCA | (SEQ ID NO: ) |
| attL17 | CAACTTTTGT ATACAAAGTT GGCA | (SEQ ID NO: ) |
| attR17 | GTTCAACTTT TGTATACAAA GTTGT | (SEQ ID NO: ) |
| attB19 | CAACTTTTTC GTACAAAGTT GT | (SEQ ID NO: ) |
| attP19 | GTTCAACTTT TTCGTACAAA GTTGGCA | (SEQ ID NO: ) |
| attL19 | CAACTTTTTC GTACAAAGTT GGCA | (SEQ ID NO: ) |
| attR19 | GTTCAACTTT TTCGTACAAA GTTGT | (SEQ ID NO: ) |
| attB20 | CAACTTTTTG GTACAAAGTT GT | (SEQ ID NO: ) |
| attP20 | GTTCAACTTT TTGGTACAAA GTTGGCA | (SEQ ID NO: ) |
| attL20 | CAACTTTTTG GTACAAAGTT GGCA | (SEQ ID NO: ) |
| attR20 | GTTCAACTTT TTGGTACAAA GTTGT | (SEQ ID NO: ) |
| attB21 | CAACTTTTTA ATACAAAGTT GT | (SEQ ID NO: ) |
| attP21 | GTTCAACTTT TTAATACAAA GTTGGCA | (SEQ ID NO: ) |
| attL21 | CAACTTTTTA ATACAAAGTT GGCA | (SEQ ID NO: ) |
| attR21 | GTTCAACTTT TTAATACAAA GTTGT | (SEQ ID NO: ) |

### 7. CONCLUSION

Various embodiments of the present invention have been described above. It should be understood that these embodiments have been presented by way of example only, and not limitation. It will be understood by those skilled in the relevant art that various changes in form and detail of the embodiments described above may be made without departing from the spirit and scope of the present invention as defined in the claims. Thus, the breadth and scope of the present invention should not be limited by any of the above-described exemplary embodiments, but should be defined only in accordance with the following claims and their equivalents.

1. A method for providing genomic and proteomic research products and services, comprising the steps of: providing a customer with access to a genomic and proteomic research products and services database; enabling the customer to access at least one of a clone collection database associated with the genomic and proteomic research products and services database and an expression database associated with the genomic and proteomic research products and services database; providing the customer with selected genomic and proteomic research products and services; and providing the customer with additional genomic and proteomic research products related to the selected genomic and proteomic research products and services.

2. The method of claim 1, wherein the clone collection database is divided into a private area and a public area, and further wherein the clone collection database contains information identifying the characteristics of individual members of a clone collection.

3. The method of claim 1, wherein the expression database contains information identifying optimized expression sequences for one or more clones in the clone collection.

4. The method of claim 1, further comprising the step of assembling a subscriber record, wherein the assembling step comprises the steps of: providing a subscription identification field in the subscriber record; providing a subscription fee payment field in the subscriber record; providing a clone purchase credit field in the subscriber record; providing a clone purchase field in the subscriber record; and providing a subscriber site identification field in the subscriber record.

5. The method of claim 1, further comprising the steps of designating one or more of the customers as subscribers and enabling the subscribers to identify clones to be built and added to the clone collection.

6. The method of claim 5, further comprising the step of enabling the subscribers to prioritize the order in which the identified clones are built and added to the clone collection.

7. The method of claim 6, further comprising the step of updating the clone collection database once the identified clones have been built and added to the clone collection.

8. The method of claim 5, further comprising the step of providing research and development consulting services to one or more sites designated by the subscriber.

9-29. (canceled)

30. A method of making a collection of clones, comprising: obtaining from a customer information of a type of polypeptide in which the customer is interested; and compiling a collection of clones comprising ORFs encoding the type of polypeptide in which the customer is interested.

31. A method according to claim 30, wherein the type of polypeptide is a druggable target.

32. A method according to claim 30, wherein the type of polypeptide is selected from the group consisting of kinases, phosphatases, G-protein-coupled receptors, ion channels, proteases, nuclear receptors, secretory proteins, growth factors, cytokines, chemokines, membrane transporters, chemokine receptors, and integrins.

33. A method according to claim 30, wherein the collection comprises a gene family.

34. A method according to claim 33, wherein the gene family comprises proteins related in amino acid sequence and/or splice variants of the same gene.

35. A method according to claim 30, wherein one or more clones in the collection comprise an open reading frame flanked by a first and a second recombination site, wherein the first and second recombination sites do not recombine with each other.

36. (canceled)

37. A clone collection, comprising: a plurality of clones, each clone comprising a nucleic acid sequence of interest, wherein the nucleic acid sequences of interest encode all or substantially all known polypeptides having a specified activity.

38. The clone collection of claim 37, wherein the specified activity is an enzymatic activity.

39. The clone collection of claim 38, wherein the activity is a kinase activity.

40. The clone collection of claim 37, wherein the activity is a G-protein-coupled receptor activity.

41. The clone collection of claim 37, wherein the nucleic acid sequences of interest comprise suppressible stop codons.

42. (canceled)

43. The clone collection of claim 37, wherein the nucleic acid sequences of interest are flanked by a first and a second recombination site and the first and the second recombination sites do not recombine with each other.


SEQUENCE LISTING (44 sequences)

SEQ ID NO: 1 - DNA, 15 bp, Artificial
  Synthetic
gcttttttatactaa

SEQ ID NO: 2 - DNA, 21 bp, Artificial
  Synthetic
caacttttttatacaaagttg

SEQ ID NO: 3 - DNA, 25 bp, Artificial
  Synthetic
agcctgcttttttgtacaaacttgt

SEQ ID NO: 4 - DNA, 233 bp, Artificial
  Synthetic
tacaggtcactaataccatctaagtagttgattcatagtgactggatatgttgtgttttacagtattatgtagtctgttttttatgcaaaatctaatttaatatattgatatttatatcattttacgtttctcgttcagcttttttgtacaaagttggcattataaaaaagcattgctcatcaatttgttgcaacgaacaggtcactatcagtcaaaataaaatcattatttg

SEQ ID NO: 5 - DNA, 100 bp, Artificial
  Synthetic
caaataatgattttattttgactgatagtgacctgttcgttgcaacaaattgataagcaatgcttttttataatgccaactttgtacaaaaaagcaggct

SEQ ID NO: 6 - DNA, 125 bp, Artificial
  Synthetic
acaagtttgtacaaaaaagctgaacgagaaacgtaaaatgatataaatatcaatatattaaattagattttgcataaaaaacagactacataatactgtaaaacacaacatatccagtcactatg

SEQ ID NO: 7 - protein, 4 aa, Artificial
  Synthetic
IEGR

SEQ ID NO: 8 - protein, 4 aa, Artificial
  Synthetic
LVPR

SEQ ID NO: 9 - DNA, 27 bp, Artificial
  Synthetic
agcctgcttttttatactaacttgagc

SEQ ID NO: 10 - DNA, 27 bp, Artificial
  Synthetic
gttcagcttttttatactaagttggca

SEQ ID NO: 11 - DNA, 27 bp, Artificial
  Synthetic
agcctgcttttttatactaagttggca

SEQ ID NO: 12 - DNA, 27 bp, Artificial
  Synthetic
gttcagcttttttatactaacttgagc

SEQ ID NO: 13 - DNA, 27 bp, Artificial
  Synthetic
gttcagcttttttgtacaaagttggca

SEQ ID NO: 14 - DNA, 27 bp, Artificial
  Synthetic
agcctgcttttttgtacaaagttggca

SEQ ID NO: 15 - DNA, 25 bp, Artificial
  Synthetic
gttcagcttttttgtacaaacttgt

SEQ ID NO: 16 - DNA, 25 bp, Artificial
  Synthetic
acccagctttcttgtacaaagtggt

SEQ ID NO: 17 - DNA, 27 bp, Artificial
  Synthetic
gttcagctttcttgtacaaagttggca

SEQ ID NO: 18 - DNA, 27 bp, Artificial
  Synthetic
acccagctttcttgtacaaagttggca

SEQ ID NO: 19 - DNA, 25 bp, Artificial
  Synthetic
gttcagctttcttgtacaaagtggt

SEQ ID NO: 20 - DNA, 22 bp, Artificial
  Synthetic
caactttattatacaaagttgt

SEQ ID NO: 21 - DNA, 27 bp, Artificial
  Synthetic
gttcaactttattatacaaagttggca

SEQ ID NO: 22 - DNA, 24 bp, Artificial
  Synthetic
caactttattatacaaagttggca

SEQ ID NO: 23 - DNA, 25 bp, Artificial
  Synthetic
gttcaactttattatacaaagttgt

SEQ ID NO: 24 - DNA, 22 bp, Artificial
  Synthetic
caacttttctatacaaagttgt

SEQ ID NO: 25 - DNA, 27 bp, Artificial
  Synthetic
gttcaacttttctatacaaagttggca

SEQ ID NO: 26 - DNA, 24 bp, Artificial
  Synthetic
caacttttctatacaaagttggca

SEQ ID NO: 27 - DNA, 25 bp, Artificial
  Synthetic
gttcaacttttctatacaaagttgt

SEQ ID NO: 28 - DNA, 22 bp, Artificial
  Synthetic
caacttttgtatacaaagttgt

SEQ ID NO: 29 - DNA, 27 bp, Artificial
  Synthetic
gttcaacttttgtatacaaagttggca

SEQ ID NO: 30 - DNA, 24 bp, Artificial
  Synthetic
caacttttgtatacaaagttggca

SEQ ID NO: 31 - DNA, 25 bp, Artificial
  Synthetic
gttcaacttttgtatacaaagttgt

SEQ ID NO: 32 - DNA, 22 bp, Artificial
  Synthetic
caactttttcgtacaaagttgt

SEQ ID NO: 33 - DNA, 27 bp, Artificial
  Synthetic
gttcaactttttcgtacaaagttggca

SEQ ID NO: 34 - DNA, 24 bp, Artificial
  Synthetic
caactttttcgtacaaagttggca

SEQ ID NO: 35 - DNA, 25 bp, Artificial
  Synthetic
gttcaactttttcgtacaaagttgt

SEQ ID NO: 36 - DNA, 22 bp, Artificial
  Synthetic
caactttttggtacaaagttgt

SEQ ID NO: 37 - DNA, 27 bp, Artificial
  Synthetic
gttcaactttttggtacaaagttggca

SEQ ID NO: 38 - DNA, 24 bp, Artificial
  Synthetic
caactttttggtacaaagttggca

SEQ ID NO: 39 - DNA, 25 bp, Artificial
  Synthetic
gttcaactttttggtacaaagttgt

SEQ ID NO: 40 - DNA, 22 bp, Artificial
  Synthetic
caactttttaatacaaagttgt

SEQ ID NO: 41 - DNA, 27 bp, Artificial
  Synthetic
gttcaactttttaatacaaagttggca

SEQ ID NO: 42 - DNA, 24 bp, Artificial
  Synthetic
caactttttaatacaaagttggca

SEQ ID NO: 43 - DNA, 25 bp, Artificial
  Synthetic
gttcaactttttaatacaaagttgt

SEQ ID NO: 44 - DNA, 25 bp, Artificial
  Synthetic
agcctgcttttttgtacaaacttgt